(19) United States
(12) Patent Application Publication
(10) Pub. No.: US 2017/0370709 A1
(43) Pub. Date: Dec. 28, 2017

(54) Imaging System To Characterize Dynamic Changes In Cell And Particle Characteristics

(71) Applicant: Trustees of Tufts College, Medford, MA (US)

(72) Inventors: Charles R. Mace, Watertown, MA (US); Jenna A. Walz, Groton, CT (US)

(21) Appl. No.: 15/310,431

(22) PCT Filed: Jun. 8, 2016
(86) PCT No.: PCT/US16/36498

§ 371 Date: Nov. 10, 2016

Related U.S. Application Data
(60) Provisional application No. 62/172,494, filed on Jun. 8, 2015.
(60) Provisional application No. 62/185,896, filed on Jun. 29, 2015.

(51) Int. Cl. G01B 11/27; G02B 21/16; G02B 21/00; G02B 21/34; G02B 21/32; G01N 21/03

(52) U.S. Cl. CPC G01B 11/272; G02B 21/34; G02B 21/32; G02B 21/16; G02B 21/008; G01N 2021/0346

(57) ABSTRACT

An imaging system for a biological sample includes a sample container having at least one biological cell that is in contact with an interface surface of a container interface. The imaging system also includes illuminating optics that output a light beam aligned with a sample plane, the light beam being oriented horizontally along a transverse (XY) plane and illuminating the biological cell vertically along an axial (XZ) plane. The imaging system further includes imaging optics aligned horizontally along the transverse (XY) plane with the interface in the sample container, the imaging optics being configured to detect along the axial (XZ) plane a magnified image of a measurable contact angle between the biological cell and the interface surface. The measurable contact angle changes over time and is indicative of biological adhesion between the biological cell and another biological cell.

### CROSS-REFERENCE TO RELATED APPLICATIONS

This application is a U.S. National Stage of International Application No PCT/US2016/036498, filed Jun. 8, 2016, titled “Imaging System To Characterize Dynamic Changes In Cell And Particle Characteristics,” which claims priority to and benefit of U.S. Provisional Patent Application Ser. No. 62/185,896, filed on Jun. 29, 2015, titled “Imaging System To Characterize Dynamic Changes In Cell And Particle Characteristics,” and to U.S. Provisional Patent Application Ser. No. 62/172,494, filed on Jun. 8, 2015, titled “Imaging System To Characterize Dynamic Changes In Cell And Particle Characteristics,” each of which is hereby incorporated by reference herein in its entirety.

### FIELD OF THE DISCLOSURE

The field of the invention relates to imaging systems useful for detecting and measuring dynamic changes in cell morphology and behavior.

### BACKGROUND

Surface adhesion proteins play a decisive role in the ability of a cell to recognize and interact with its environment effectively. Changes to the adhesive properties of a cell often are concomitant with a change in phenotype. Changes to the morphology of a cell occur as a result of adhesion, which is studied predominantly by optical microscopy. Current microscopy techniques only acquire images of cells in the transverse (xy-) plane. Any spatial information regarding the thickness of a sample must be inferred from a series of still images; that is, the desired imaging plane is reconstructed computationally rather than observed directly. In surface chemistry, interfacial interactions between liquid droplets and surfaces are studied using a type of low-powered microscopy (i.e., contact angle goniometry), and the complete thermodynamic characterization and interfacial free energies of a system can be determined by measuring the contact angle of the droplet on the surface in the sagittal (xz-) plane.

### SUMMARY

Provided herein are imaging system(s) useful for assessing dynamic changes in cell and particle characteristics, where the cells or particles are imaged laterally (e.g., substantially parallel to the interface). The systems described herein provide direct measurement of many dynamic cell characteristics or behavior that were previously inferred (e.g., indirectly assessed) by conventional upright (i.e., top-down) or inverted (i.e., bottom-up microscopy). In addition, the systems described provide a method for performing cellular assays when cells are exposed to normal gravitational forces (1×g), such as determining sedimentation rates etc. Also provided herein are methods for monitoring or measuring cell/particle dynamics, which are particularly useful for assessing the interaction of a cell or particle with a desired interface or surface.

Provided herein in one aspect is an imaging system comprising: (a) a sample container comprising an interface, in which a sample (e.g., a biological sample) comprising at least one cell or particle is introduced; (b) illuminating optics outputting a light beam oriented aligned with a sample plane; and (c) imaging optics aligned with the interface in the sample container.

In one embodiment of this aspect and all other aspects described herein, upon introduction of the biological sample comprising at least one cell or particle, the imaging optics magnify, in response to a control input, at least one cell or particle in the biological sample.

In another embodiment of this aspect and all other aspects described herein, the imaging system further comprises an illumination or light source.

In another embodiment of this aspect and all other aspects described herein, the imaging system further comprises a camera, a complementary metal oxide semiconductor (CMOS) sensor, a CCD camera, or a diode array.

In another embodiment of this aspect and all other aspects described herein, the camera is a high-speed charge-coupled device (CCD) camera or a high speed CMOS sensor.

In another embodiment of this aspect and all other aspects described herein, the imaging system further comprises a vibration-isolated breadboard on which one or more of the sample container, the imaging optics, and/or the camera are mounted.

In another embodiment of this aspect and all other aspects described herein, the interface includes a planar surface, an immiscible liquid interface, a three-dimensional surface, an inert material surface, a porous material surface, a patterned material surface, a treated/coated material surface, a surface of another cell(s) or a biological material.

In another embodiment of this aspect and all other aspects described herein, the imaging optics are configured as an imaging configuration selected from the group consisting of a bright-field imaging configuration, a phase-contrast imaging configuration, an epi-fluorescence imaging configuration, and a confocal imaging configuration.

In another embodiment of this aspect and all other aspects described herein, the imaging system further comprises one or more controllers communicatively coupled with the camera.

In another embodiment of this aspect and all other aspects described herein, the one or more controllers communicatively coupled with the camera are configured to: (i) receive data representative of an image of the at least one cell at a first time point; (ii) measure the contact angle between the at least one cell and the interface surface; and (iii) optionally compare the contact angle for the at least one cell to a reference.

In another embodiment of this aspect and all other aspects described herein, the one or more controllers communicatively coupled with the camera are configured to: (i) receive data representative of a plurality of images of the at least one cell at a plurality of time points; (ii) measure, for each of the plurality of images, the contact angle between the at least one cell and the interface surface; and (iii) determine the change in the contact angle over time for the at least one cell.

Also provided herein, in another aspect, is a method for analyzing dynamics of at least one cell or particle in a sample (e.g., a biological sample), the method comprising: (a) magnifying at least one cell or particle in a sample using an imaging system comprising: (i) a sample container in which the sample is introduced; (ii) illuminating optics outputting a light beam aligned with a sample plane; (iii) imaging optics aligned with the interface in the sample container; and (b) measuring an output parameter to analyze the dynamics of the at least one cell or particle.

In one embodiment of this aspect and all other aspects described herein, the at least one cell or particle is in contact with an interface in the sample container.

In another embodiment of this aspect and all other aspects described herein, the at least one cell comprises a human cell, a mammalian cell, a bacterial cell, a yeast cell, a fungal cell, an algal cell or a cell fragment.

In another embodiment of this aspect and all other aspects described herein, the particle includes a liposome, a micelle, an exosome, a microbubble, or a unilamellar vesicle.

In another embodiment of this aspect and all other aspects described herein, the interface includes a planar surface, an immiscible liquid interface, a three-dimensional surface, an inert material surface, a porous material surface, a patterned material surface, a treated material surface, a coated material surface, a surface of another cell(s) or a biological material.

In another embodiment of this aspect and all other aspects described herein, the treated material surface or the coated material surface includes a coating with a biological material, a polymer material, a nylon material, a Teflon™ material, a polytetrafluoroethylene (PTFE) material, or a gold material.

In another embodiment of this aspect and all other aspects described herein, the biological material has at least one extracellular matrix component.

In another embodiment of this aspect and all other aspects described herein, the extracellular matrix component includes fibronectin, collagen, laminin, vitronectin, fibrinogen, tenascin, elastin, entactin, heparin sulfate, chondroitin sulfate, keratin sulfate, gelatin, alginic acid or agar. In some embodiments, the extracellular matrix component is comprised by a commercially available mixture such as Matrigel™.

In another embodiment of this aspect and all other aspects described herein, the output parameter includes contact angle, rate of change of contact angle, height of cell or cell pedestal, contact area, sedimentation, adhesion, rolling, extravasation, intravasation, tethering, migration, displacement, morphology, detachment, locomotion, protrusion, contraction, matrix remodeling, gradient sensing, or contact inhibition.

In another embodiment of this aspect and all other aspects described herein, the output parameter is contact angle.

In another embodiment of this aspect and all other aspects described herein, the method further comprises a step of contacting the biological sample with a bioactive agent.

In another embodiment of this aspect and all other aspects described herein, the method further comprises a step of applying directional flow and/or shear stress to the interface.

In another embodiment of this aspect and all other aspects described herein, the imaging system is further configured for detecting fluorescence.

In another embodiment of this aspect and all other aspects described herein, the output parameter is measured at a plurality of time points.

In another embodiment of this aspect and all other aspects described herein, the particle includes at least one droplet.

In another embodiment of this aspect and all other aspects described herein, the droplet includes a colloidal droplet, a phase-separated droplet, or a coacervate.

Another aspect provided herein relates to a method for directly measuring contact angle of at least one cell in a biological sample, the method comprising: (a) magnifying and obtaining an image of the at least one cell using light microscopy, and (b) measuring contact angle of the at least one cell at an interface using the image obtained in step (a), thereby directly measuring the contact angle of the at least one cell.

In one embodiment of this aspect and all other aspects described herein, the image is obtained laterally (e.g., from the ‘side’).

In another embodiment of this aspect and all other aspects described herein, the at least one cell comprises a human cell, a mammalian cell, a bacterial cell, a yeast cell, a fungal cell, an algal cell or a cell fragment.

In another embodiment of this aspect and all other aspects described herein, the interface includes a planar surface, an immiscible liquid interface, a three-dimensional surface, an inert material surface, a porous material surface, a patterned material surface, a treated material surface, a coated material surface, or a surface of another cell.

In another embodiment of this aspect and all other aspects described herein, the treated material surface or the coated material surface includes a coating with a biological material, a polymer material, a nylon material, a Teflon™ material, a polytetrafluoroethylene (PTFE) material, or a gold material.

In another embodiment of this aspect and all other aspects described herein, the method further comprises a step of contacting the biological sample with a bioactive agent.

In another embodiment of this aspect and all other aspects described herein, the light microscopy is performed using an imaging system comprising: (a) a sample container comprising an interface, in which a biological sample comprising the cell is introduced, (b) illuminating optics outputting a light beam aligned with a sample plane, and (c) imaging optics aligned with the interface.

Another aspect described herein relates to a method for directly measuring adhesion of at least one cell in a biological sample, the method comprising: (a) magnifying and obtaining an image of the at least one cell using light microscopy, and (b) measuring adhesion of the at least one cell at an interface using the image obtained in step (a), thereby directly measuring the adhesion of the at least one cell.

In another embodiment of this aspect and all other aspects described herein, the image is obtained laterally.

Described herein, in another aspect, is a method for determining morphology or shape of at least one cell in a biological sample, the method comprising: (a) magnifying and obtaining an image of the at least one cell laterally using light microscopy, and (b) determining the morphology or shape of the at least one cell using the image obtained in step (a).

Described herein in another aspect is an assay for determining invasiveness of a cancer or tumor cell, the assay comprising: (a) magnifying and obtaining an image of the at least one cancer or tumor cell laterally using light microscopy, (b) measuring the height of the cell or cell pedestal as a percentage of the diameter of the cell, wherein an increased height as compared to a reference, non-invasive cell indicates that the cell is invasive, thereby determining the invasiveness of the cancer or tumor cell.

Described herein in another aspect is an assay for aspirating and/or dispensing single cells using the lateral microscope described herein. Another aspect described herein relates to measuring the invasion depth of a cell into a material, such as Matrigel™, to test for invasiveness of a cell, particularly a cancer cell using the lateral microscope described herein. In addition, another aspect described herein relates to the measurement of the force required to pull an adhered cell off of a surface, material or interface using the lateral microscope and/or the aspiration equipment described herein.

Another aspect described herein relates to the measurement of rate of change of the contact angle between a cell and a surface, material or interface using the lateral microscope described herein.

Also contemplated herein in other aspects are apparatuses for use with the lateral microscope including, but not limited to, a flow chamber or modified Boyden chamber as described herein.

### BRIEF DESCRIPTION OF THE FIGURES

FIG. 1A illustrates an image of an exemplary assembled apparatus for a microscope set-up and in which the stage mechanics, light source, and vibration isolation system have been removed for clarity.

FIG. 1B illustrates an image of HeLa cells in contact with or sedimenting towards a glass surface and in which cells are (i) in or (ii) out of the plane of focus, or (iii) sedimenting into the field of view.

FIG. 1C illustrates a magnified view of the cell in (i) and measurement of its contact angle.

FIG. 1D illustrates a change in contact angle over time for adherent HeLa cells (black) and suspension H9 cells (grey).

FIG. 1E is a schematic showing that contact angle or effective contact angle (θ_{c,eff}) measurements can be used to describe cell morphology and the ability of a surface to promote or resist adhesion.

FIG. 2A shows, generally, a schematic of a sample container for the lateral microscope, and, more specifically, illustrates an exploded view of one embodiment depicting a reservoir and removable windows for a sample container (with the lid and underlying sample stage removed for clarity) of a lateral microscope.

FIG. 2B shows, generally, a schematic of a sample container for the lateral

FIG. 3A shows a HeLa immortalized cervical cancer cell on a glass surface as a function of time. More generally, an exemplary method and associated results are shown relating to detecting and measuring contact angle of HeLa cells on planar surfaces. HeLa cells cultured in a petri dish were treated with Cellstripper™, a solution that non-enzymatically dissociates adherent cells from surfaces. The planar surface of interest for interaction with cells (glass, nylon, or PTFE) was sterilized and placed inside a custom-made sample container. The container was filled with cell culture medium (DMEM, 10% FBS, 1% penicillin-streptomycin) and the dissociated HeLa cells were pipetted into the container. Using the lateral microscope, a single cell was monitored in the field of view and imaged every 15 minutes spanning a 90 minute time period. The first image (0 min) represents the cell's initial contact with the surface. Experiments were performed at 37° C. in a 5% CO₂ environment.

FIG. 3B shows a HeLa cell on a nylon surface, an exemplary opaque material, as a function of time. More generally, an exemplary method and associated results are shown relating to detecting and measuring contact angle of HeLa cells on planar surfaces.

FIG. 3C shows a HeLa cell on a polytetrafluoroethylene (PTFE) surface, an exemplary opaque material, as a function of time. More generally, an exemplary method and associated results are shown relating to detecting and measuring contact angle of HeLa cells on planar surfaces.

FIG. 4 is a graph showing the change in HeLa cell contact angle over time for the experiments outlined in FIGS. 3A-3C. Using a plug-in for ImageJ (DropSnake™) with the images obtained in FIGS. 3A-3C, the contact angle (θc) between the cell and the surface was measured. The contact angle represents the average of the left and right contact angle measurements. The change in HeLa cell contact angle as a function of time on each surface is plotted and shows the greatest change in HeLa cell contact angle on the glass surface.

FIG. 5 shows the detection and measurement of contact angle of cells on the interface of immiscible liquids. The measured contact angels of these HeLa cells on the surface of the liquid, fluorinated solvent are ˜150°, which is comparable to the contact angles on solid PTFE.

FIG. 6B shows a lateral microscopy image of a HeLa cell adhering to a three-dimensional scaffold, e.g., an arbitrarily placed strand of hair.

FIG. 7A shows a lateral microscopy image of HeLa cells adhering to other cells, e.g., a monolayer of HeLa cells.

FIG. 7B shows a lateral microscopy image of an aggregate of MCF-7 immortalized breast cancer cells adhered to other cells, e.g., on a glass surface.

FIG. 8 is a schematic depicting an exemplary set-up for the imaging systems described herein and indicates the components, including optional components that can be used in the imaging system.

FIG. 9A is a schematic depicting, according to one embodiment, a sample container comprising a polyethylene box with glass windows.

FIG. 9B is an end view schematic depicting, according to another embodiment, a sample container further comprising an acrylic lid, among other features.

FIG. 9C is a side/diagonal view of the sample container of FIG. 9B.

FIG. 10A shows the use of lateral microscopy to observe morphology changes to HeLa cells on glass during adhesion. Images of a single HeLa cell after 0, 30, 60 and 90 minutes of adhesion time to glass. The cell is positioned at a short distance from the edge of the glass surface. White dashed lines represent the interface between the cell and the surface. Scale bars are 10 μm.

FIG. 10B shows the use of lateral microscopy to observe morphology changes to HeLa cells on glass. The plot shows the changes in contact angle of single HeLa cells as represented by different symbols and the average changes in contact angle of all HeLa cells (black traces, N=10 cells/surface) on glass. The gray area enclosed by the black dashed lines represents the 95% confidence band. According to the rates of change in contact angle for each cell, no statistical outliers (95% confidence) were determined on glass or collagen-coated glass.

FIG. 10C shows the use of lateral microscopy to observe morphology changes to HeLa cells on collagen-coated glass surfaces during adhesion. Images of a single HeLa cell after 0, 30, 60 and 90 minutes of adhesion time to collagen-coated glass. The cell is positioned further beyond the edge of the collagen-coated glass surface, resulting in a reflection of the cell. White dashed lines represent the interface between the cell and the surface. Scale bars are 10 μm.

FIG. 10D shows the use of lateral microscopy to observe morphology changes to HeLa cells on collagen-coated glass surfaces during adhesion. The plot shows the changes in contact angle of single HeLa cells as represented by different symbols and the average changes in contact angle of all HeLa cells (black traces, N=10 cells/surface) collagen-coated glass. The gray area enclosed by the black dashed lines represents the 95% confidence band. According to the rates of change in contact angle for each cell, no statistical outliers (95% confidence) were determined on glass or collagen-coated glass.

FIG. 11 shows a 3D reconstruction of a HeLa cell adhered to glass using confocal microscopy. After 90 minutes of adhesion, the average contact angle of HeLa cells on glass was 52.9°±13.6° as measured by lateral microscopy (10 cells) and 52.9°±10.3° as measured by confocal microscopy (8 cells, 4 projections each).

FIG. 12A shows, generally, the use of lateral microscopy to observe morphology changes to HeLa cells on collagen-alginate hydrogels during adhesion. Specifically, images depict a single HeLa cell from the time it first contacted a hydrogel surface and 30, 60, and 90 minutes after adhesion. White dashed lines represent the interface between the cell and the surface. Scale bar is 10 μm.

FIG. 12B shows, generally, the use of lateral microscopy to observe morphology changes to HeLa cells on collagen-alginate hydrogels during adhesion. Specifically, a plot shows changes in contact angle of single HeLa cells as represented by different symbols and the average change in contact angle of all HeLa cells (black trace, N=10 cells/surface). The gray area enclosed by the black dashed lines represents the 95% confidence band. According to the rates of change in contact angle for each cell, no statistical outliers (95% confidence) were determined.

FIG. 13A shows, generally, the use of lateral microscopy to observe morphology changes to HeLa cells on during adhesion. Images of a single HeLa cell after 0, 30, 60 and 90 minutes of adhesion time to Nylon. The cells are positioned at a distance beyond the edge of surfaces. A cell that is out of focus can be seen in the 0 and 30 minute images. White dashed lines represent the interface between the cell and the surface. Scale bars are 10 μm.

FIG. 13B shows, generally, the use of lateral microscopy to observe morphology changes to HeLa cells on Nylon during adhesion. A plot shows the changes in contact angle of single HeLa cells as represented by different symbols and the average changes in contact angle of all HeLa cells (black traces, N=10 cells/surface) on Nylon. The gray area enclosed by the black dashed lines represents the 95% confidence band. According to the rates of change in contact angle for each cell, three statistical outliers (95% confidence) were determined on PTFE (solid symbols).

FIG. 13C shows, generally, the use of lateral microscopy to observe morphology changes to HeLa cells on PTFE during adhesion. Images of a single HeLa cell after 0, 30, 60 and 90 minutes of adhesion time to PTFE. The cells are positioned at a distance beyond the edge of surfaces.

FIG. 13D shows, generally, the use of lateral microscopy to observe morphology changes to HeLa cells on PTFE during adhesion. A plot shows the changes in contact angle of single HeLa cells as represented by different symbols and the average changes in contact angle of all HeLa cells (black traces, N=10 cells/surface) on PTFE. The gray area enclosed by the black dashed lines represents the 95% confidence band. According to the rates of change in contact angle for each cell, three statistical outliers (95% confidence) were determined on PTFE (solid symbols).

FIG. 14A shows images of a single 3T3 cell from the time it first contacted a glass surface and 30, 60, and 90 minutes after adhesion. The cell is imaged at a distance beyond the edge of the surface, resulting in a reflection of the cell. White dashed lines represent the interface between the cell and the surface. Generally, FIGS. 14A-14F show a LEFT PANEL (FIGS. 14A and 14B) in which the use of lateral microscopy observes morphology changes to 3T3 cells on glass during adhesion, a MIDDLE PANEL (FIGS. 14C and 14D) in which the use of lateral microscopy observes morphology changes to 3T3 cells on collagen-coated glass during adhesion, and a RIGHT PANEL (FIGS. 14E and 14F) in which the use of lateral microscopy observes morphology changes to 3T3 cells on collagen-alginate hydrogels during adhesion.

FIG. 14B shows a plot depicting the changes in contact angle of single 3T3 cells as represented by different symbols and the average change in contact angle of all 3T3 cells (black trace, N=10 cells/surface). The gray area enclosed by the black dashed lines represents the 95% confidence band. According to the rates of change in contact angle for each cell, no statistical outliers (95% confidence) were determined.

FIG. 14C shows images of a single 3T3 cell from the time it first contacted a collagen surface and 30, 60, and 90 minutes after adhesion. The cell is imaged at a distance beyond the edge of the surface, resulting in a reflection of the cell. White dashed lines represent the interface between the cell and the surface.

FIG. 14D shows a plot depicting the changes in contact angle of single 3T3 cells as represented by different symbols and the average change in contact angle of all 3T3 cells (black trace, N=10 cells/surface). The gray area enclosed by the black dashed lines represents the 95% confidence band. According to the rates of change in contact angle for each cell, no statistical outliers (95% confidence) were determined.

FIG. 14E shows images of a single 3T3 cell from the time it first contacted a hydrogel surface and 30, 60, and 90 minutes after adhesion. White dashed lines represent the interface between the cell and the surface.

FIG. 14F shows a plot depicting the changes in contact angle of single 3T3 cells as represented by different symbols and the average change in contact angle of all 3T3 cells (black trace, N=10 cells/surface). The gray area enclosed by the black dashed lines represents the 95% confidence band. According to the rates of change in contact angle for each cell, one statistical outlier (95% confidence) was determined.

FIG. 15A shows images of a single 3T3 cell from the time it first contacted a Nylon surface and 30, 60, and 90 minutes after adhesion. The cell is imaged at the edge of the surface. Cells that are out of focus can be seen in each image. Generally, in reference to FIGS. 15A-15D, a LEFT PANEL (FIGS. 15A and 15B) shows the use of lateral microscopy to observe morphology changes to 3T3 cells on Nylon during adhesion, and a RIGHT PANEL (FIGS. 15C and 15D) shows the use of lateral microscopy to observe morphology changes to 3T3 cells on PTFE during adhesion.

FIG. 15B shows a plot depicting the changes in contact angle of single 3T3 cells as represented by different symbols and the average change in contact angle of all 3T3 cells (black trace, N=10 cells/surface). The gray area enclosed by the black dashed lines represents the 95% confidence band. According to the rates of change in contact angle for each cell, no statistical outliers (95% confidence) were determined.

FIG. 15C shows images of a single 3T3 cell from the time it first contacted a PTFE surface and 30, 60, and 90 minutes after adhesion. The cell is imaged at the edge of the surface.

FIG. 15D shows a plot depicting the changes in contact angle of single 3T3 cells as represented by different symbols and the average change in contact angle of all 3T3 cells (black trace, N=10 cells/surface). The gray area enclosed by the dashed lines represents the 95% confidence band. According to the rates of change in contact angle for each cell, one statistical outlier (95% confidence) was determined.

FIG. 16A shows images of a single HEK293 cell from the time it first contacted a glass surface and 30, 60, and 90 minutes after adhesion. The cell is imaged at a distance beyond the edge of the surface, resulting in a reflection of the cell. White dashed lines represent the interface between the cell and the surface. Generally, in reference to FIGS. 16A-16F, a LEFT PANEL (FIGS. 16A and 16B) shows the use of lateral microscopy to observe morphology changes to HEK293 cells on glass during adhesion, a MIDDLE PANEL (FIGS. 16C and 16D) shows the use of lateral microscopy to observe morphology changes to HEK293 cells on collagen-coated glass during adhesion, and a RIGHT PANEL (FIGS. 16E and 16F) shows the use of lateral microscopy to observe morphology changes to HEK293 cells on collagen-alginate hydrogels during adhesion.

FIG. 16B shows a plot depicting the changes in contact angle of single HEK293 cells as represented by different symbols and the average change in contact angle of all HEK293 cells (black trace, N=10 cells/surface). The gray area enclosed by the black dashed lines represents the 95% confidence band. According to the rates of change in contact angle for each cell, one statistical outlier (95% confidence) was determined.

FIG. 16C shows images of a single HEK293 cell from the time it first contacted a collagen surface and 30, 60, and 90 minutes after adhesion. White dashed lines represent the interface between the cell and the surface.

FIG. 16D shows a plot depicting the changes in contact angle of single HEK293 cells as represented by different symbols and the average change in contact angle of all HEK293 cells (black trace, N=10 cells/surface). The gray area enclosed by the black dashed lines represents the 95% confidence band. According to the rates of change in contact angle for each cell, no statistical outliers (95% confidence) were determined.

FIG. 16E shows images of a single HEK293 cell from the time it first contacted a hydrogel surface and 30, 60, and 90 minutes after adhesion. White dashed lines represent the interface between the cell and the surface.

FIG. 16F shows a plot depicting the changes in contact angle of single HEK293 cells as represented by different symbols and the average change in contact angle of all HEK293 cells (black trace, N=10 cells/surface). The gray area enclosed by the black dashed lines represents the 95% confidence band. According to the rates of change in contact angle for each cell, no statistical outliers (95% confidence) were determined.

FIG. 17A shows images of a single HEK293 cell from the time it first contacted a Nylon surface and 30, 60, and 90 minutes after adhesion. The cell is imaged at a distance beyond the edge of the surface, resulting in a reflection of the cell. White dashed lines represent the interface between the cell and the surface. Generally in reference to FIGS. 17A-17D, a LEFT PANEL (FIGS. 17A and 17B) shows the use of lateral microscopy to observe morphology changes to HEK293 cells on Nylon during adhesion, and a RIGHT PANEL (FIGS. 17C and 17D) shows the use of lateral microscopy to observe morphology changes to HEK293 cells on PTFE during adhesion.

FIG. 17B shows a plot depicting the changes in contact angle of single HEK293 cells as represented by different symbols and the average change in contact angle of all HEK293 cells (black trace, N=10 cells/surface). The gray area enclosed by the black dashed lines represents the 95% confidence band. According to the rates of change in contact angle for each cell, one statistical outlier (95% confidence) was determined.

FIG. 17C shows images of a single HEK293 cell from the time it first contacted a PTFE surface and 30, 60, and 90 minutes after adhesion. White dashed lines represent the interface between the cell and the surface.

FIG. 17D shows a plot depicting the changes in contact angle of single HEK293 cells as represented by different symbols and the average change in contact angle of all HEK293 cells (black trace, N=10 cells/surface). The gray area enclosed by the black dashed lines represents the 95% confidence band. According to the rates of change in contact angle for each cell, two statistical outliers (95% confidence) were determined.

FIG. 18A shows images of a single MDA-MB-231 cell from the time it first contacted a glass surface and 30, 60, and 90 minutes after adhesion. The cell is imaged at the edge of the surface. Scale bar is 10 Generally, in reference to FIGS. 18A-18D, images represent use of lateral microscopy for observing morphology changes to MDA-MB-231 cells on glass during adhesion (FIGS. 18A-18B) and to observe morphology changes to MDA-MB-231 cells on PTFE during adhesion (FIGS. 18C-18D).

FIG. 18B is a plot showing the changes in contact angle of single MDA-MB-231 cells as represented by different symbols and the average change in contact angle of all MDA-MB-231 cells (black trace, N=10 cells). The gray area enclosed by the black dashed lines represents the 95% confidence band. According to the rates of change in contact angle for each cell, there were no statistical outliers (95% confidence).

FIG. 18C shows images of a single MDA-MB-231 cell from the time it first contacted a PTFE surface and 30, 60, and 90 minutes after adhesion. The cell is imaged at a distance beyond the edge of the surface. White dashed lines represent the interface between the cell and the surface. A cell has rolled into the field of view in the 90 minute image. Scale bar is 10 μm.

FIG. 18D is a plot showing the changes in contact angle of single MDA-MB-231 cells as represented by different symbols and the average change in contact angle of all MDA-MB-231 cells (black trace, N=10 cells). The gray area enclosed by the black dashed lines represents the 95% confidence band. According to the rates of change in contact angle for each cell, there were no statistical outliers (95% confidence).

FIG. 19 shows images of an exemplary fluorescence lateral microscope set-up.

FIG. 20A shows an image of a cell illuminated in brightfield mode.

FIG. 20B shows an image of a cell illuminated in fluorescence mode using DIL, a general membrane dye.

FIG. 20C shows an image of a cell illuminated in fluorescence mode using FITC, a general protein dye.

FIG. 21A shows a single MDA-MB-231 cell that has maintained an unique pedestal morphology after 30, 60 and 90 minutes of adhesion, resulting in a change in the height of the cell that is quantified as a percentage of the cell's original diameter. White dashed lines represent the interface between the cell and the surface. Scale bars is 10 Generally, in reference to FIGS. 21A-21F, a LEFT PANEL (FIGS. 21A and 21B) shows the use of lateral microscopy to observe morphology changes to MDA-MB-231 cells on collagen-coated glass during adhesion, a MIDDLE PANEL (FIGS. 21C and 21D) shows the use of lateral microscopy to observe morphology changes to MDA-MB-231 cells on Nylon during adhesion, and a RIGHT PANEL (FIGS. 21E and 21F) shows the use of lateral microscopy to observe morphology changes to MDA-MB-231 cells on collagen-alginate hydrogels during adhesion.

FIG. 21B shows a table of the average changes in height of MDA-MB-231 cells on collagen-coated glass at each time point (N=10 cells/surface).

FIG. 21C shows a single MDA-MB-231 cell that has maintained an unique pedestal morphology after 30, 60 and 90 minutes of adhesion, resulting in a change in the height of the cell that is quantified as a percentage of the cell's original diameter.

FIG. 21D shows a table of the average changes in height of MDA-MB-231 cells on Nylon at each time point (N=10 cells/surface).

FIG. 21E shows a single MDA-MB-231 cell that has adopted a unique pedestal morphology at 60 minutes of adhesion, resulting in a change in the height of the cell that is quantified as a percentage of the cell's original diameter. The cell has resumed adhesion by way of spreading at 90 minutes.

FIG. 21F shows a table of the average changes in height of MDA-MB-231 cells on Nylon at each time point (N=10 cells/surface).

FIG. 22A shows a side view of a lateral flow chamber for use with the lateral view microscope described herein, according to one embodiment.

FIG. 22B shows a close-up side view of the lateral flow chamber of FIG. 22A, with a cover removed.

FIG. 22C shows the cover of FIG. 22B in place.

FIG. 23A shows a diagnostic assay of cell migration in which MDA-MB-231 cells invade Matrigel™ (reconstituted extracellular matrix).

FIG. 23B shows a diagnostic assay of cell invasion, using invasion depth as a function of time to characterize the invasion potentials of cancer cells.

FIG. 24A shows modifications to a conventional Boyden chamber for use with a lateral view microscope.

FIG. 24B shows modifications to a modified Boyden chamber for use with a lateral view microscope.

FIG. 25A is an image showing a membrane-free invasion assay set-up.

FIG. 25 is an image showing dynamic analysis of cell invasion.

FIG. 26A shows a Diagnostic Assay: correlating Cell morphology, surface marker expression and phenotype in MCF-7 cells grown on glass substrates coated in E-cadherin.

FIG. 26B shows a Diagnostic Assay: correlating Cell morphology, surface marker expression and phenotype in MDA-MB-231 cells grown on glass substrates coated in E-cadherin.

FIG. 26C shows the number of invasive cells shown in FIGS. 26A-26B based on cell surface expression.

FIG. 26D shows data relating to the contact angle of weakly invasive or non-invasive cells shown in FIGS. 26A-26B as a function of time.

FIG. 27A shows a diagnostic assay: small molecule interference with actin and its effect on cell morphology and adhesion: an exemplary drug screen. The change in contact angle upon treatment with 10 μm blebbistatin is shown.

FIG. 27B shows a diagnostic assay: small molecule interference with actin and its effect on cell morphology and adhesion: an exemplary drug screen. The change in contact angle upon treatment with 50 μm blebbistatin is shown.

FIG. 28 illustrates lateral microscopy for observing morphology changes to H9 T lymphocytes on glass, collagen-coated glass, Nylon, PTFE, and collagen-alginate hydrogel surfaces during adhesion. The average changes in contact angles of H9 cells on each surface are plotted and remained relatively constant (N=10 cells for each surface).

FIG. 29A illustrates a pressure transduction system with a differential height pressure transducer.

FIG. 29B illustrates a pressure transduction system with a Raspberry Pi computer and stepper motor driver.

FIG. 29C illustrates a pressure transduction system with a Raspberry Pi workstation monitor.

FIG. 30A illustrates a micropipette aspiration equipment with a coarse adjustment manipulator.

FIG. 30B illustrates a micropipette aspiration equipment with a fine adjustment micromanipulator.

FIG. 30C illustrates a micropipette aspiration equipment with a micropipette aspiration equipment is mounted to the live-cell enclosure of the lateral microscope and used to manipulate the micropipette holder.

FIG. 31 is an image of the micropipette aspiration equipment and pressure transduction in use with the lateral microscope.

FIG. 32A illustrates a schematic in which an experimental approach is illustrated for force measurements of single cells. In the schematic, a micropipette is positioned above a cell adhered to a glass surface.

FIG. 32B illustrates a further schematic of the experimental approach of FIG. 32A, showing suction pressure (ΔP) being applied to the cell.

FIG. 32C illustrates a further schematic of the experimental approach of FIG. 32A, showing the suction pressure (ΔP) detaching the cell from a surface. The maximum pressure (ΔPₘₐₓ) is proportional to the adhesion force.

FIG. 32D illustrates an example in which a micropipette is positioned above a two-cell aggregate of MDA-MB-231 breast cancer cells, which are adhered to a glass surface.

FIG. 32E illustrates the suction pressure being applied to the two-cell aggregate of MDA-MB-231 breast cancer cells of FIG. 32D.

FIG. 32F illustrates the suction pressure detaching the two-cell aggregate of MDA-MB-231 breast cancer cells of FIG. 32D from the glass surface.

FIG. 33A illustrates a single cell held in the tip of a micropipette.

FIG. 33B illustrates the single cell of FIG. 33A released onto a sample surface using positive pressure.

FIG. 33C demonstrates the use of the described system illustrated in FIGS. 33A-33B for controlled single-cell arraying.

FIG. 34 illustrates an example of three-dimensional arraying of single cells in a vertical arrangement.

FIG. 35 is a schematic of a micropipette aspiration apparatus used to measure cell adhesion forces. Valves allow for calibration of the system and loading of the micropipette using a syringe. Although not shown, the container is mounted on the lateral microscope stage for simultaneous imaging.

FIG. 36 illustrates gold surfaces patterned with self-assembled monolayers by microcontact printing enables multiplexed investigations of ligands that promote (SAM 1) or resist (SAM 2) cell adhesion.

### DETAILED DESCRIPTION

Provided herein is an imaging system comprising imaging optics that are aligned with the sample plane and that permit e.g., direct imaging of cells, interaction of cells with a surface material, and cell responses to external stimuli (e.g., contact with one or more biological agents). Also provided herein are methods for measuring a variety of cell characteristics/responses including, but not limited to, contact angle, cell morphology, cell rolling, adhesion, and invasiveness. The imaging system can also be applied to magnifying and imaging non-biological samples comprising a particle.

### Definitions

As used herein, the term “sample” refers to a sample comprising at least one cell and/or at least one particle. The term “biological sample” is used herein to refer to a biological sample comprising at least one cell, while a “sample” further encompasses particles, which can be synthetically produced. In one embodiment, a “biological sample,” as that term is used herein, refers to a sample obtained from a subject. The term “biological sample” is intended to encompass samples that are processed prior to imaging using the systems and methods described herein. For example, a biological sample can be a whole blood sample obtained from a subject, or can be further processed to a serum sample, a platelet sample, an exosome sample, etc. The term “biological sample” further encompasses cells obtained from a subject (e.g., primary cells) or cells derived from a subject (e.g., cultured and/or immortalized cells).

As used herein, the term “subject” refers to an animal, particularly a human, from which a biological sample is obtained or derived from. The term “subject” as used herein encompasses both human and non-human animals. The term “non-human animals” includes all vertebrates, e.g., mammals, such as non-human primates, (particularly higher primates), sheep, dog, rodent (e.g., mouse or rat), guinea pig, goat, pig, cat, rabbits, cows, and non-mammals such as chickens, amphibians, reptiles etc. In one embodiment, the subject is human. In another embodiment, the subject is an experimental animal or animal substitute as a disease model. In some embodiments, the term “subject” refers to a mammal, including, but not limited to, murines, simians, humans, felines, canines, equines, bovines, mammalian farm animals, mammalian sport animals, and mammalian pets. In one embodiment, the subject is a human subject.

As used herein, the term “particle” refers to substantially spherical bodies or membranous bodies from 500 nm-999 μm in size, such as e.g., liposomes, micelles, exosomes, microbubbles, or unilamellar vesicles. In some embodiments, the particle is less than 900 μm, less than 800 μm, less than 700 μm, less than 600 μm, less than 500 μm, less than 400 μm, less than 300 μm, less than 200 μm, less than 100 μm, less than 90 μm, less than 80 μm, less than 75 μm, less than 70 μm, less than 60 μm, less than 50 μm, less than 40 μm, less than 30 μm, less than 25 μm, less than 20 μm, less than 15 μm, less than 10 μm, less than 5 μm, less than 2 μm, less than 1 μm, less than 750 nm, less than 500 nm or smaller. Nanoparticles less than 500 nm (e.g., 1 nm-500 nm) can also be visualized using the methods and systems described herein, however a label will be necessary to visualize the nanoparticles. In such embodiments, a nanoparticle can be less than 400 nm, less than 300 nm, less than 200 nm, less than 100 nm, less than 50 nm, less than 40 nm, less than 30 nm, less than 20 nm, less than 10 nm, less than 5 nm, or smaller.

As used herein, the term “illuminating optics” refers to an illumination lens or lens system which gathers light from a light source and directs the light to a sample.

As used herein, the term “imaging optics” refers to an imaging lens or lens system which gathers light rays that have passed through the sample and permits viewing of a magnified image of the cell or particle within the sample.

As used herein, the term “aligned with,” with respect to a light beam or imaging optics, means that the orientation of the light beam and/or imaging optics is substantially parallel to the sample plane (e.g., the interface). In one embodiment, “aligned with” is less than 0.1 degree from parallel in any direction. In other embodiments, the term “aligned with” means less than 0.2, less than 0.3, less than 0.4, less than 0.5, less than 1, less than 2, less than 3, less than 4, less than 5 degrees from parallel in any direction.

As used herein, the term “interface” refers to a surface formed in the sample container (e.g., between two phases of different densities) and can comprise a surface formed between any liquid and any polymer, a surface formed between two immiscible liquids, or a surface formed between any liquid and a biological material, including e.g., cultured cells. The interface can comprise essentially any shape including 3-dimensional shapes. The term “interface” also refers to the surface on which the cell or particle interacts. In one embodiment, the interface is an opaque material, for example, materials that cannot be used with conventional light microscopy set-ups.

As used herein, the term “conventional light microscopy” refers to a system where the light beam passes through the sample in an upright (i.e., top-down) or inverted (i.e., bottom-up) configuration; that is, the light beam and the optics are orthogonal (e.g., at a substantially right angle (90°) with the interface in the sample container).

As used herein, the term “output parameter” refers to a qualitative or quantitative parameter that is representative of the function of a cell and/or particle in the sample. In some embodiments, the output parameter is the same as the cell and/or particle function. For example, the output parameter ‘contact area’ is a measure of the area of the cell in contact with the interface and if measured over a plurality of time points can provide a functional measure of “cell attachment” and/or “cell detachment.” Similar, the distance (d) that a cell traverses over a plurality of time points can be used as a measure of cell migration. In other embodiments, the output parameter and the function are the same, for example, when viewing morphology of cells known to change shape or size in response to an input (e.g., contact with a cytokine).

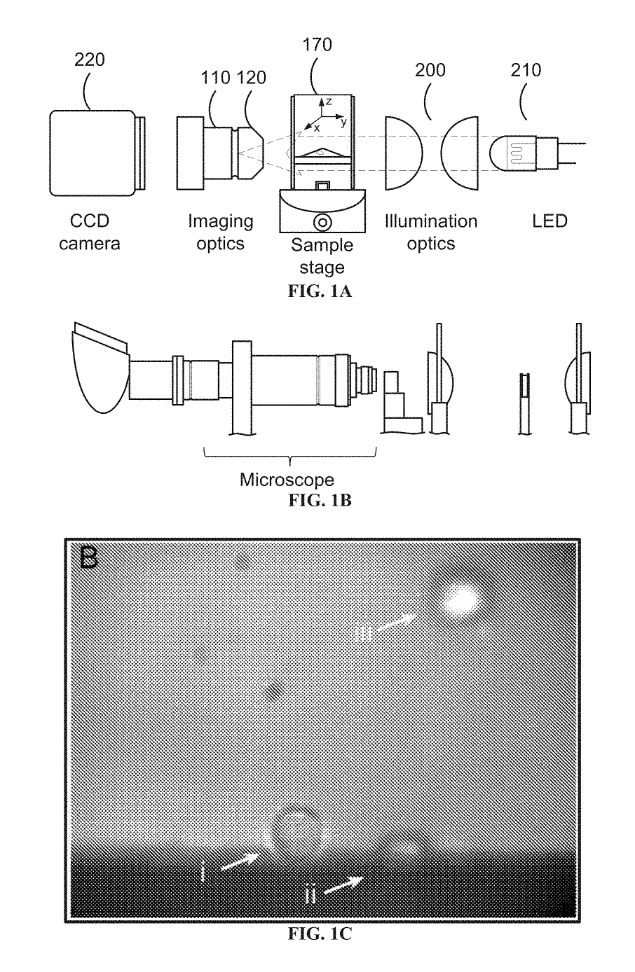

As used herein, the term “contact angle” refers to the angle generated between a cell or particle when in contact with the interface. In one embodiment, the contact angle of a cell or particle is measured by identifying the interface boundary and drawing a line tangent to the cell membrane or particle from the point of intersection (e.g., see FIG. 1C).

As used herein, the term “directly measuring” refers to the direct magnification, visualization, imaging, and/or measuring of an output parameter using the imaging systems described herein. That is, the output parameter can be directly observed using the imaging system and in some cases, the actual quantitative value can be determined. For example, the imaging systems described herein permit direct measure of contact angle of a cell/particle and an interface. In contrast, conventional light microscopy, where the light beam and optics are oriented in a top-down or bottom-up configuration, only permit measurement of contact angle; for example, by imaging through different depths of field to achieve image slices in the ‘z’ plane that are then compiled using software to indirectly estimate the contact angle.

As used herein, the term “laterally” refers to imaging of the cell and/or particle wherein the optics are aligned with the interface; that is, the cell is imaged from the “side” using conventional microscopy as a reference for top/bottom orientation.

As used herein, the term “total magnification” refers to the total magnification of the cell or particle obtained by the compound magnification of the ocular lens and the objective lens. The total magnification can be determined by multiplying the magnification of the ocular lens (e.g., typically 10×) by the magnification of the objective lens. For example, the total magnification of a lateral microscope using a 10× ocular lens and a 63× objective lens is 630× (i.e., (10×)×(63×)).

As used herein, the term “comprising” means that other elements can also be present in addition to the defined elements presented. The use of “comprising” indicates inclusion rather than limitation.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Further, unless otherwise required by context, singular terms shall include pluralities and plural terms shall include the singular.

Other than in the operating examples, or where otherwise indicated, all numbers expressing quantities of ingredients or reaction conditions used herein should be understood as modified in all instances by the term “about.” The term “about” when used in connection with percentages can mean±1%.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. The terminology used herein is for the purpose of describing particular embodiments only, and is not intended to limit the scope of the present invention, which is defined solely by the claims. Definitions of common terms in molecular biology can be found in The Merck Manual of Diagnosis and Therapy, 19th Edition, published by Merck Sharp & Dohme Corp., 2011 (ISBN 978-0-911910-19-3); Robert S. Porter et al. (eds.), The Encyclopedia of Molecular Cell Biology and Molecular Medicine, published by Blackwell Science Ltd., 1999-2012 (ISBN 9783527600908); and Robert A. Meyers (ed.), Molecular Biology and Biotechnology: a Comprehensive Desk Reference, published by VCH Publishers, Inc., 1995 (ISBN 1-56081-569-8); Immunology by Werner Luttmann, published by Elsevier, 2006; Lewin's Genes XI, published by Jones & Bartlett Publishers, 2014 (ISBN-1449659055); Michael Richard Green and Joseph Sambrook, Molecular Cloning: A Laboratory Manual, 4th ed., Cold Spring Harbor Laboratory Press, Cold Spring Harbor, N.Y., USA (2012) (ISBN 1936113414); Davis et al., Basic Methods in Molecular Biology, Elsevier Science Publishing, Inc., New York, USA (2012) (ISBN 044460149X); Laboratory Methods in Enzymology: DNA, Jon Lorsch (ed.) Elsevier, 2013 (ISBN 0124199542); Current Protocols in Molecular Biology (CPMB), Frederick M. Ausubel (ed.), John Wiley and Sons, 2014 (ISBN 047150338X, 9780471503385), and Current Protocols in Protein Science (CPPS), John E. Coligan (ed.), John Wiley and Sons, Inc., 2005 (ISBN 0471142735), the contents of which are all incorporated by reference herein in their entireties.

### Imaging System/Lateral Microscope

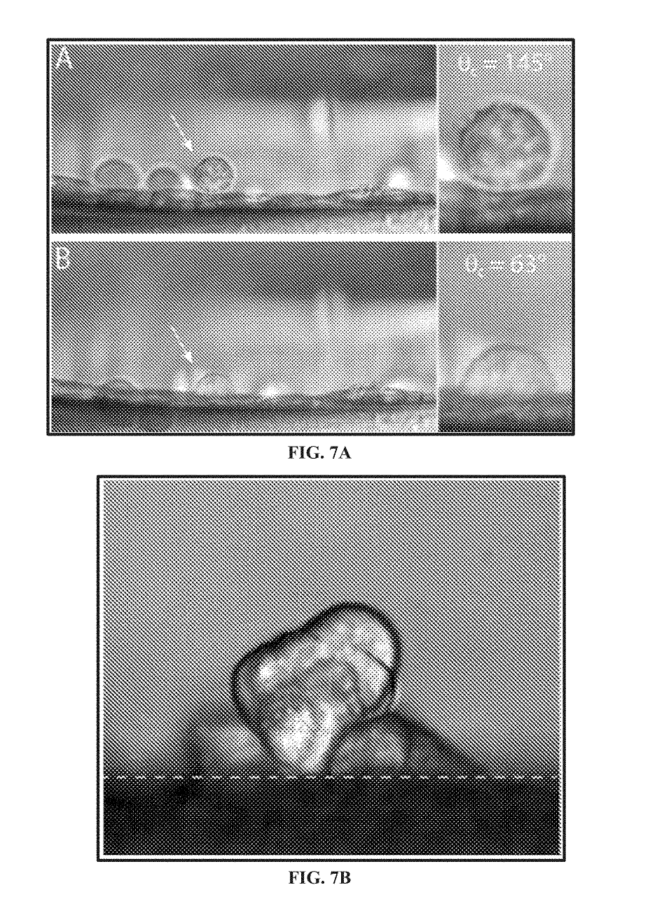

At a minimum, referring to FIG. 8, the imaging systems described herein comprise (i) a sample container 140 with an interface surface 180 where a sample 160 is introduced, (ii) a light beam aligned with the sample plane 190 and (iii) imaging optics 110 aligned with the interface 180 in the sample container 140. The light beam is generated from an illumination source 210 that is aligned with the sample plane 190 or imaging axis 130. The illumination source 210 can comprise a light source in the visible range, a UV light source, an infrared light source, a laser light source, etc. In one embodiment, the imaging system further comprises illuminating optics 200 to focus the light beam 190 from the illumination source 210 along the illumination axis 190. The system optionally includes a stage 170 moveable in the x, y, and/or z plane to permit focusing and/or imaging of the cell/particle 150 in the sample, and in particular to image the interface 290 between the cell/particle and the surface. The imaging optics further optionally include an optical lens 120. Generally, any optical lens (including a zoom lens) can be configured for use with the imaging systems described herein, provided that they are of sufficient power to permit imaging of objects (e.g., cells, particles, etc.) in the micrometer range. The optical lens can comprise a magnification of e.g., 2×. 4×, 10×, 35×, 40×, 50×, 63×, 100×. The imaging system can magnify up to 1500× total magnification (optical lens+objective lens magnification). For example, 200-630× range can be obtained using 20-63× objective lenses and the imaging optics that comprise the lateral microscope. The imaging optics 110 and the optical lens 120 together form the basic microscope 100. The imaging system can further comprise an imaging device 220, which can comprise a camera, a video camera, a charge-coupled device (CCD) camera, a complementary metal-oxide-superconductor (CMOS) sensor, a diode array, and the like. The system can further comprise a vibration isolation system.

### Removable Components/Consumables

Sample Containers for Static Cell Adhesion Experiments:

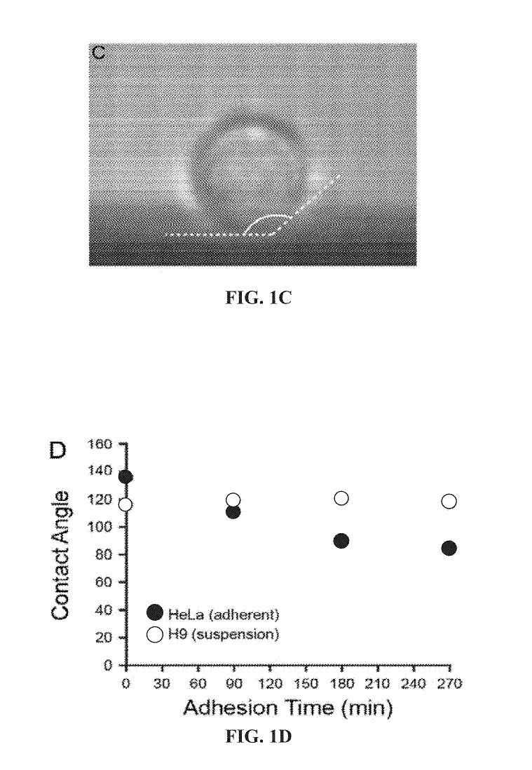

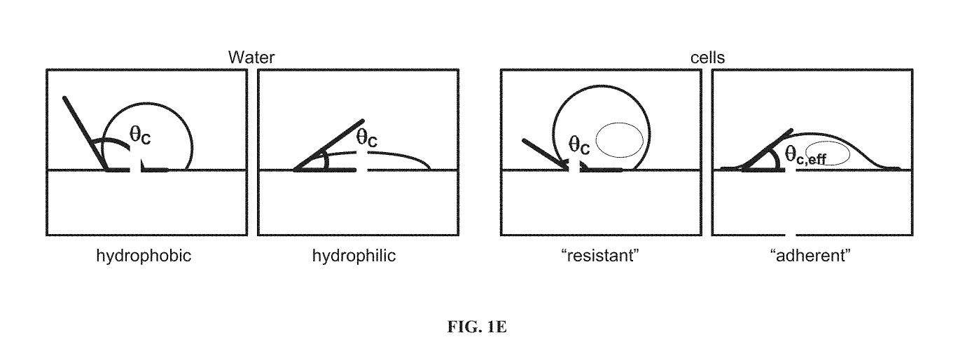

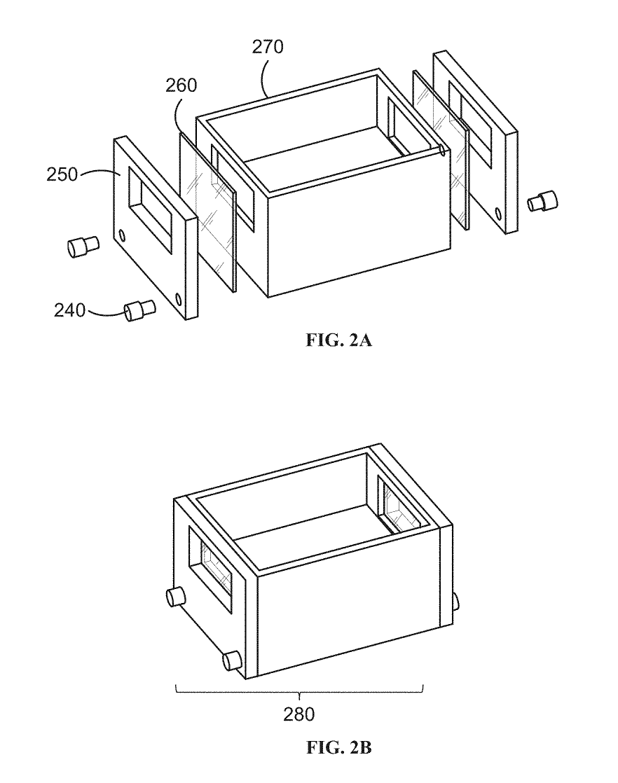

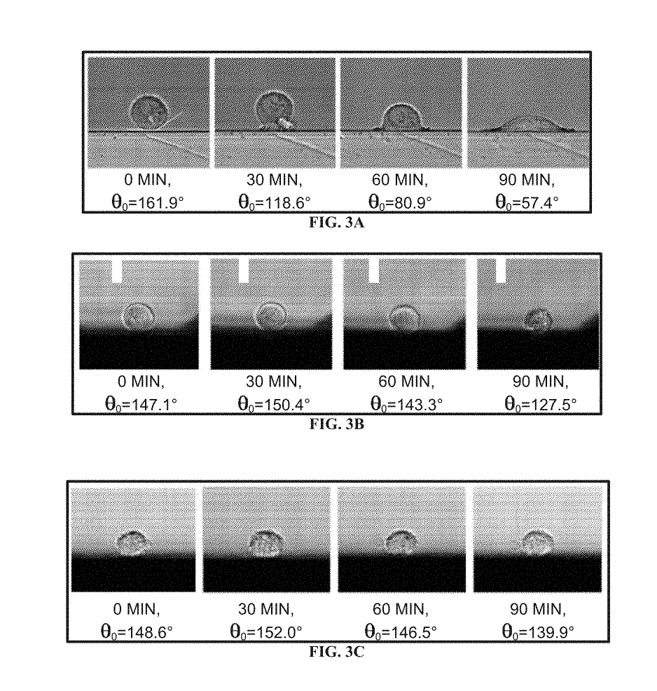

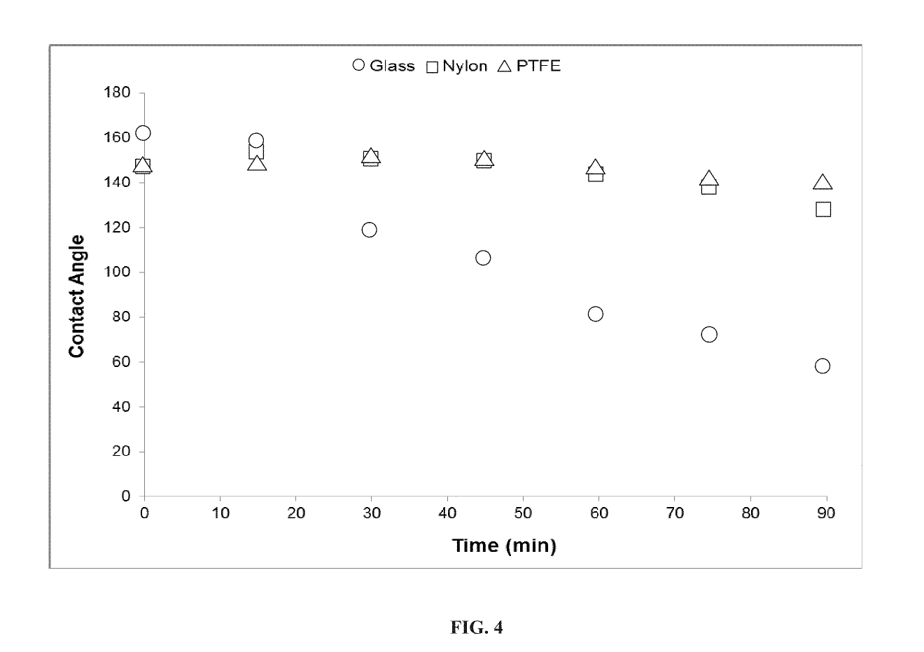

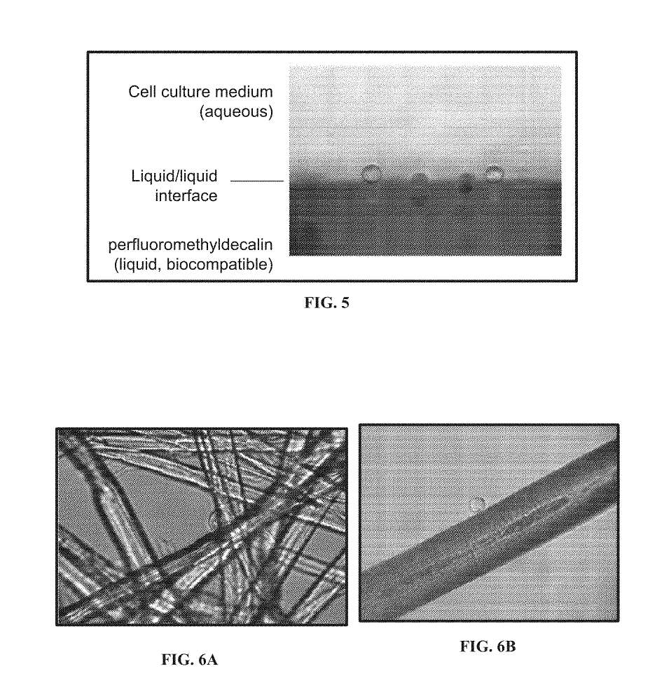

In some embodiments, the sample container 140 is a sample container comprising removable windows 280 (see FIGS. 2A-2B). Such a sample container 280 comprises a body 270, removable windows 260, and end pieces 250, which are held in place with fasteners 240 (e.g., pegs or screws).

In other embodiments, the sample container 140 is a sample container comprising a polyethylene U-channel 310 cut into 0.5 inch pieces to serve as the framework of each sample container. A double-sided adhesive can be used to adhere a glass coverslip 300 to each of the long sides of the sample container to create the remaining two walls through which light can pass to reach the objective lens of the lateral microscope. The outer edges of the coverslips 300 in contact with the U-channel 310 can be coated in epoxy to ensure proper sealing and prevent leaking upon the addition of a sample e.g., cell culture media. A channel is milled into the bottom of each U-channel piece 310 in order to align the sample container perpendicular to the objective lens on the sample stage of the lateral microscope. A nylon surface is included in one of the images, but the surface can be easily interchanged.

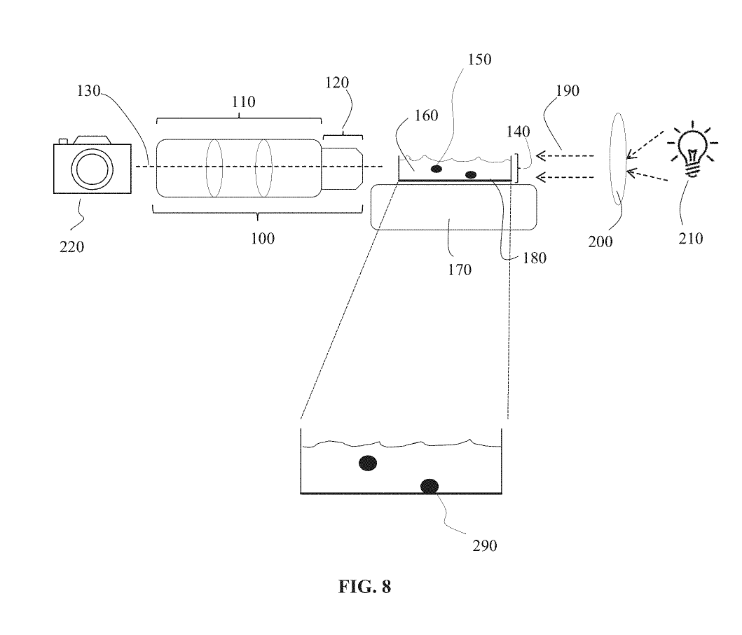

In another embodiment, to enable long-term observations of changes to cell morphology in the lateral microscope, a custom sample container was developed as shown in FIGS. 9B and 9C. The body of this container was made from a ultra-high molecular weight polyethylene u-channel. The u-channel was cut to a specific length depending on the desired sample volume. After the channel was cut, its sides were milled and sanded to remove any coarse edges. A u-shaped piece of double-sided adhesive, matching the contour of the channel's cross-section, was placed on each cut face of the piece. Glass coverslips were then pressed onto the adhesive to create a liquid-tight seal. Sample surfaces can be adhered to the bottom of this transparent-walled container to enable the study of cell adhesion to different materials. To ensure reproducible mounting of this sample container in the lateral microscope, a small channel is milled across the bottom of the sample container. This channel fits snugly over a piece of solid material attached to the top of the lateral microscope's goniometer.

Chamber for Flow-Based Cell Adhesion Experiments:

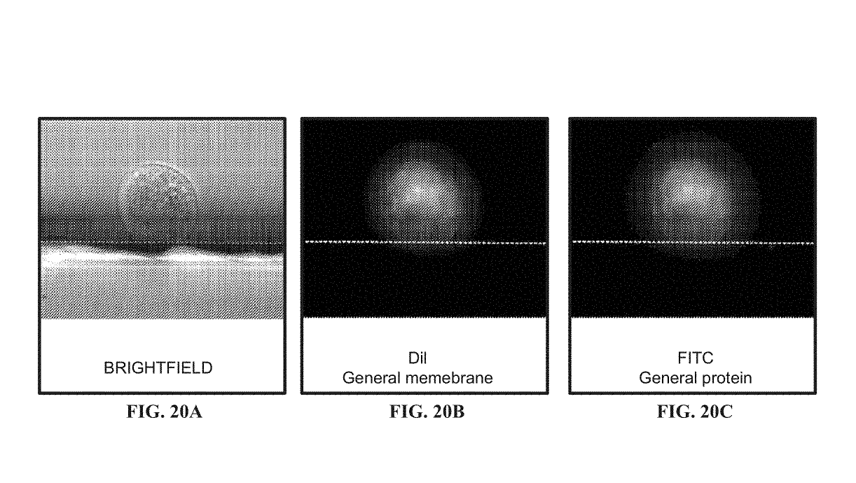

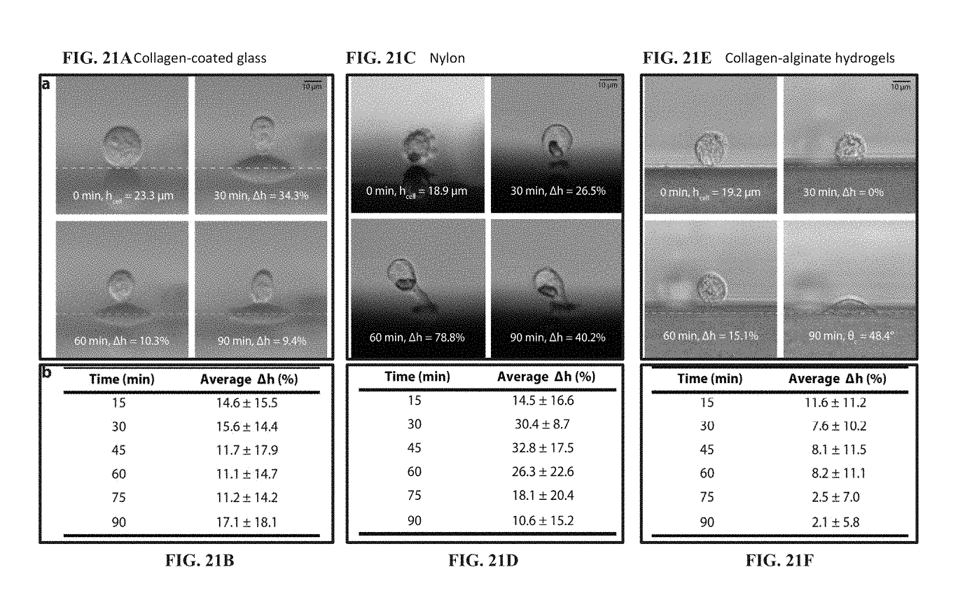

To enable monitoring of cell adhesion under dynamic conditions (liquid flow, perfusion of different liquids, etc.) a custom flow chamber was developed for use with the lateral microscope (see e.g., FIGS. 22A-22C for one embodiment of a flow chamber). This device was machined from a solid stock of aluminum. A u-channel was milled in the center of the aluminum piece. A hole was drilled in each side of the piece so that the center of the flat-bottomed holes was aligned with the bottom of the milled u-channel. These holes were threaded to allow for the fastening of barbed tubing fittings. These fittings serve as the inlet and outlet of the device. A second u-channel was milled in the center of the device—this channel allows for the mounting of a sample surface that sits evenly with the bottom of the flow chamber. A lid, matching the contour of the milled flow chamber volume, was machined to allow for low-volume, laminar flow experiments. Concentric holes were drilled in the lid and device body; the holes in the device body were threaded to allow the lid to be mounted with screws. The spacing between the lid and flow chamber surface can be modulated by placing spacers (washers, etc.) between the lid and the device body. Glass coverslips are sealed to the sides of the device body to create a fluid-tight seal while allowing for observation of cells under flow.

Modified Boyden Chamber for Cell Invasion Experiments:

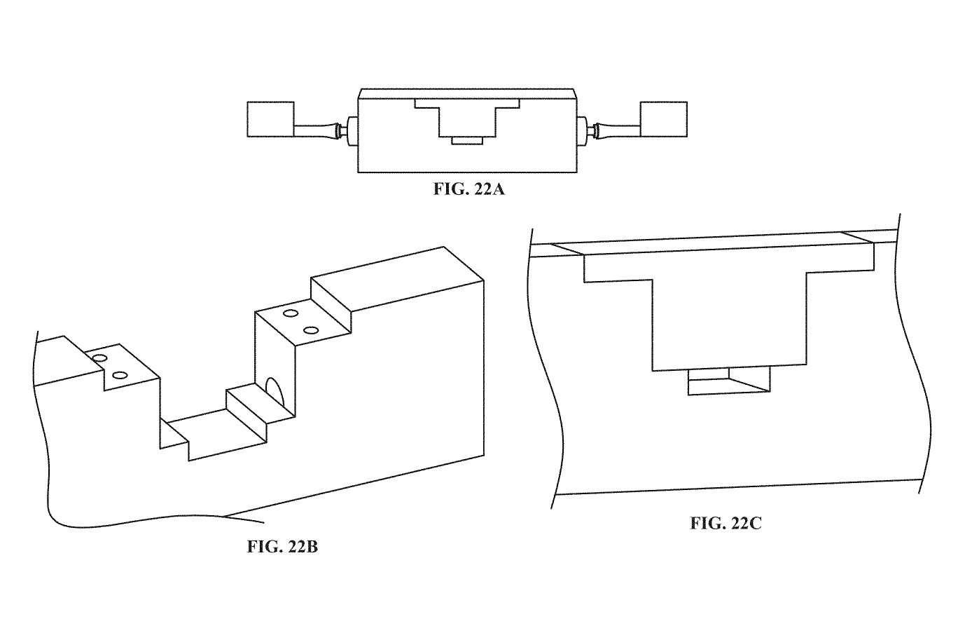

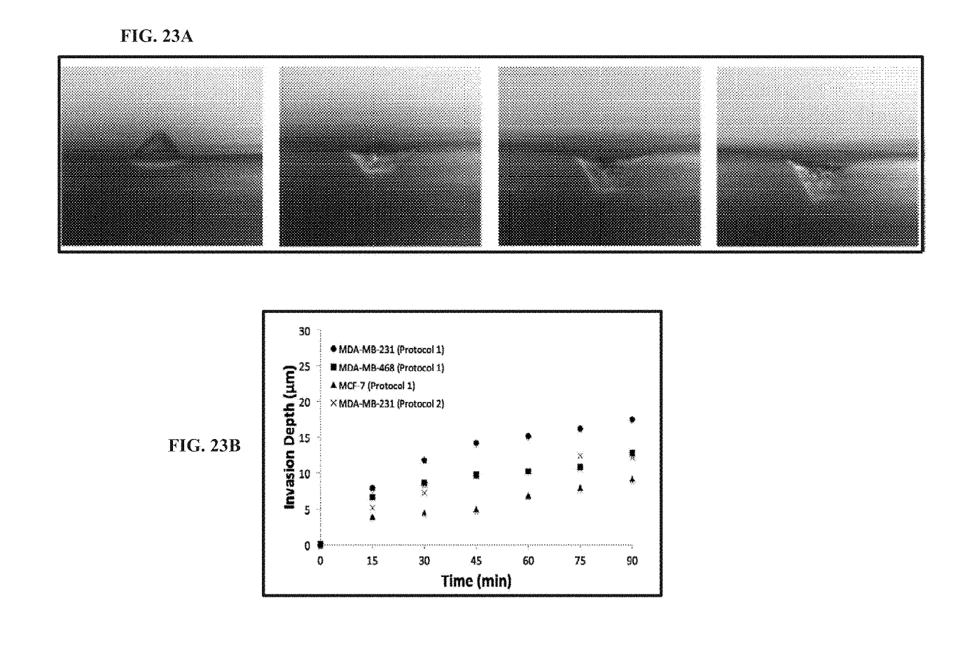

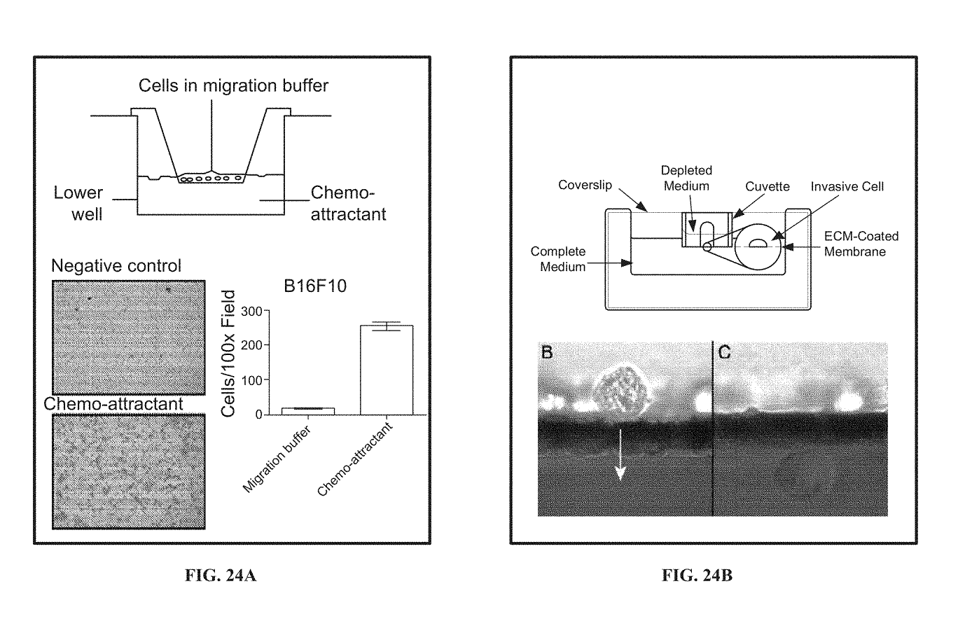

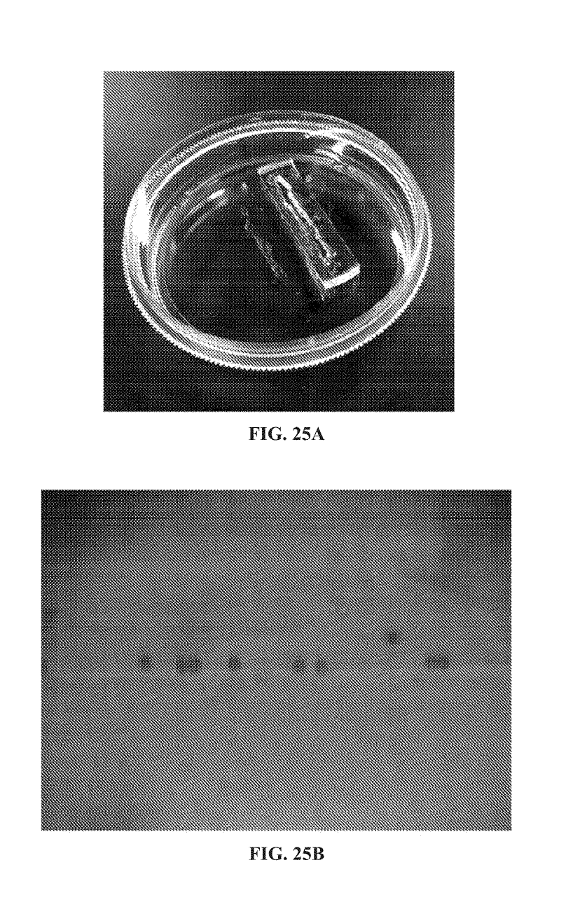

To enable studies of cellular response to a chemical gradient (invasion, etc.) a modified version of the Boyden Chamber (see e.g., FIG. 24B) was developed for use with the lateral microscope. The fabrication of this device involved an alteration to the sample container described above. A plastic cuvette was cut to a length to fit inside the sample container. The cut edges of the cuvette were milled to remove any coarse edges. Additionally, protrusions on the front of the cuvette were milled away to allow for flat mounding of the cuvette wall to the glass surface of the sample container wall. A viewing window was milled in the wall of the cuvette to allow for imaging in the lateral microscope, as the thickness of the cuvette exceeds the working distance/focal length of most high-magnification microscopy lenses. A track-etched membrane was cut to match the cross-sectional area of the cuvette. This membrane was adhered to the open end of the cuvette, such that the membrane spanned the length of the viewing window, using a UV-curable adhesive. This same adhesive was used to adhere the cuvette device to the inside of the sample container wall so that the cuvette and remainder of the sample were sealed as independent chambers. Images can be acquired by focusing the microscope objective on the membrane cross-section in the viewing window.

This membrane in the modified Boyden chamber device can be coated with different matrices (collagen, Matrigel, PuraMatrix, etc.) to facilitate invasion assays. In these experiments, cells are added to the upper chamber (cuvette) in serum-free medium. The remainder of the sample container is filled with complete medium, and cells migrate through the membrane in response to the established chemical gradient. Unlike invasion assays performed in conventional microscopes, this lateral microscopy experiment allows for real-time monitoring of cell migration events. It is possible to perform this experiment in a flow-based device, allowing for the collection of selected cells after migration.

The components of the imaging system can be obtained commercially from e.g., ZEISS, NIKON, OLYMPUS, and LEICA and configured as desired or as described herein.

### Fluorescence Lateral Microscope

To give the lateral microscope capabilities comparable to commercially available fluorescence microscopes, a fluorescence lateral microscope was developed. This was achieved through the modification of a commercially available fluorescence stereo microscope. Custom aluminum mounting equipment was fabricated and used to orient the optical pathway of the microscope parallel to the optical table on which it was mounted. Additional mounting equipment was fabricated to incorporate positioning stages into the instrument. One vertical motorized stage and one linear motorized stage were used for sample positioning. The motorized drive of the microscope was used for image focusing. A Köhler™ condenser was mounted to the instrument with a custom-fabricated bracket. This condenser was paired with a custom-fabricated high-powered cold white LED array to enable brightfield and phase contrast imaging. An aperture was placed on the light source to control illumination through the condenser. An opaque black enclosure was constructed around the instrument from laser-cut acrylic. This enclosure blocks out light from the surrounding environment to reduce background fluorescence signal in acquired images and videos. In addition to fluorescence, this microscope is also capable of brightfield and phase-contrast imaging.

This instrument can image endogenously expressed or exogenous fluorescent molecules and enables observation of protein localization, protein expression, stress fiber formation, cell signaling, etc. It is possible to pair this instrument with confocal microscopy equipment to enable optical sectioning microscopy in the field of view offered by the lateral microscope.

### Aspiration System for Manipulation of Single Cells

Described herein is a micropipetting system that uses the application of small (ca. Pascal) amounts of positive or negative pressure to manipulate and aspirate single cells. The use of this aspiration system enables the measurement of the force of adhesion between a cell and a surface. Unlike other methods that are used currently (e.g., single-cell forces spectroscopy), the use of pressure is non-destructive and permits replicate measurements. In addition to aspirating the entire cell, only a portion of the cell may be withdrawn into the pipette; this can examine the stiffness of the cell membrane. Further, this aspiration system can be used to dispense and site-specifically array single cells over a surface. In total, this approach enables (i) precise and quantitative measurements related to cell biology, and (ii) a new method of tissue engineering.

In order to complete micropipette aspiration experiments, a custom pressure transduction device was designed and fabricated. This device consists of two liquid reservoirs that can be manipulated with micron-scale precision to transduce pressures on the order of a single Pascal in the tip of a micropipette. The two liquid reservoirs were fabricated from clear cast acrylic using a lathe. These reservoirs have barbed tip outlets and are connected by 1/16″ ID (inner diameter) tubing and a barbed T-fitting. The third barb of the T-fitting is connected to a Warner Instruments micropipette holder. The reservoirs are held in custom fabricated foam-lined aluminum plates. These plates are connected to M5 threaded rods attached to stepper motors by custom adapters. These stepper motors are driven by custom software on a Raspberry Pi computer to move the liquid reservoirs up and down. The reservoir holding plates are held on one side by 12 mm linear travel bearings attached to 12 mm smooth rods. On the other side, near the reservoir, the plate is kept from wobbling during travel by a 3/16″ guide rod held by a rubber grommet in the plate. A magnetic position sensor with a digital read out was added to the pressure transduction device to measure the travel distance of the experimental reservoir. This measurement device has a resolution of 25.4 μm.

The coarse adjustment assembly for the micromanipulator was mounted to the top of the live-cell enclosure of the lateral microscope. The hydraulic micromanipulator assembly was attached to the coarse adjustment assembly. The micromanipulator is used to bring the micropipette into position, forming a seal on the membrane of an adhered cell, during aspiration experiments. The pressure transduction device has been used in preliminary experiments to aspirate adhered MDA-MB-231 cells from an octadecanethiol self-assembled monolayer (SAM) on a gold surface. After both reservoirs and the micropipette tip have been leveled to achieve zero net flow, the control reservoir is turned off using an in-line valve. Pressure can then be transduced in the micropipette tip by changing the height of the remaining reservoir. The height difference (h, m) can be obtained from the digital read out of the magnetic sensor. The applied pressure (P, Pa) can then be calculated according to the following equation:

P=μgh (Eq. 1)

Where ρ is the density of the liquid in the reservoirs (kg/m³) and g is the acceleration due to gravity. The motorized z stage that holds the sample in the lateral microscope is used to bring the cell into and out of contact with the micropipette tip. The force (F, N) on a cell held by a micropipette is expressed by Eq. 2 as the suction pressure P times the cross-sectional area of the pipette tip, where Rp is the radius of the pipette tip (m):

F=πR²ₚP (Eq. 2)

Cell adhesion forces are determined using micropipette aspiration in the following manner:
1. The pipette tip is brought into contact with a non-adhered cell (e.g., recently settled or on a non-adherent, Teflon surface) until a seal is formed between the tip and cell membrane. Small, increasing steps of pressure are applied until the cell has been aspirated into the pipette. The force required to aspirate the cell into the pipette is calculated from the minimum aspiration pressure.
2. The removed cell is placed on a test surface using the micromanipulator and allowed to adhere for a specified period of time. The cell is then detached from the surface and aspirated into the pipette. Again, small increasing steps in pressure are applied using the manometer. The total force for detachment and aspiration are calculated from the minimum pressure.
3. The forces of aspiration and detachment (adhesion) are decoupled by subtracting the force required for aspiration only from the total force required for detachment and aspiration.
4. To account for size differences among single cell populations, measured adhesion forces are normalized to the adhesion area of the cell. This aspiration approach can be used to perform replicate force measurements with a single cell on a unique test surface and across multiple test surfaces. Overall, the system described herein can measure forces with a resolution of 50 pN over a dynamic range of 0.05-500 nN. This aspiration system enables a number of unique applications, which include:
   the measurement of the cortical (membrane) tension of single cells;
   the measurements of the force required to reproducibly and non-destructively detach a single cell from a surface;
   the site-specific introduction of reagents to a single cell; and
   the ability to control the placement or arraying of single cells in three dimensions.

### Interfaces

Essentially any interface surface can be used for imaging cell and/or particle dynamics in relation to the interface. In some embodiments, particularly those involving cells, the interface does not interfere with cell viability, growth, adhesion, or any other functional parameter, unless so desired.

In some embodiments, the interface comprises at least one biologically active molecule, e.g., a cell adhesion molecule, an integrin, a cell attachment peptide, a peptide, a growth factor, an enzyme, a proteoglycan, or a polysaccharide.

In some embodiments, the interface comprises a cell culture matrix or cell culture scaffold, including 3-dimensional scaffolds. The terms “cell culture matrix” and “cell culture scaffold” are used interchangeably and refer to a matrix, which cells can grow on and/or in. In some embodiments, cells are seeded to grow within the matrix, e.g., within pores of the matrix. In other embodiments, cells will grow on the matrix, cells will attach to the matrix, or the cells will grow as spheroids within the cell culture matrix. In some embodiments, a cell culture matrix is 3-dimensional. In some embodiments, the interface (e.g., interface of a scaffold) comprises silk fibroin.

Synthetic interfaces (e.g., synthetic polymer interfaces) can also be used with the imaging systems described herein. Examples of such synthetic interface materials include, but are not limited to, are polylactic acid (PLA) polymer interfaces, polyglycolic acid (PGA) polymer interfaces and polylactic acid-polyglycolic acid (PLGA) copolymer interfaces including stereoisomeric forms thereof. In some embodiments, the interface comprises at least one compound selected from the group consisting of poly(vinyl alcohols), poly(alkylene oxides) particularly poly(ethylene oxides), polypeptides, poly(amino acids), such as poly(lysine), poly(allylamines), poly(acrylates), modified styrene polymers such as poly(4-aminomethyl styrene), polyesters, polyethers, polyamides, polyethylenes, fluorinated polyethylenes, polyurethanes, polysiloxanes, polyphosphazenes, pluronic polyols, polyoxamers, poly(uronic acids) and copolymers, including graft polymers thereof.

Also contemplated herein are interfaces comprising a metal or metallic coating. Non-limiting examples of metals or metal coatings include aluminum, platinum, titanium, gold, nickel, rhodium, or oxides or alloys thereof.

Interfaces of a 3-dimensional scaffold can also be imaged using the systems described herein. Such scaffolds can be any shape suitable for the particular in vitro, ex vivo or in vivo application. For example, a suitable shape can be produced utilizing freeze-drying techniques. In some embodiments, a cross-section can be round, elliptical, star shaped or irregularly polygonal, depending on the application. In some embodiments, the 3-dimensional scaffold can be nose shaped, cube shaped, cylindrical shaped and the like. In other embodiment, the scaffold can be shaped as desired, for example, for nerve, lung, liver, bone, cartilage, and/or soft tissue repair. The scaffold itself can be molded by the selection of a suitable vessel (e.g., a tissue culture vessel) in the methods of preparation or cut or formed into a specific shape that is desired or applicable for its end usage.

In some embodiments, the interface surface comprises a polysaccharide. In some embodiments, polysaccharides include, but are not limited to, alginates, gellan, gellan gum, xanthan, agar, and carrageenan. In some embodiments, a cell culture matrix comprises 1, 2, 3, 4, 5, 6, 7, 8, 9, 10 or more different polysaccharides.

The interface for measuring cell/particle dynamics using the imaging systems described herein can comprise a porous surface. In some embodiments, the average pore size of the surface is in the range between about 1 μm to about 1000 μm. In some embodiments, the porous surface has an average pore size of between from about 1 μm to about 500 μm; about 1 μm to about 250 μm; about 1 μm to about 100 μm; about 1 μm to about 50 μm; about 1 μm to about 25 μm; about 1 μm to about 10 μm; about 1 μm to about 5 μm; about 10 μm to about 1000 μm; about 25 μm to about 1000 μm; about 50 μm to about 1000 μm; about 100 μm to about 1000 μm; about 250 μm to about 1000 μm; about 500 μm to about 1000 μm; about 5 μm to about 25 μm; about 15 μm to about 40 μm; about 25 μm to about 50 μm; about 40 μm to about 75 μm; about 75 μm to about 100 μm; about 100 μm to about 250 μm; or about 250 μm to about 500 μm.

In other embodiments, the average pore size of the surface is in the range between about 1 nm to about 1000 nm. In some embodiments, the porous surface has an average pore size of between from about 1 nm to about 500 nm; about 1 nm to about 250 nm; about 1 nm to about 100 nm; about 1 nm to about 50 nm; about 1 nm to about 25 nm; about 1 nm to about 10 nm; about 1 nm to about 5 nm; about 10 nm to about 1000 nm; about 25 nm to about 1000 nm; about 50 nm to about 1000 nm; about 100 nm to about 1000 nm; about 250 nm to about 1000 nm; about 500 nm to about 1000 nm; about 5 nm to about 25 nm; about 15 nm to about 40 nm; about 25 nm to about 50 nm; about 40 nm to about 75 nm; about 75 nm to about 100 nm; about 100 nm to about 250 nm; or about 250 nm to about 500 nm. In some embodiments, the size range for the porous material or patterned material ranges from 0.1-0.8 μm.

In some embodiments, the interface surface comprises a grooved surface, for example, to direct cell growth (e.g., an aligned laminar surface).

In some embodiments, the interface surface can also comprise a cross-linking agent. In some embodiments, a cross-linking agent is selected from the group consisting of the salts of calcium, copper, aluminum, magnesium, strontium, barium, tin, zinc, chromium, organic cations, poly(amino acids), polycations, polyanions, poly(ethyleneimine), poly(vinylamine), poly(allylamine), and polysaccharides.

In some embodiments, the interface surface is coated with a positively charged molecule. Alternatively, a negatively charged molecule can be used to coat the interface surface. In some embodiments, the surface is coated by layer-by-layer assembly of alternating positive and negative charged species, as desired.

In some embodiments, polyethylene glycol (PEG) is used as the interface surface and can be optionally functionalized to introduce either a strong nucleophile, such as a thiol, or a conjugated structure, such as an acrylate or a vinylsulfone. In addition, PEG is useful in the formation of 3-dimensional interfaces or scaffolds, such as medical implants, as described in more detail below.

In some embodiments, the interface surface comprises a peptide.

Cells interact with their environment through protein-protein, protein-oligosaccharide and protein-polysaccharide interactions at the cell surface. Extracellular matrix proteins provide a host of bioactive signals to the cell. This dense network is required to support the cells, and many proteins in the matrix have been shown to control cell adhesion, spreading, migration and differentiation. Some of the specific proteins that have been shown to be particularly active include laminin, vitronectin, fibronectin, fibrin, fibrinogen, tenascin, and collagen. Thus, in some embodiments, the interface comprises an extracellular matrix protein or fragment thereof.

The extracellular matrix proteins can be incorporated into a matrix and include peptides that bind to adhesion-promoting receptors on the surfaces of cells. Such adhesion promoting peptides can be selected from the group as described above. In some embodiments, the peptides are the RGD sequence from fibronectin, or the YIGSR sequence from laminin.

### Cells

Essentially any cell can be observed and/or imaged using the imaging systems described herein including, but not limited to, human cells, non-human cells, mammalian cells, bacterial cells, yeast cells, fungal cells, algal cells and cell fragments. The term “non-human cells” as used herein includes all vertebrates, e.g., mammals, such as non-human primates, (particularly higher primates), sheep, dog, rodent (e.g., mouse or rat), guinea pig, goat, pig, cat, rabbits, cows, and non-mammals such as chickens, amphibians, reptiles etc. In one embodiment, the cells are obtained from (e.g., primary cells) or derived from (e.g., iPS cells, immortalized cells) from a human. In another embodiment, the cells are obtained from or derived from an experimental animal or animal substitute as a disease model.

Typically, the imaging systems are applied to observing, measuring and imaging living cells in order to analyze dynamic cell interactions and/or behavior. However, fixed cells can also be imaged using the imaging systems described herein. The imaging systems can be used to assess cellular dynamics of both primary cells and immortalized cell lines. In some embodiments, the cells are in suspension within the biological sample. In other embodiments, the cells are adherent cells e.g., that are grown in the sample container.

One of skill in the art can readily adapt many conventional cellular assays for use with the imaging systems comprising optics aligned with the sample plane. For completeness, some non-limiting examples of cells are briefly described herein.

Embryonic Stem Cells:

The term “embryonic stem cell” is used to refer to the pluripotent stem cells of the inner cell mass of the embryonic blastocyst. Such cells can similarly be obtained from the inner cell mass of blastocysts derived from somatic cell nuclear transfer.

Cells derived from embryonic sources can include embryonic stem cells or stem cell lines obtained from a stem cell bank or other recognized depository institution. Other means of producing stem cell lines include methods comprising the use of a blastomere cell from an early stage embryo prior to formation of the blastocyst (at around the 8-cell stage). Such techniques correspond to the pre-implantation genetic diagnosis technique routinely practiced in assisted reproduction clinics. The single blastomere cell is co-cultured with established ES-cell lines and then separated from them to form fully competent ES cell lines.

Embryonic stem cells are considered to be undifferentiated when they have not committed to a specific differentiation lineage. Such cells display morphological characteristics that distinguish them from differentiated cells of embryo or adult origin. Undifferentiated embryonic stem (ES) cells are easily recognized by those skilled in the art, and typically appear in the two dimensions of a traditional microscopic view in colonies of cells with high nuclear/cytoplasmic ratios and prominent nucleoli.

Adult Stem Cells:

Adult stem cells are stem cells derived from tissues of a post-natal or post-neonatal organism or from an adult organism. An adult stem cell is structurally distinct from an embryonic stem cell not only in markers it does or does not express relative to an embryonic stem cell, but also by the presence of epigenetic differences, e.g., differences in DNA methylation patterns.

Induced Pluripotent Stem Cells (iPSCs):

iPSCs are somatic cells that are induced to reprogram to a more pluripotent phenotype. That is, a somatic cell can be obtained from a subject, reprogrammed to an induced pluripotent stem cell, and then re-differentiated into a desired cell type. iPSCs resemble ES cells as they restore the pluripotency-associated transcriptional circuitry and much of the epigenetic landscape. In addition, iPSCs satisfy all the standard assays for pluripotency: specifically, in vitro differentiation into cell types of the three germ layers, teratoma formation, contribution to chimeras, germline transmission.

As used herein, the term “reprogramming” refers to a process that alters or reverses the differentiation state of a differentiated cell (e.g., a somatic cell). Stated another way, reprogramming refers to a process of driving the differentiation of a cell backwards to a more undifferentiated or more primitive type of cell. In some embodiments, reprogramming encompasses complete or partial reversion of the differentiation state of a differentiated cell (e.g., a somatic cell) to an undifferentiated cell (e.g., an embryonic-like cell). The resulting cells are referred to as “reprogrammed cells;” when the reprogrammed cells are pluripotent, they are referred to as “induced pluripotent stem cells (iPSCs or iPS cells).” Methods for reprogramming iPSCs are known to those of ordinary skill in the art and are therefore not described in detail herein.

Somatic Cells:

Somatic cells, as that term is used herein, refer to any cells forming the body of an organism, excluding germline cells. Every cell type in the mammalian body—apart from the sperm and ova, the cells from which they are made (gametocytes) and undifferentiated stem cells—is a differentiated somatic cell. For example, internal organs, skin, bones, blood, and connective tissue are all made up of differentiated somatic cells. Additional somatic cell types for use with the compositions and methods described herein include: a fibroblast (e.g., a primary fibroblast), a muscle cell (e.g., a myocyte), a cumulus cell, a neural cell, a mammary cell, a hepatocyte, a cardiomyocyte and a pancreatic islet cell.

In some embodiments, the somatic cell is a primary cell line or is the progeny of a primary or secondary cell line. In some embodiments, the somatic cell is obtained from a human sample, e.g., a hair follicle, a blood sample, a biopsy (e.g., a skin biopsy or an adipose biopsy), a swab sample (e.g., an oral swab sample), and is thus a human somatic cell.

Some non-limiting examples of differentiated somatic cells include, but are not limited to, epithelial, endothelial, neuronal, adipose, cardiac, skeletal muscle, immune cells, hepatic, splenic, lung, circulating blood cells, gastrointestinal, renal, bone marrow, and pancreatic cells. In some embodiments, a somatic cell can be a primary cell isolated from any somatic tissue including, but not limited to brain, liver, lung, gut, stomach, intestine, fat, muscle, uterus, skin, spleen, endocrine organ, bone, etc. Further, the somatic cell can be from any mammalian species, with non-limiting examples including a murine, bovine, simian, porcine, equine, ovine, or human cell. In some embodiments, the somatic cell is a human somatic cell.

The term “somatic cell” further encompasses a cancerous cell, for example, a pre-cancer cell, a tumor cell, a cancer cell, a malignant cancer cell, etc.

Immortalized Cell Lines:

Immortalized cell lines, such as cancer cell lines, can also be imaged using the systems described herein. Some non-limiting examples of immortalized cell lines include A549 cells, HeLa cells, MDA-MB-231 cells, MCF-7 cells, HEK 293 cells, Jurkat, 3T3 a mouse fibroblast cells, Vero monkey cells, F11 rat cells, and Chinese Hamster Ovary (CHO) cells.

Bacterial Cells:

The imaging system(s) described herein and methods of use thereof is contemplated for use with any species of bacteria. In some embodiments, the bacterial cells are gram-negative cells and in alternative embodiments, the bacterial cells are gram-positive cells.

“Gram-negative bacteria” include cocci, nonenteric rods, and enteric rods. The genera of Gram-negative bacteria include, for example, Neisseria, Spirillum, Pasteurella, Brucella, Yersinia, Francisella, Haemophilus, Bordetella, Escherichia, Salmonella, Shigella, Klebsiella, Proteus, Vibrio, Pseudomonas, Bacteroides, Acetobacter, Aerobacter, Agrobacterium, Azotobacter, Spirilla, Serratia, Vibrio, Rhizobium, Chlamydia, Rickettsia, Treponema, and Fusobacterium.

“Gram-positive bacteria” include cocci, nonsporulating rods, and sporulating rods. The genera of Gram-positive bacteria include, for example, Actinomyces, Bacillus, Clostridium, Corynebacterium, Erysipelothrix, Lactobacillus, Listeria, Mycobacterium, Myxococcus, Nocardia, Staphylococcus, Streptococcus, and Streptomyces.

Fungi:

The imaging system(s) described herein and methods of use thereof are contemplated for use with any species of fungus.

In one embodiment, the fungus is a pathogenic or disease-causing fungus including, but not limited to, Cryptococcus neoformans, Histoplasma capsulatum, Coccidioides immitis, Blastomyces dermatitidis, Chlamydia trachomatis, or Candida albicans.

Screening Assays for Identifying and/or Testing Efficacy of Bioactive Agents

In one embodiment, the imaging systems described herein can be used to screen candidate agents (e.g., small molecules, antibodies, inhibitory RNA etc.). Typically, a biological sample comprising a cell is contacted with a candidate agent and at least one output parameter is assessed using the imaging system(s) described herein. The measurement of the output parameter is compared to a reference, such as the measurement of the output parameter prior to treatment with the candidate agent. Alternatively, a sample comprising a particle can be contacted with candidate agent, particularly when the surface comprises a biological material such as a monolayer of cultured cells.

The term “candidate agent” is used herein to mean any agent that is being examined for a desired biological activity, for example, anti-cancer activity. A candidate agent can be any type of molecule, including, for example, a peptide, a peptidomimetic, a polynucleotide, or a small organic molecule, that one wishes to examine for the ability to modulate a desired activity, such as, for example, anti-cancer activity. An “agent” can be any chemical, entity or moiety, including without limitation synthetic and naturally-occurring proteinaceous and non-proteinaceous entities. In some embodiments, an agent is nucleic acid, nucleic acid analogues, proteins, antibodies, peptides, aptamers, oligomer of nucleic acids, amino acids, or carbohydrates including without limitation proteins, oligonucleotides, ribozymes, DNAzymes, glycoproteins, siRNAs, lipoproteins, aptamers, and modifications and combinations thereof etc.

In some embodiments, the nucleic acid is DNA or RNA, and nucleic acid analogues, for example can be PNA, pcPNA and LNA. A nucleic acid may be single or double stranded, and can be selected from a group comprising; nucleic acid encoding a protein of interest, oligonucleotides, PNA, etc. Such nucleic acid sequences include, for example, but not limited to, nucleic acid sequence encoding proteins that act as transcriptional repressors, antisense molecules, ribozymes, small inhibitory nucleic acid sequences, for example but not limited to RNAi, shRNAi, siRNA, micro RNAi (mRNAi), antisense oligonucleotides etc. A protein and/or peptide agent or fragment thereof can be, for example, but not limited to; mutated proteins; therapeutic proteins; truncated proteins, wherein the protein is normally absent or expressed at lower levels in the cell. Proteins of interest can be selected from a group comprising; mutated proteins, genetically engineered proteins, peptides, synthetic peptides, recombinant proteins, chimeric proteins, antibodies, humanized proteins, humanized antibodies, chimeric antibodies, modified proteins and fragments thereof.

In certain embodiments, the candidate agent is a small molecule having a chemical moiety. Such chemical moieties can include, for example, unsubstituted or substituted alkyl, aromatic, or heterocyclic moieties and typically include at least an amine, carbonyl, hydroxyl or carboxyl group, frequently at least two of the functional chemical groups, including macrolides, leptomycins and related natural products or analogues thereof. In some embodiments, the candidate agent is an agent known to disrupt the cytoskeleton and/or affect spreading/adhesion. Some non-limiting examples of such agents include alkyloids or mycotoxins.

Candidate agents can be known to have a desired activity and/or property, or can be selected from a library of diverse compounds. Also included as candidate agents are pharmacologically active drugs, genetically active molecules, etc. Such candidate agents of interest include, for example, chemotherapeutic agents, hormones or hormone antagonists, growth factors or recombinant growth factors and fragments and variants thereof.

Candidate agents, such as chemical compounds, can be obtained from a wide variety of sources including libraries of synthetic or natural compounds, such as small molecule compounds. For example, numerous means are available for random and directed synthesis of a wide variety of organic compounds, including biomolecules, including expression of randomized oligonucleotides and oligopeptides. Alternatively, libraries of natural compounds in the form of bacterial, fungal, plant and animal extracts are available or readily produced. Additionally, natural or synthetically produced libraries and compounds are readily modified through conventional chemical, physical and biochemical means, and may be used to produce combinatorial libraries. Known pharmacological agents may be subjected to directed or random chemical modifications, such as acylation, alkylation, esterification, amidification, etc. to produce structural analogs.

In one embodiment of the screening method, compound libraries can be screened. Commercially available combinatorial small molecule drug libraries can be screened for a desired effect on a cell(s) using the imaging systems and methods well known in the art and/or as described herein. Combinatorial libraries can be obtained from commercially available sources including e.g., from Vitas-M Lab and Biomol International, Inc. A comprehensive list of compound libraries can be found at Broad Institute at Harvard University. Other chemical compound libraries such as those from of 10,000 compounds and 86,000 compounds from NIH Roadmap, Molecular Libraries Screening Centers Network (MLSCN) can also be used to supply candidate agents for the methods described herein.

Small Molecule Interference with Actin and its Effect on Cell Morphology and Adhesion (a Drug Screen):

The effects of various small molecule drugs that interfere with actin polymerization are typically inferred from indirect cell morphology and adhesion assays. Using lateral microscopy (brightfield and fluorescence), the morphologies of cells treated with varying concentrations of these drugs can be observed directly to offer new information on cytoskeleton remodeling, and measurements of the contact angle can rapidly indicate the performance of the drug.

With regard to intervention, any treatments which comprise a desired biological activity, such as anti-cancer or chemotherapeutic activity, should be considered as candidates for human therapeutic intervention.

### Exemplary Cellular/Particle Dynamics Assays and Other Applications of the Imaging Systems

The imaging systems described herein can be applied for imaging of essentially any cell, cell fragment, or particle where it would be advantageous to view the cell or particle laterally (e.g., substantially parallel to the sample plane or interface surface), for example, when measuring the contact angle of a cell. The following examples of applications of the imaging systems described herein are not intended to be limiting.

In one embodiment, the imaging system(s) described herein can be used to study changes in cell morphology, such as, the cell morphology that occurs upon adhesion of a cell to a surface. The cell morphology can be monitored in response to a desired stimulus, such as the response of the cell to a bioactive agent or drug. Alternatively, the imaging system(s) described herein can be used to detect and or identify a cell having a particular morphology or phenotype for use in e.g., diagnosis of disease. The imaging systems can be used herein to characterize or categorize cells based on cellular characteristics including, but not limited to, contact angle, adhesion, tethering, rolling, invasiveness, migration, displacement, morphology, detachment, locomotion, protrusion, contraction, matrix remodeling, gradient sensing or contact inhibition. As but one example, the imaging systems described herein can be used to detect, monitor and/or measure leukocyte migration and/or extravasation. In addition, the imaging systems can be used to diagnose or determine a prognosis for a cancer by e.g., measuring the change in contact angle of a cell. The expression of cell surface markers can be correlated with a change in contact angle of a cell, for example, a cancer cell model to determine the mesenchymal-epithelial transition.

In another exemplary embodiment, the imaging system can be used to detect, measure and image/describe the adhesion of a cell(s) to a variety of materials. For example, this embodiment can be analogous to measurements of surface wettability (e.g., hydrophilicity or hydrophobicity) that are measured conventionally using contact angle measurements.

The imaging systems described herein have the advantage of being able to directly image cell to cell interactions, particularly interaction of cells with a monolayer of cultured cells that cannot be measured using conventional microscopy. For example, the imaging systems can be applied to study the formation of multilayer cell constructs.

In one embodiment, the imaging system can be used to detect a change in contact angle as a rapid diagnostic for invasion potential of cancer cells.

In another embodiment, the imaging system can be used to detect and/or measure a change in contact angle to characterize the response of cells in an in vitro culture to e.g., drug candidates.

In another embodiment, the imaging system can be used to detect and/or measure a change in contact angle for the quantitative characterization of biomaterials that promote or resist the adsorption of cells.

In another embodiment, the imaging system described herein can be used for monitoring stem cells and/or stem cell cultures for therapeutic applications.

### Diagnostic Assays: Using Rates of Change in Cell Morphology to Characterize Cell Motility and Invasion Potential

a. With the Modified Boyden Chamber:

The lateral microscope provides the field of view necessary to observe cell migration in the vertical direction, which is the basis of traditional transwell migration and invasion assays (i.e., the Boyden chamber). However, standard assays require large cell populations and sufficient time to establish the end results of experiments. A modified Boyden chamber was created that enables the real-time visualization of cell migration and invasion in the vertical direction. These tools provide an assay that addresses the limitations of the traditional technique: (i) cells will be observed in real-time during migration and invasion, permitting measurements of rates of change in cell morphology that can be used to describe the motility or invasiveness of cells, (ii) cells of interest can be monitored individually, and (iii) the amount of time required to complete the assay will be drastically shortened because the endpoint will be predetermined and cells do not need to be subjected to subsequent staining protocols before analysis.

b. With Hydrogels:

Highly invasive MDA-MB-231 cells have been shown to invade Matrigel, which is a hydrogel of reconstituted extracellular matrix derived from mouse sarcoma, in the vertical direction. Over the course of 90 minutes, cell penetration depths were visualized reaching ˜25 μm. When non-invasive MCF-7 cells were seeded onto Matrigel, minimal penetration was observed. As a result, invasion depths can inform the invasion potentials of tumorigenic cell lines.

c. With Coated Substrates:

Cell migration and adhesion processes are largely influenced by environmental factors that cells sense through surface proteins. Cells respond to these cues by altering the expression of specific surface markers that mediate cell function. E-cadherin has been classified as a key marker in the epithelial-mesenchymal transition (EMT) of cancer metastasis. To create a functional assay that describes the expression of E-cadherin among single cells in real-time, the lateral microscope was used to monitor changes to the morphologies of breast cancer cells on E-cadherin-coated glass substrates. The rates of change in contact angle of cells from three different breast adenocarcinoma cell lines: MDA-MB-231, MDA-MB-468, and MCF-7 were used. These cells served as a useful model for the metastatic cascade not only because of their differences in E-cadherin expression, but also because of their differences in invasion potential. The most rapid change in contact angle was observed with MCF-7 cells, followed by MDA-MB-468 cells, and lastly, MDA-MB-231 cells. As such, the rates of change in cell morphology can be related to invasion potential. With the use of different cell lines and surface coatings, the applications of this approach can be expanded to systems that represent the immune response and wound healing, as well as additional systems related to cancer metastasis.

In addition, the lateral microscope permitted the discovery of a unique morphology among invasive breast cancer cells during the initial adhesion period. This morphology is best described as the formation of a pedestal that connects the bulk of the cell to the material surface, resulting in a vertical elongation of the cell. With these cells, the change in cell height was measured as percentage of the diameter of the cell at t=0 min. Therefore, the rates of change in cell height can also be used to characterize invasion potential.

### References or Reference Samples for Cell/Particle Dynamics Assays

In some embodiments, the measured output parameter is compared to a reference. The terms “reference level,” “reference sample,” and “reference” are used interchangeably herein and refer to the measured output parameter in the test biological sample against which another sample is compared (i.e., obtained from an earlier time point, or obtained from an untreated sample). A standard is useful for detecting a change in a measurable output parameter or a relative increase/decrease in the output parameter in a biological sample. A standard serves as a reference level for comparison, such that samples can be normalized to an appropriate standard. An appropriate standard can be determined by one of skill in the art based on the output parameter to be measured and the application to which the imaging system is to be used. For example, when the imaging systems described herein are applied to the diagnosis of a cancer, the standard can be used in order to infer the presence, absence or extent of cancer cell invasiveness in a subject or in an organ by comparing the output parameter of a biological sample to a sample having known cancer invasiveness characteristics. Alternatively, when the imaging systems described herein are applied to test a candidate agent, the standard can be the biological sample prior to treatment with the candidate agent.

In one embodiment, a reference standard is obtained at an earlier time point (presumably prior to the onset of disease in a cellular diagnostic assay, or alternatively prior to treatment of a biological cell with a candidate agent) from the same individual or biological sample that is to be tested or treated as described herein. Alternatively, a standard can be from the same individual having been taken at a time after the onset or diagnosis of cancer or other disease affecting cell growth/adhesion parameters, or after a biological sample is treated with a candidate agent as described herein. In such instances, the standard can provide a measure of the efficacy of treatment.

In relation to a cellular diagnostic or prognostic assay for e.g., cancer, a standard level can be obtained, for example, from a known biological sample from a different individual (e.g., not the individual being tested) that is substantially free of e.g., cancer. In another embodiment, a standard level can be obtained from a known biological sample from the same individual outside of the tumor area. A known sample can also be obtained by pooling samples from a plurality of individuals to produce a standard over an averaged population, wherein a standard represents an average level of an output parameter among a population of individuals (e.g., a population of individuals having cancer). Thus, the level of the output parameter in a standard obtained in this manner is representative of an average level of this parameter in a general population of individuals having cancer. A biological sample is compared to this population standard by comparing the output parameter from a sample relative to the population standard. Generally, a measurement of an output parameter that falls within a range determined in a specific population (e.g., in a population of subjects having cancer of a certain degree of invasiveness) will indicate the presence of an invasive cancer and/or the degree of invasiveness of the cancer, while a measurement that falls outside of the range will indicate that the individual does not have an invasive cancer. The converse is contemplated in cases where a standard is obtained from a population of subjects lacking an invasive cancer. It should be noted that there is often variability among individuals in a population, such that some individuals will have higher measurements for a given output parameter, while other individuals have lower measurements for the same parameter. However, one skilled in the art can make logical inferences on an individual basis regarding the detection and treatment of e.g., invasive cancer as described herein.

### Example 1: Direct Imaging of Cell Dynamics

There is an obvious need for a tool that can enable the direct imaging of cell/material interfaces, a means for the quantitative measurement of interactions between cells and materials is absolutely required to advance our understanding of basic biological processes. In surface chemistry, interfacial interactions between liquid droplets and surfaces are studied using a type of low-powered microscopy (i.e., contact angle goniometry), and the complete thermodynamic characterization and interfacial free energies of a system can be determined by measuring the contact angle of the droplet on the surface in the sagittal (xz-) plane (also referred to as an axial plane). That is, merely shifting the field of view enables critical examinations of interfaces. The inventors have developed a novel imaging tool—a “lateral microscope” or “contact angle microscope”—that can, for the first time, enable the direct imaging of the interface between cells and materials.

Rather than fabricate an optical train in toto, which can be time-consuming to design, align, and maintain, the inventors have identified a simple macroscope (Leica Z6 APO) that functions as the foundation of the prototype imaging system of the contact angle microscope (FIG. 1A). The Z6 APO is equipped with a zoom lens (0.57-3.6×) that can alter the overall magnification of an image without the need to change objective lenses. Although the use of the zoom lens provides empty magnification (i.e., without an increase in resolution), this capability greatly aids in the identification of regions of interest on the surface of a sample. Most importantly, the inventors recognize that this particular application requires careful consideration of the choice of objective lenses to use in the optical train to provide the desired resolution and magnification.

The lateral microscopy system described herein uses a Leica objective lens that has a moderate magnification (40×), a long working distance (6.9 mm), and is corrected for imaging through glass windows (0-2 mm). The lateral microscope further comprises a motorized (X, Y, and Z) translation stage(s) to control the placement of the sample, an optical train, fiber optic illumination, and a high-speed CCD camera. The entire apparatus is mounted on a vibration isolated breadboard. The imaging capabilities of this lateral microscope are demonstrated herein using HeLa cervical cancer cells and H9 T lymphocytes. HeLa cells are adherent and therefore were removed from the culture flask by trypsin digestion to proteolytically degrade surface proteins and adhesion markers. This process effectively transforms adherent cells into “suspension” cells until the expression level of adherent markers increases. The inventors introduced trypsinized HeLa cells into a custom sample container as depicted in FIG. 9. In an image acquired with the lateral microscope (FIG. 1B), three cells were observed: one cell is in focus and newly come to rest on the glass surface (i), a similar cell is out of focus (ii), and a third cell is sedimenting by gravity into the field of view (iii). The contact angle of a cell was measured by magnifying a region of interest, identifying the surface boundary, and drawing a line tangent to the cell membrane from the point of intersection (FIG. 1C). The change in contact angle of HeLa cells and control H9 cells (grown in suspension) was assessed as a function of time (FIG. 1D). Cells with adherent and suspension properties can be characterized by their contact angles and changes to their contact angles: the contact angle of HeLa cells changed 51° during the course of the experiment (from 136° to 85°) while the contact angle of the H9 cells remained relatively unchanged (from 115° to 117°).

The inventors' approach differs from traditional contact angle measurements in one fundamental aspect: measurements of cells are not made exclusively with the system at equilibrium. Not only is cell adhesion a dynamic process, but biochemical pathways triggered by adhesion events result in the dramatic rearrangement of the cytoskeleton of the cell. That is, the simple rheological model of a cell breaks down. The imaging systems described herein permit one of skill in the art to determine when this transition occurs and appropriately modify the method of analysis. The methods and systems described herein permit the study of the dynamics of cell adhesion and permit those of skill in the art to address a number of outstanding questions regarding the response of cells to surfaces and predict biological outcomes of interactions between cells and surfaces in the presence or absence of a biological agent.

### Example 2: Comparison to Conventional Cell Adhesion Microscopy

Surface adhesion proteins play a decisive role in the ability of a cell to recognize and interact with its environment effectively. Changes to the adhesive properties of a cell often are concomitant with a change in phenotype. Prominent examples include the invasion-metastasis cascade of metastatic tumors, extravasation of leukocytes during an immune response and a number of processes during embryogenesis. It follows that the ultimate fate and function of a cell can be correlated to the expression level of specific surface markers. Extensive changes to the morphology of a cell occur as a result of adhesion (e.g., spreading). These aspects of cell adhesion are studied predominantly by optical microscopy, which only acquires images of cells in the transverse (xy-) plane. Any special information regarding the thickness of a sample or the depth at which sub-cellular structures exist (i.e., in the z-direction) must be inferred from a series of still images; that is, the desired imaging plane is reconstructed computationally rather than observed directly. Furthermore, all dynamic information regarding interactions at the interface between a cell and material is lost. This limitation has a profound impact on how we interpret the behavior of cells and influences experimental practices that range from the management of routine cell cultures to the development of biomaterials.

In another embodiment, the imaging system(s) described herein can be used to detect and/or measure characteristics associated with cell adhesion. There are a number of existing conventional microscopy techniques that provide insight into the study of cell adhesion. A general approach is combine confocal microscopy with deconvolution software to determine critical spatial relationships through computational reconstruction of a series of still images. Two approaches study only interactions that occur at the cell-material interface: Total Internal Reflectance Fluorescence (TIRF) Microscopy and reflection interference contrast microscopy (RICM). Other methods, including photoactivated localization microscopy (PALM) and stochastic optical reconstruction microscopy (STORM), aim to resolve single molecules at focal adhesions, but they do not explicitly examine the geometry or rheological properties of the adhesion site and the mechanics revealed by these measurements are speculative without those studied by contour analysis. Each one of these approaches requires expensive, specialized instrumentation (>>$100k) and specialized software. As a result, access to these tools is largely limited to centralized facilities or exceptional research groups. Unlike the microscopy approaches described above, the imaging systems described herein are the first to image a cell in the desired (sagittal) plane and thus the first to directly measure contact angle, which is the determining factor in characterizing the cell-surface interaction. The imaging systems described herein are easier to build (only five components), less expensive to implement (costs <$10k), and have a smaller footprint than other microscopes (only 1 sq. ft.), thereby making it broadly accessible to other researchers and doctors.

To compare the imaging systems described herein with conventional microscopes, MDA-MB-231 cells were introduced to a glass slide and allowed to adhere for 30 minutes. The cells were then incubated with DiI (a general membrane stain) at room temperature, washed twice with buffer, then imaged by confocal microscopy. In total, 211 0.2 μm slices were needed to generate the full three-dimensional representation of the cell and resulting projection of the interface between the cell and the glass slide. These images took approximately 3 minutes to acquire, which preclude the study of real-time adhesion interactions. In addition, the inventors found that conventional microscopy systems require ˜15 min to set up the experiment before image acquisition could be initiated, which means that the early data from t=0-15 min were not observed at all.

In these experiments, it was important to show that cell spreading is an isotropic process and uniform in all directions. One early criticism of the inventors' preliminary data was that the single field of view of a cell may be biased and not represent the cell or cell adhesion generally. The images obtained include data from a single confocal microscopy experiment and are the result of 211 individual images (data not shown). Here, the inventors show that the cell is indeed rounded and that four unique projections (0°, 90°, 180°, and 270°) are nearly identical. As a result, the single field of view imaged by the lateral microscope can be considered representative of the behavior of the cell.

After 30 minutes of adhesion, the contact angle measured by confocal microscopy is ˜156°, while the measurement made by lateral microscopy of cells from the same culture is ˜145°. This difference is small and is representative of assumed differences that are inherent within a population of cells. Without wishing to be bound by theory, this difference likely represents the changes to the cell morphology that could have occurred as a function of the staining and washing protocols required for confocal microscopy.

Overall, the inventors found it to be very challenging to develop a staining and washing protocol that would provide fluorescence intensities that were sensitive and specific using conventional confocal microscopy. This would have to be optimized for every cell, every dye, and every material. In addition, there was a significant time lag when acquiring the images need for reconstruction. The inventors postulate that the images likely lost fine movements and could not acquire the same “real-time” data that is routine using the imaging systems and techniques described herein. Another drawback for conventional confocal microscopy is that inverted confocal microscopy requires a transparent substrate (i.e., glass) and upright confocal microscopy cannot produce a brightfield image—only fluorescence—which makes it challenging to locate the cells. The imaging systems and methods for using them overcome all of these problems associated with conventional confocal microscopy with regard to measuring cell adhesion characteristics.

### Example 3: A Lateral Microscope Enables the Direct Observation of Cellular Interfaces and the Quantification of Changes to Cell Morphology During Adhesion

The ability to observe cell adhesion processes in real-time remains a grand challenge in basic biology and medicine. Toward this goal, an optical, lateral microscope was developed that allows for the direct observation of cell-substrate interactions in real-time on any substrate—transparent, opaque, or coated—without requiring provisions for labeling or specialized optical components. The use of the lateral microscope is demonstrated by quantifying the dynamic changes in cell morphology that occur during adhesion to various materials. Specifically, the rates of change in contact angle of HeLa, 3T3, HEK293, and MDA-MB-231 cells were determined on five different substrates: glass, collagen-coated glass, Nylon, PTFE, and collagen-alginate hydrogels. The rates of change in contact angle were used to compare the morphology changes of each cell line on a particular surface, as well as rank the adhesion-promoting capacities of each surface for a particular cell line. Maximal rates of change in contact angle (0.050 deg/min) were observed on collagen-coated class substrates with HeLa, 3T3, and HEK293 cell lines, and minimal rates of change (0.003 deg/min) on PTFE with all five cell lines. Additionally, a unique morphology was discovered among MDA-MB-231 breast cancer cells during the initial adhesion period that was quantified using measurements of changes in cell height. The development of the lateral microscope not only enables more comprehensive, quantitative studies of cell adhesion to inform the development of biomaterials, but it can ultimately assist in advancing our understanding of many important biological processes and discovering new behaviors related to cell adhesion.

Background:

Cell adhesion is a highly dynamic process driven by the interplay of molecular recognition and biomechanical contributions from cells and their surrounding matrix.¹⁻⁴ Adhesion and programmed changes in adhesion play critical roles in development (e.g., embryogenesis),⁵ health (e.g., leukocyte extravasation during an immune response),⁶ and the pathogenesis of disease (e.g., invasion-metastasis cascade of tumors).⁷ In addition to its importance in basic biological processes, the control of cell adhesion is an essential component for the function of implanted biomedical devices. Rejections of a biomedical device by contamination from microorganisms or improper integration into the host are significant concerns.^{8,9} The surface of a cell and the surface of a material with which the cell interacts both play decisive roles in determining the extent of adhesion and the ultimate fate of the cell.¹⁰ For these reasons, cell adhesion is an actively studied process in both basic and translational sciences.

In the absence of external mechanical contacts (e.g., in suspension), cells maintain a spherical shape due to their cortical tension.^{11,12} During adhesion, cells undergo significant changes in morphology as they spread, which increases their contact area with a surface. A number of models have been developed to describe the biophysics and biomechanics underlying cell adhesion, which have since been applied to systems that range in complexity from single cells to tissues.¹³⁻¹⁶ Common to all of these approaches is the importance of an accurate description of cell morphology and the significance of the contact angle between cellular interfaces as an emergent geometric parameter resulting from adhesion processes.¹⁷⁻¹⁹ Additionally, the use of the contact angle has been proposed as a means to translate theories related to surface wetting phenomena into quantitative descriptions of cell adhesion.^{20, 21} Recently, Cerchiara et al. became the first to use contact angle measurements at both cell-cell and cell-substrate interfaces to develop a mathematical model for predicting tissue formation. Their approach exemplifies the need for accurate and accessible contact angle information to understand the changes in surface energy that occur upon cellular contacts.²²

Cell adhesion is predominantly analyzed with the use of optical microscopes.²³ This standard imaging method is available in two configurations, upright and inverted, both of which limit observation to the transverse (xy-) plane. The plane of interest for observing interfacial interactions between cells and materials, however, lies orthogonally to those transverse optical sections in either the sagittal (xz-) or coronal (yz-) planes. Critical spatial relationships between sub-cellular components must be inferred from indirect approaches, particularly reflectance interference contrast microscopy (RICM) and confocal microscopy. The interference fringes resulting from RICM images can be translated into distance information, while the ability of confocal microscopy to generate three-dimensional reconstructions inherently provides interfacial fields of view.

These techniques, however, are not without their drawbacks: (i) RICM is restricted to imaging cells adhered to transparent glass substrates and requires mathematical models to extrapolate contact angles and cell morphologies.^{25,26} (ii) Confocal microscopy requires cells to be labeled with a fluorophore by addition of an exogenous dye or expression of an endogenous fluorescent protein.²⁷ Due to the specificity of fluorescent tags, multiple staining procedures are necessary to map the entirety of the cell, and the cell must then be sequentially imaged at different wavelengths to observe each tagged component. Any dynamic changes in cellular components that are not labeled go unnoticed. Moreover, with confocal microscopy, significant lags in time are needed to establish the desired focal plane and acquire each series of image slices, which must later be reconstructed computationally into a three-dimensional image.²⁸ One of the latest advancements in optical microscopy, lattice light sheet microscopy, is capable of producing high-resolution images faster than confocal microscopy with reduced phototoxicity to cells,²⁹ but this technology still necessitates sample labeling with fluorophores. Further, with many microscopy techniques, cells are typically fixed with paraformaldehyde in order to overcome the challenges of imaging cells on opaque substrates (i.e., without a brightfield image to guide the experiment). This procedure provides important experimental flexibility, but precludes any time-resolved, live-cell investigations.³⁰

An ideal instrument to study cell adhesion at material interfaces enables rapid, quantitative measurements, is non-destructive to the cell under study, and requires no labels. Bell and Jeon acknowledged the need for such a tool in 1963 by developing a side-view imaging system to produce brightfield images of the xz- or yz-planes of a sample.³¹ In order to achieve this field of view, their system incorporated 45° prisms to redirect light nearly parallel across a sample and into an objective lens. As with most optical microscopy techniques, the side-view imaging system is limited by the necessity of transparent substrates and sample chambers, both of which enable the transmission of light. However, the indirect imaging pathway in side-view systems increases the probability of its obstruction during sample manipulation and ultimately results in poor image quality. Since its origination, the side-view imaging system has been predominantly used as a companion to instruments that quantify cellular forces and membrane rigidity.³²⁻³⁵ While these instruments, including atomic force microscopy (AFM), are capable of characterizing cell adhesion quantitatively, they are slow, low-throughput, and often destructive to the cell being analyzed. Further, when side-view imaging is paired with AFM, two imaging pathways must be maintained: (i) the side-view imaging pathway to enable interfacial fields of view and (ii) the traditional xy-plane imaging pathway to enable cell selection and cantilever alignment for AFM measurements. Again, this experimental setup is limited to optically transparent surfaces and requires careful sample manipulation in order to locate, image, and probe one cell using two different objective lenses.

On its own, the side-view imaging system has yet to offer more than qualitative data on the deformations cells experience when subjected to perturbations. With access to this field of view, approaches that infer the contact angle between a cell and surface are no longer required in order to describe cell morphology during adhesion. Instead, measurements can be made directly from a brightfield image. To recognize the full potential of side-view imaging, an optimized side-view microscope—the lateral microscope—was designed such that the optical train and light pathway are oriented substantially parallel to a surface of interest, eliminating the need for prisms or secondary imaging pathways that guide the detection of cell-substrate interfaces (FIG. 1A). Using the lateral microscope, cells may be observed directly on any material regardless of its composition, opacity, or topography. Images can be acquired without the need for exogenous labels, time-consuming experimental protocols, or computational methods that are required for confocal or other microscopy approaches. Further, lateral microscopy facilitates the quantitative study of single cells, while still permitting the characterization of populations of cells. The ability to observe cell adhesion to any material is particularly important for medical device fabrication. These devices, which must interact with cells to integrate in the body, are commonly constructed out of opaque materials, such as metals, ceramics, and plastics.³⁶ Thus, the direct observation of cell adhesion to these materials would guide the synthesis of new surface coatings to facilitate the development of medical devices. To exhibit this significant benefit of the lateral microscope, cells were imaged on two different opaque materials—PTFE (Teflon) and Nylon—and compared the adhesion profiles of cells on these surfaces to those exhibited on glass, collagen-coated glass, and collagen-alginate hydrogels. Additionally, because the lateral microscope produces real-time, brightfield images of the interface between cells and materials, previously unknown phenomena related to cell morphology were observed among MDA-MB-231 cells during the early events of adhesion characterized by the vertical elongation of cells.

The morphology of four adherent mammalian cell lines, HeLa, 3T3, HEK293, and MDA-MB-231, was analyzed on the five surfaces listed above. These cell lines vary in origin and cell type, which make them useful candidates to study and compare with the lateral microscope. HeLa is an epithelial cervical cancer line, HEK293 is an epithelial human embryonic kidney line, MDA-MB-231 is a mesenchymal-like epithelial breast cancer line, and 3T3 is a mouse embryonic fibroblast line. As a control cell line, H9 T lymphocytes were selected because they grow in suspension and are not expected to adhere to the surfaces selected. According to the studies described herein, the lateral microscope has far-reaching applications for the quantitative study of cell adhesion and grants us the ability to discover novel cell morphologies related to basic biological processes that often go unrecognized with the use of conventional microscopes.

### EXPERIMENTAL SECTION

Instrumentation:

The lateral microscope was fabricated from commercial components made specifically for high-quality microscopy applications using a Leica Z6 APO macroscope as the foundation of the imaging system. The Z6 APO macroscope also contains a zoom lens that can reduce or increase magnification from 0.57-3.6× without changing the objective lens. A 40× objective lens (WD=0-2 mm, NA=0.55) was used to observe cell adhesion. The lateral microscope is equipped with a cold LED light source (Thorlabs™) and Köhler™ condensing optics (Leica™). Three linear translation stages (Thorlabs™) control the position of the sample. To observe cells adhering to surfaces, custom-built, reusable sample containers (FIGS. 9B, 9C) were used to hold a material of interest and a small volume of cell culture medium (ca. 5-mL). These containers were fabricated out of a polyethylene U-channel (McMaster-Carr) cut into 0.5 inch pieces to serve as the framework of each sample container. A double-sided adhesive (FLEXcon™) was used to adhere a glass coverslip (No. 1.5, VWR™) to each of the long sides of the sample container to create the remaining two walls for light to pass through to the objective lens of the lateral microscope. The outer edges of the coverslips in contact with the U-channel were coated in a silicone sealant (Dow Corning™ 732 Multipurpose Sealant) to prevent leaking upon the addition of sample. A channel was milled into the bottom of each U-channel piece in order to align the sample container perpendicular to the objective lens on the sample stage of the lateral microscope. Additionally, an atmosphere- and temperature-controlled enclosure was built around the microscope to enable live-cell imaging.

Cell Culture:

HeLa (ATCC CCL-2), MDA-MB-231 (ATCC HTB-26), and 3T3 (ATCC CRL-1658) cells were cultured in Petri dishes until 70% confluency using Dulbecco's Modified Eagle medium (ATCC™) supplemented with 10% fetal bovine serum (EMD Millipore™) and 1% penicillin-streptomycin (Life Technologies™). Before imaging experiments, cells were washed once with a solution of 0.46 mM EDTA (Sigma-Aldrich™) in 1×PBS (Fisher Scientific™) and then incubated with the same solution for approximately 30 minutes, which allowed cells to non-enzymatically dissociate from the Petri dish. Cells were pelleted and resuspended in Leibovitz's L-15 medium (ATCC™) supplemented with 10% FBS, which is formulated to help maintain physiological pH in carbon dioxide-free live-cell enclosures. Flow cytometry was performed after treating cells with propidium iodide to confirm cell viability (>95%) was maintained for minimally 90 minutes following this switch in medium. A sample container was prepared to contain a sterilized surface immersed in complete L-15 medium, which was then positioned in the live cell enclosure of the lateral microscope to equilibrate to 37° C. Cells were pipetted into the sample container to perform lateral microscopy imaging experiments. The pH of the medium was measured before cell introduction and at the end of each experiment to assure that a physiological range was sustained for the duration of the 90-minute period of observation.

Surface Preparation:

Strips of Nylon (McMaster-Carr™), sheets of PTFE (ePlastics™), and glass coverslips (No. 1.5, VWR™) were cut into 0.25 inch pieces using a deluxe diamond scribing pen (Ted Pella™, Inc.). Each surface piece was sterilized with 70% ethanol and dried with nitrogen gas to remove any surface contaminants. To create collagen-coated glass coverslips, glass pieces were incubated with 100 μL of Coating Matrix Kit Protein containing human recombinant type 1 collagen (Life Technologies™) for 30 minutes and stored at 4° C. until ready for use, at which point any remaining liquid was aspirated off the surface. Collagen-alginate hydrogels were fabricated by soaking a 0.25 inch piece of filter paper in 1 M calcium chloride and drying in a 60° C. oven. Once dry, the paper was immersed in 100 μL of 1% (w/v) sodium alginate (Sigma Aldrich™) in 1×PBS supplemented with 2.0% (v/v) Coating Matrix Kit Protein containing human recombinant type 1 collagen, which initiated immediate gelling. The paper served only as a scaffold for the hydrogel, providing a flat interface for cell adhesion studies and increasing the density of the hydrogel such that it remained immersed in cell culture medium. For imaging experiments, a surface was placed in a sterilized sample container and rinsed twice with cell culture medium before seeding cells into the container.

Image Analysis:

The Contact Angle plug-in for ImageJ was used to measure contact angles and effective contact angles between cells and surfaces (data not shown).³⁷ ImageJ was also used to measure the diameter of MDA-MB-231 cells and their vertical elongation during pedestal formation.

Statistical Analysis:

Prism 6 was used to fit the rates of change in contact angle to a single exponential decay using non-linear regression. For cell and substrate combinations that resulted in minimal changes in contact angle during 90 minutes (e.g., PTFE with all cell lines), the rates were determined using linear regression. Outliers were calculated using Dixon's Q Test at 95% confidence using each cell's rate of change in contact angle so that the overall adhesive behavior of a single cell could be evaluated with respect to the average rate of change of the population. The 95% confidence band represented by the gray shading on each plot was calculated using all contact angle data points at each time point (excluding outliers) to assist in predicting the changes in contact angle a cell should undergo as a function of time.

Confocal Microscopy:

HeLa, 3T3, and MDA-MB-231 cells were incubated at room temperature with DiIC₁₈(3) general membrane stain (Biotium™) and washed twice with media to remove excess reagent. Cells were then introduced to glass and collagen-coated glass slides and allowed to adhere for 15-90 minutes at 37° C. and 5% CO₂ and imaged with a confocal microscope (Andor™ DSD2) mounted to an inverted microscope (Leica™ DMi8). A full three-dimensional representation of each cell and the resulting projection of the interface between the cell and the surface were generated from a reconstruction of 0.2 μm slices using Imaris™ software. Because of the time necessary to capture these images, t=0 min time points could not be imaged due to cellular movement before adhesion. The 3D image of the elongated MDA-MB-231 cell on collagen-coated glass was acquired using a Leica TCS SL confocal microscope with a 63× water immersion objective to achieve higher resolution.

### Results

Using our lateral microscope, the adhesion of single cells on glass, collagen-coated glass, Nylon, PTFE, and collagen-alginate hydrogels was monitored over a 90-minute time period, beginning at the time each cell first contacted a surface. An image of each cell was acquired every 15 minutes. The inventors observed the majority of cells spreading when interacting with surfaces that promote adhesion, as well as cells retaining a spherical shape on surfaces that resist adhesion. These results bear similarities to those of surface wettability experiments with which contact angle measurements inform the hydrophobicity of a surface: water droplets spread and form small contact angles (θ_{c}<90°) on hydrophilic surfaces but are spherical and form large contact angles (θ_{c}>90°) on hydrophobic surfaces (FIG. 1E). As such, the contact angles formed between cells and surfaces were measured to quantitatively describe cell morphology and adhesion at material interfaces. Unlike water droplets, however, the morphologies of cells are highly variable with respect to time. Therefore, the average changes and rates of change in contact angle of each cell population were determined and these values were used to describe and compare (i) the adhesion-promoting abilities of materials and (ii) the dynamic changes in cell morphology that occur during adhesion. Some cells were observed forming a “fried egg” morphology upon spreading, which results from lamellipodia extension beyond the bulk cell body.³⁸⁻³⁹ To describe the shapes of these cells, effective contact angle (θ_{c,eff}) measurements were used, which are obtained by excluding the lamellipodia and only considering the geometry of the bulk of the cell.⁴⁰ While θₑ and θ_{c,eff} suggest different adhesion behaviors, it is useful to consider these parameters as part of a single, continuous process for monitoring and quantifying cell adhesion.

HeLa Cells:

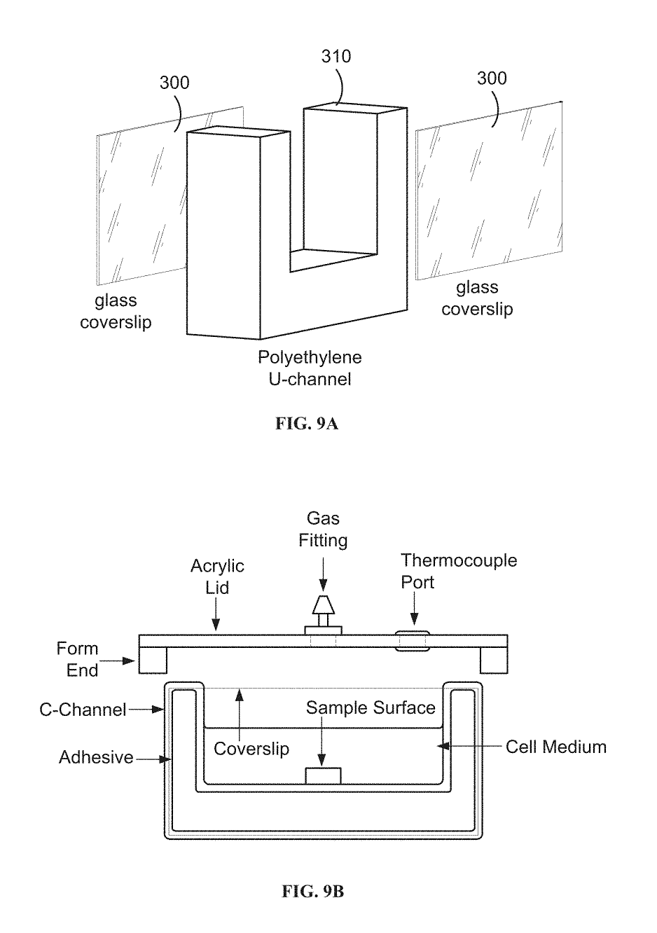

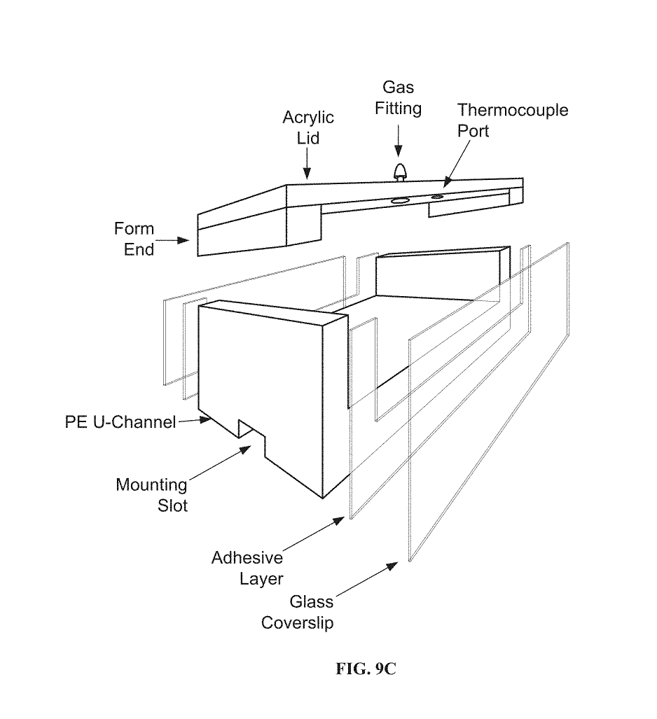

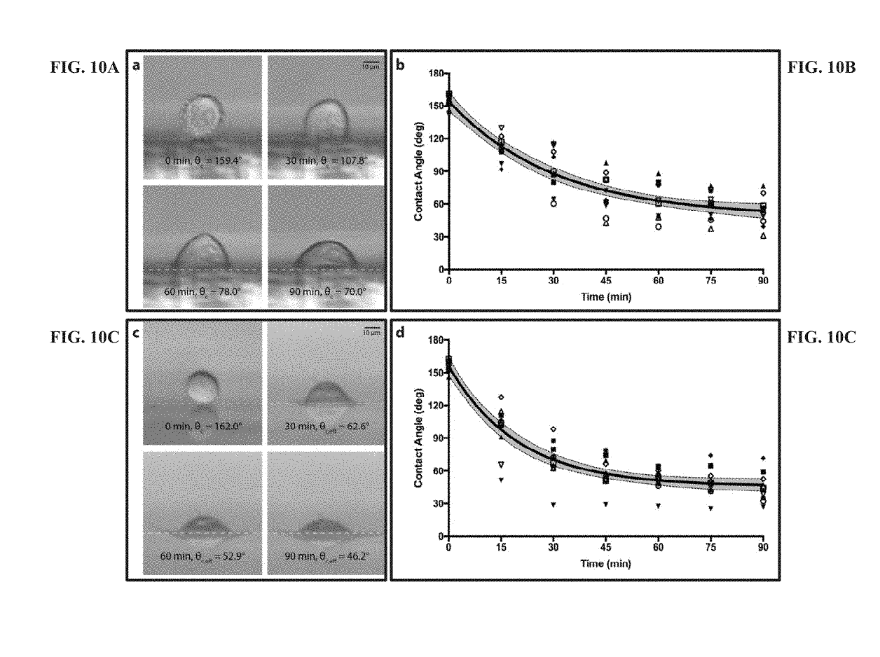

According to contact angle measurements obtained from images of single HeLa cells on glass surfaces, the population (N=10 cells) underwent an average change in contact angle of 101.4° over the 90-minute period of observation. The rate of change in the contact angle of each cell was determined by plotting contact angle as a function of time, which resulted in an average rate of change of 0.033 deg/min amongst the population (FIGS. 10A-10B; Table 1). On collagen-coated glass surfaces, an average change in contact angle of 111.5° and an average rate of change in contact angle of 0.050 deg/min (FIGS. 10C, 10D; Table 1) was observed. This rate, which is 1.5 times more rapid than the average rate of change HeLa cells experienced on uncoated glass surfaces, indicates significant and rapid changes in cell morphology that are indicative of spreading during adhesion. Notably, the most rapid change in contact angle among the majority of HeLa cells on collagen occurred during the first 30 minutes of experiments, whereas contact angle measurements decreased more slowly from 30-90 minutes (FIG. 10D). Prolonged monitoring of HeLa cells on collagen would assist in determining when maximum cell spreading and a minimum contact angle are achieved. On collagen-alginate hydrogels, an average change in contact angle of 74.0° and a rate of 0.026 deg/min were measured (FIGS. 12A-12B; Table 1). Differences in adhesion rates on collagen-coated glass and collagen-alginate hydrogels may reflect differences in the mechanical properties of each substrate or a non-uniform distribution of collagen in the hydrogel due to the viscosity of the alginate during mixing.

TABLE 1
Comparing the average change in contact angle and
the average rate of change in contact angle among
HeLa cells on glass, collagen, Nylon, PTFE, and collagen-
alginate hydrogel surfaces (N = 10 cells/surface).
Results exclude outlier cells.

| | Δθ_{c} | | |
|---|---|---|---|
| | (deg) | k (deg/min) | ratio |
| Glass | 101.4 | 0.033 | 1.0 |
| Collagen | 111.5 | 0.050 | 1.5 |
| Nylon | 105.3 | 0.019 | 0.6 |
| PTFE | 0.8 | 0.006 | 0.2 |
| Hydrogel | 74.0 | 0.026 | 0.8 |

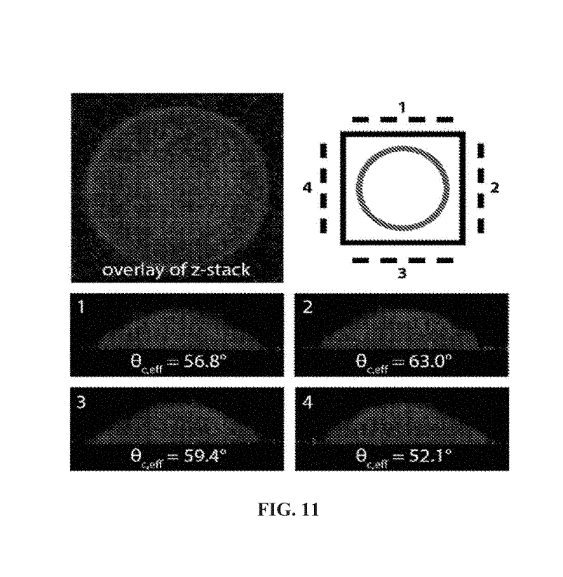

On PTFE, HeLa cells underwent an average rate of change in contact angle of 0.003 deg/min, which is 10 times slower than the rate achieved on glass (FIGS. 13C, 13D; Table 1). Moreover, HeLa cells experienced an average change in contact angle of 0.8° on this surface, which corresponds to minimal cell spreading during adhesion and the conservation of spherical cell morphologies. Notably, however, PTFE did not resist adhesion for all HeLa cells. Some outlier cells (Dixon's Q Test, 95% confidence) experienced a significant change in contact angle compared to the majority population (FIG. 13D). On Nylon, the average change in contact angle was comparable to those on glass and collagen-coated glass surfaces, but this change was achieved at a slower rate of 0.019 deg/min (FIGS. 13A, 13B). On both Nylon and PTFE, rolling was more likely to be observed rather than a non-motile phenotype (data not shown).

According to the average rates of change in contact angle, the performance of the materials used at promoting the adhesion of HeLa cells rank as follows: 1. Collagen-coated glass, 2. Uncoated glass, 3. Collagen-alginate hydrogels, 4. Nylon, and 5. PTFE (Table 1). Rapid adhesion to collagen was expected, as collagen is an extracellular matrix protein that has been determined to promote HeLa cell adhesion. Furthermore, minimal adhesion to PTFE aligns with existing evidence that indicates HeLa cells do not adhere strongly to this hydrophobic material within 90 minutes.

Comparison to Confocal Microscopy:

The lateral microscope provides a single field of view of cells on a surface. One important consideration when developing this approach was to demonstrate that measurements of cell morphology were not biased by the orientation of the imaging system. To address this concern, control confocal microscopy experiments were performed with HeLa cells on glass and collagen-coated glass substrates.

Cells were labeled with DiIC₁₈(3), a fluorescent general membrane stain, and confocal microscopy was used to monitor changes in cell morphology during adhesion in 15-minute intervals for 90 minutes. Cells spreading isotropically were observed during this time, which resulted in uniform cell morphologies around their contact area with the surface. These results were demonstrated by measuring the contact angles of a HeLa cell on glass at four unique imaging planes (data not shown). These data (requiring reconstruction of a z-stack containing over 200 slices) are in agreement with observations made directly by lateral microscopy in a single image and without the need for fluorescent labeling: after 90 minutes of adhesion, the average contact angle of HeLa cells on glass was 52.9°±13.6° as measured by lateral microscopy (10 cells) and 52.9°±10.3° as measured by confocal microscopy (8 cells, 4 projections each). However, with confocal microscopy, approximately 1-2 minutes were needed to acquire each series of images, which precluded the study of real-time adhesion interactions. As such, lateral microscopy provides an imaging plane that is representative of the cell for the periods of time of interest to this work and enables the observation of cell adhesion processes in real time.

3T3 Mouse Embryonic Fibroblasts:

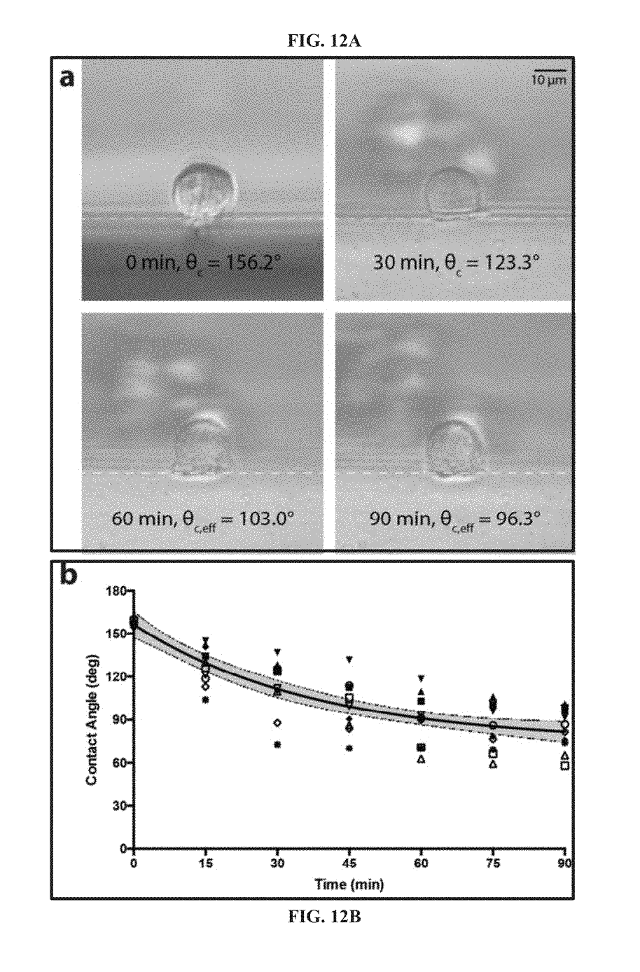

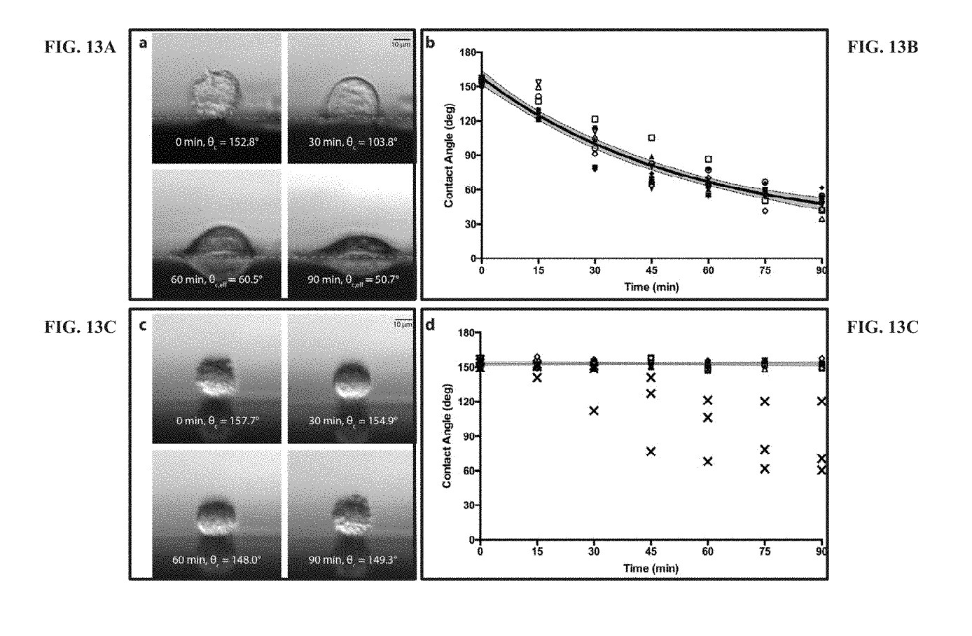

On all five substrates, large variability in the adhesion of single 3T3 fibroblasts was observed (FIGS. 14A-14F, 15A-15D). Oftentimes, contact angle measurements of fibroblasts decreased rapidly within the first 30 minutes of experiments but immediately increased from 30 to 90 minutes. This behavior, which appears to indicate the reversal of adhesion, may be related to contact inhibition of locomotion. It has been well established that 3T3 mouse embryonic fibroblasts experience this phenomenon, which is characterized by a decrease in cellular motility with increasing cell density.^{43,44} Thus, it is possible that because cells were introduced to substrates at low densities to avoid cell-cell contacts, 3T3 fibroblasts maintained high motility to cause the fluctuations observed in contact angle measurements. According to the average rates of change in contact angles, however, 3T3 fibroblasts adhered most rapidly to Nylon with a rate of 0.037 deg/min and most slowly to PTFE with a rate of 0.006 deg/min (FIGS. 15A-15D; Table 2). Interestingly, 3T3 cells established better adhesion to hydrophobic PTFE surfaces than HeLa cells on the same material. Similar rates of adhesion were measured on glass and collagen-alginate hydrogels (FIGS. 14A-14B, 14E-14F, Table 2). As anticipated, the steadiest decrease in the average contact angle of 3T3 fibroblasts was observed on collagen-coated glass surfaces⁴⁵ (FIGS. 14C, 14D, Table 2).

TABLE 2
Comparing the average change in contact angle
of 3T3 fibroblasts on glass, collagen, Nylon, PTFE,
and collagen-alginate hydrogel surfaces.

| | Δθ_{c} | | |
|---|---|---|---|
| | (deg) | k (deg/min) | ratio |
| Glass | 66.8 | 0.028 | 1.0 |
| Collagen | 97.1 | 0.037 | 1.3 |
| Nylon | 81.2 | 0.045 | 1.6 |
| PTFE | 68.5 | 0.007 | 0.3 |
| Hydrogel | 26.9 | 0.030 | 1.1 |

HEK293 Human Embryonic Kidney Cells:

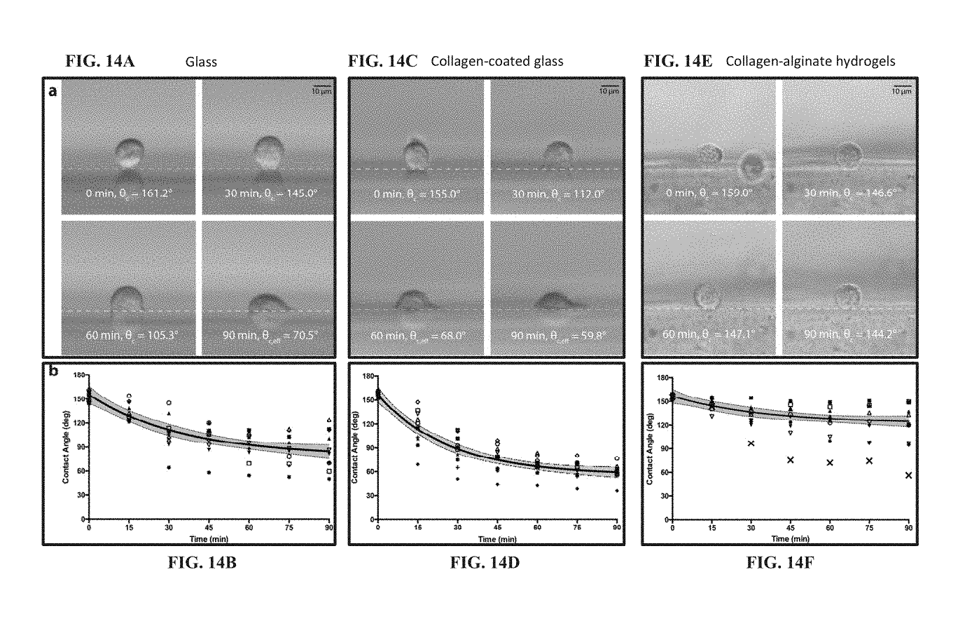

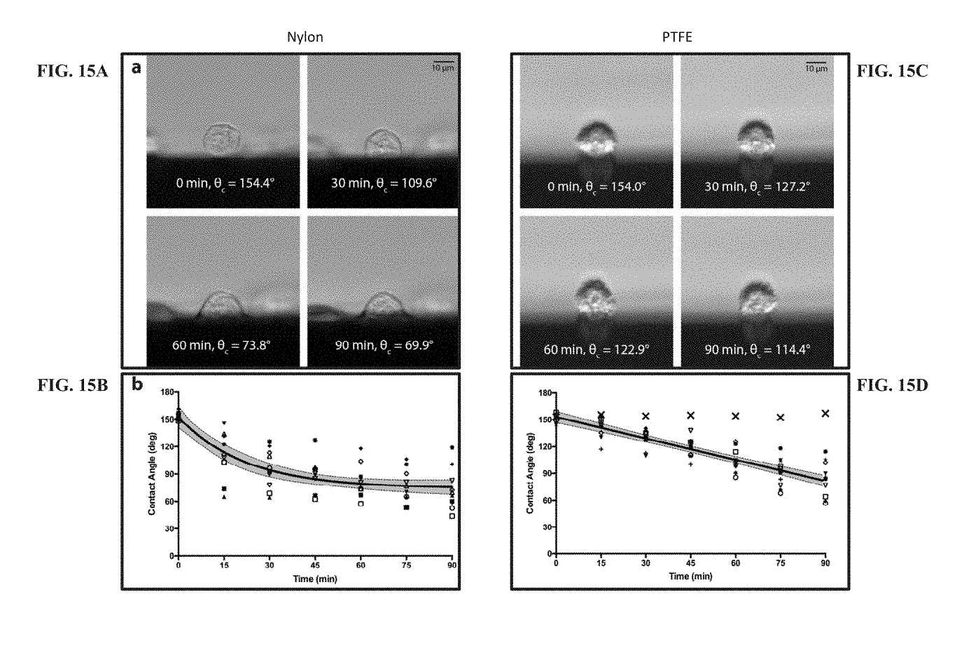

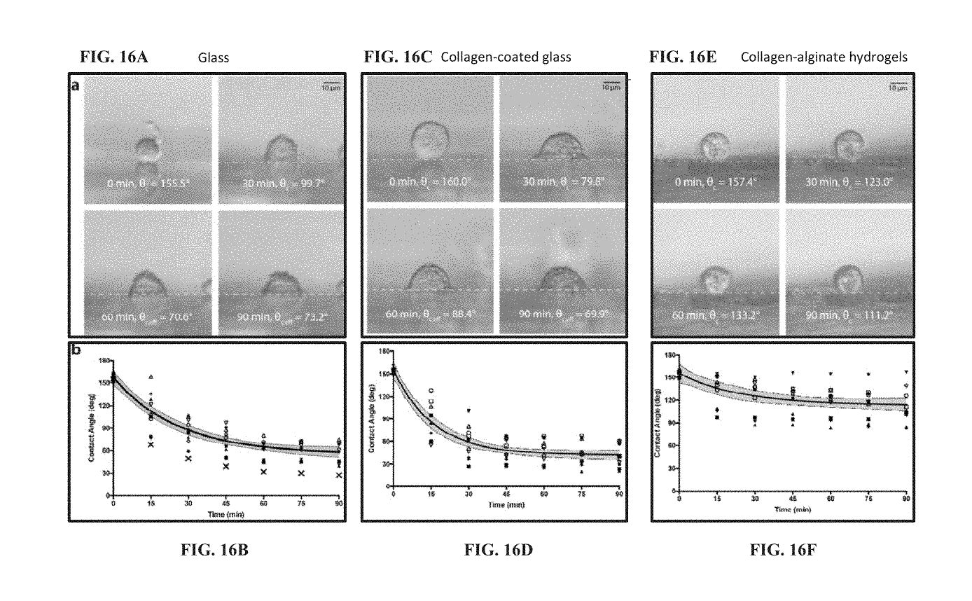

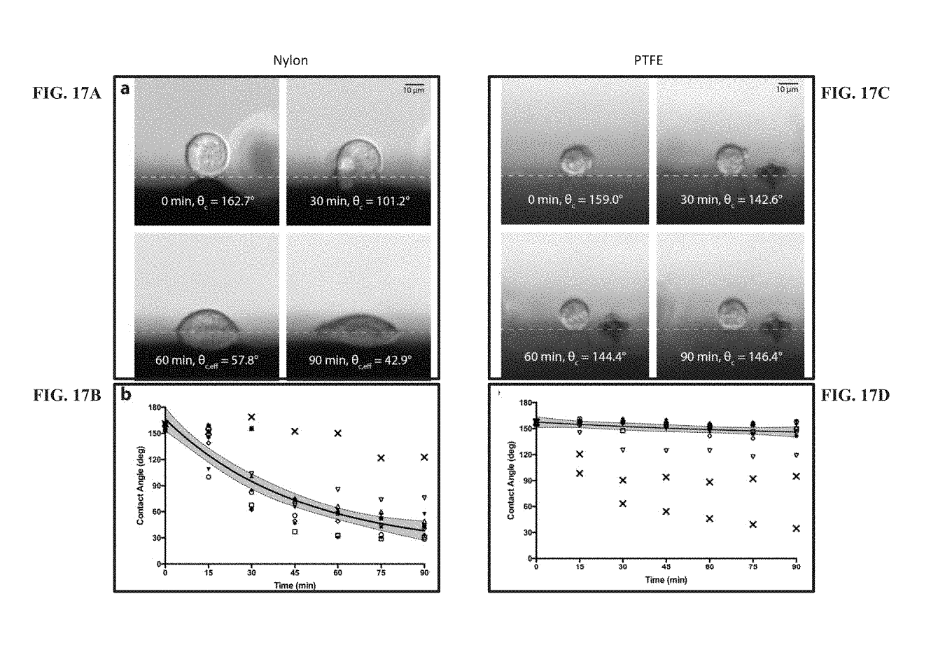

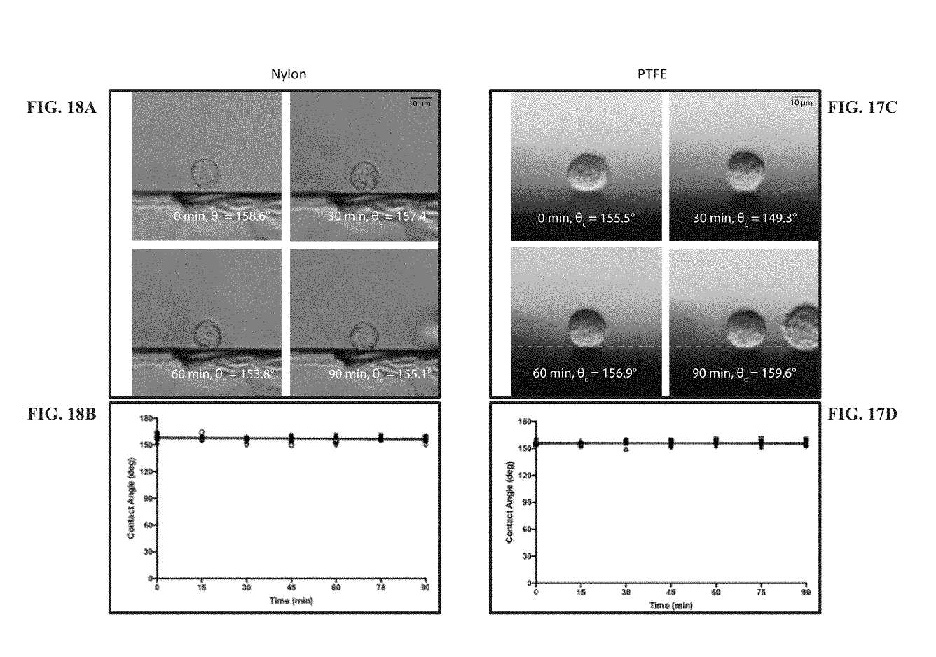

With HEK293 cells, comparable changes in cell morphology to those exhibited by HeLa cells were observed on all five surfaces for the duration of 90 minutes. On glass and collagen-alginate hydrogels, HEK293 cells underwent average rates of change in contact angle of 0.037 deg/min and 0.041 deg/min, respectively. (FIGS. 16A-16B, 16E-16F; Table 3). The most rapid rate of change in contact angle of 0.058 deg/min was observed on collagen-coated glass substrates (FIGS. 16C-16D, Table 3), and the slowest rate of change of 0.010 deg/min occurred on PTFE (FIGS. 17C-17D, Table 3). As was the case with HeLa cells, the majority of HEK293 cells resisted adhesion to PTFE with the exception of some statistical outliers that experienced larger changes in contact angle on this material. On Nylon, a large average change in contact angle of 114.1° was observed, which was similar to the results observed on collagen-coated glass, but at a slower rate of 0.022 deg/min (FIGS. 17A-17B, Table 3). With the exception of collagen-alginate hydrogels, the substrates ranked identically for promoting the adhesion of HEK293 cells and HeLa cells spanning 90 minutes of contact.

TABLE 3
Comparing the average change in contact angle
of HEK293 cells on glass, collagen, Nylon, PTFE,
and collagen-alginate hydrogel surfaces.

| | Δθ_{c} | | |
|---|---|---|---|
| | (deg) | k (deg/min) | ratio |
| Glass | 103.5 | 0.037 | 1.0 |
| Collagen | 117.1 | 0.058 | 1.6 |
| Nylon | 114.1 | 0.022 | 0.6 |
| PTFE | 9.3 | 0.010 | 0.3 |
| Hydrogel | 44.9 | 0.041 | 1.1 |

MDA-MB-231 Breast Cancer Cells:

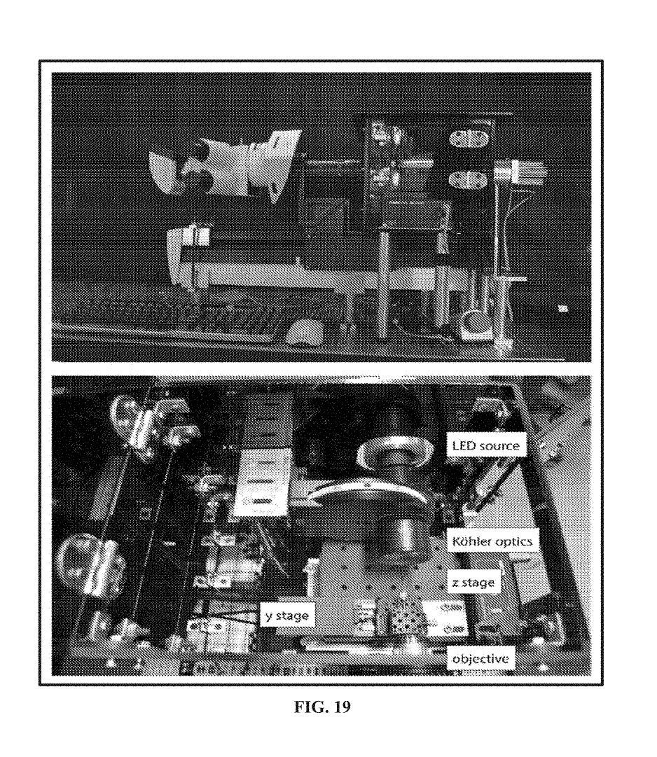

With MDA-MB-231 cells only, a unique, previously unreported morphology during adhesion was observed. This morphology is best described as the formation of a pedestal that connects the bulk of the cell to the material surface, resulting in a vertical elongation of the cell. With these cells, effective contact angle measurements do not inform the extent of adhesion. Instead, the change in cell height was measured as percentage of the diameter of the cell at t=0 min. The elongated cell morphology during adhesion was most commonly observed on collagen-coated glass, Nylon, and collagen-alginate hydrogel surfaces (FIGS. 21A-21B FIGS. 21C-21F). With some cells, pedestals formed immediately, whereas with other cells, pedestals were established later on. This spread in behavior did not follow any obvious trends, as represented by the wide distributions of the changes in cell height over time. Typically, however, those cells that attached early on would elongate and retract back down during the 90 minute time period, at which point one could resume measuring contact angles to quantify MDA-MB-231 adhesion. To determine if this elongation resulted from the lateral microscopy experimental protocol, 3D confocal microscopy images of MDA-MB-231 cells were acquired on collagen-coated glass and observed the same morphology within 90 minutes of adhesion (data not shown). In brightfield images of the xy-plane, however, MDA-MB-231 cells in a pedestal morphology appear spherical and vertical elongation is indistinguishable (data not shown). Furthermore, cells are not often probed until a sufficient amount of time for adhesion has passed (i.e., 24 hours), which explains why this morphology has yet to be described. While the biological basis of pedestal formation requires further attention, the observation of changes in the heights of cells using the lateral microscope highlights many benefits of acquiring brightfield images of the planes orthogonal to those imaged by traditional microscopy approaches: cellular morphology in the z-plane is clearly distinguished rather than inferred and any cellular behaviors that are not anticipated and specifically labeled for may not go unnoticed.

Notably, during MDA-MB-231 cell elongation, a pivoting motion by the bulk of the cell body on its pedestal was observed. The absence of any cell detachment from the surface while pivoting further confirmed that this unique morphology is representative of adhesion. Additionally, ripples were observed that originated at the base of the pedestal, propagating upward into the bulk of cell. Without the field of view and imaging capabilities of the lateral microscope, this unexpected adhesive behavior may not have been revealed.

On glass and PTFE, cells preferred to roll rather than adhere within 90 minutes (data not shown). Because minimal adhesion to glass was unexpected, a prolonged experiment was performed with MDA-MB-231 cells on this surface and found that within 2 to 3 hours, the majority of cells began to adhere by way of pedestal formation.

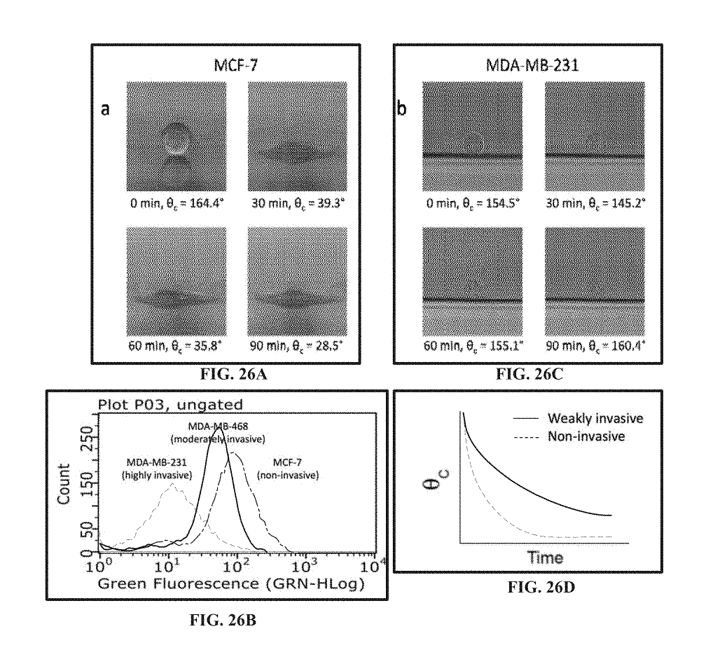

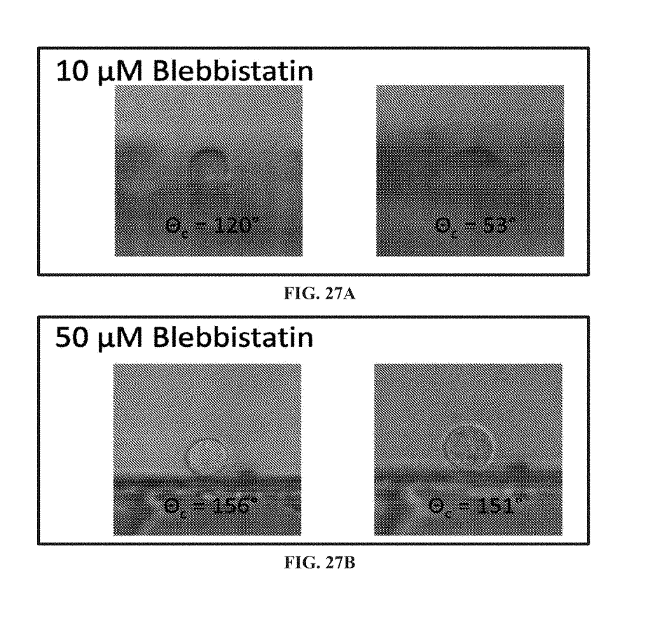

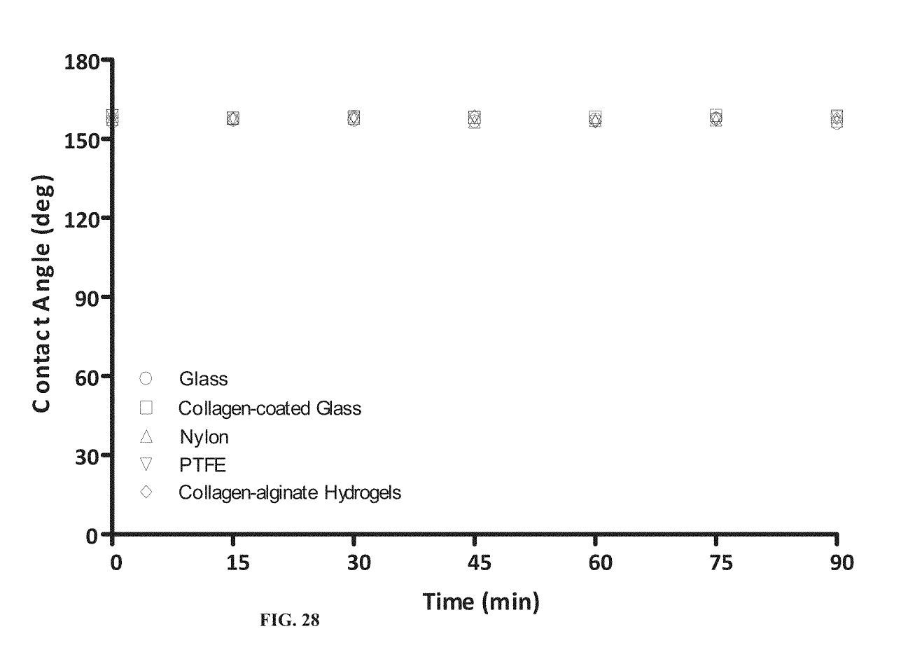

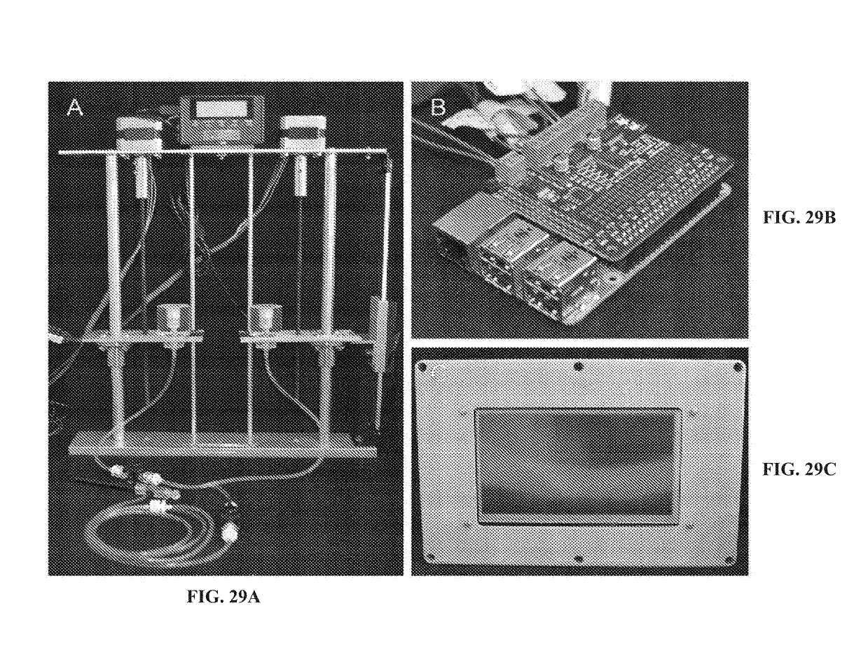

With the development of the lateral microscope, the inventors have established a simplified method for characterizing the morphology of cells during adhesion using contact angle and cell height measurements. By monitoring the adhesion of various cell lines, the average rate of change in contact angle was used to compare and predict their adhesive behaviors on specific materials. According to these results, the HeLa cell line is the most isotropically adherent cell line on all surfaces studied compared to the 3T3 and MDA-MB-231 cell lines. This enabled the effective quantification of HeLa cell adhesion using contact angle measurements. Alternatively, the MDA-MB-231 cell line was observed to adhere in a unique, vertically quantifiable manner that was easily discernible from HeLa and 3T3 adhesion. The vertical elongation and motility that was exhibited by the MDA-MB-231 cell line highlights a new mode of adhesion that has gone unseen using traditional optical microscopy techniques. It is possible that this morphology is related to the highly invasive nature of the MDA-MB-231 cell line. Future studies with the lateral microscope on the morphologies of breast cancer cells that vary in invasiveness may offer substantial insight into the mechanisms of cancer metastasis. Of the four cell lines observed in this study, the 3T3 cell line was the most motile as indicated by the fluctuations in contact angle measurements during 90 minutes of adhesion. To ensure that the differences in the adhesion of the HeLa, 3T3, HEK293, and MDA-MB-231 cell lines were not a factor of the surface materials used, changes in contact angle of H9 T lymphocytes were measured on the four surfaces studied. H9 T lymphocytes are classified as a non-adherent, suspension cell line and were thus predicted to experience no change in contact angle in 90 minutes on all surfaces. As expected, these cells underwent an average change in contact angle of 0.46°, 0.19°, 0.42°, 0.45°, and 0.57° on glass, collagen-coated glass, Nylon, PTFE, and collagen-alginate hydrogels, respectively (FIG. 28). These changes are small and insignificant when compared to the changes in contact angles of the adherent cell lines and instead may reflect the deformability of H9 T lymphocytes upon settling onto a surface. Therefore, it was determined that HeLa, 3T3, HEK293, and MDA-MB-231 cell lines are distinguishable by their morphology changes on surfaces as quantified by contact angle and cell height measurements.

When comparing the five surfaces used for adhesion studies, it was found that collagen-coated glass surfaces promote the greatest adhesion for the HeLa cell line, as anticipated, whereas Nylon surfaces promote the greatest adhesion for the 3T3 cell line. Both collagen-coated glass and Nylon substrates can be considered to promote the greatest adhesion for the MDA-MB-231 cell line as well, based on the number of cells that adhered to this surface with a unique, elongated morphology. Uncoated glass surfaces also promote adhesion for the HeLa and 3T3 cell lines, but to less of an extent than collagen-coated glass and Nylon surfaces. With MDA-MB-231 cells, however, glass typically resists adhesion within the first 90 minutes of cell contact with the surface. With all cell lines studied, PTFE surfaces resisted adhesion as supported by the lack of large average changes in contact angle measurements.

In order to demonstrate the innovation of the lateral microscope compared to existing technologies, single cell dynamics were imaged upon contact with a diverse series of substrates. Single cell studies have become of increasing importance for understanding the causes of abnormal behaviors in many biological systems. Typically, however, cells are studied in large populations so as to simplify experiments and obtain reliable statistics. As with traditional optical microscopy, the number of cells that can be imaged in the field of view of the lateral microscope depends largely on the sizes of cells, the density at which they are introduced to the substrate, and the magnification of the objective lens. Using our 40× objective lens, up to ˜10 cells could fit side-by-side in a single field of view (data not shown). It is likely, however, that not all of the cells in the field of view will be in perfect focus. With a quick adjustment of the motorized sample stage, each cell can be brought into focus and imaged within ˜2 seconds of one another. As a result, high-throughput single cell analysis is possible at the slight expense of dynamics. If accurate dynamics are of high importance during an experiment, throughput may be compromised. Because the sample surface is typically brought into focus before the introduction of cells, cells can be visualized descending through the medium towards the surface, enabling the acquisition of images that represent true t=0 min morphologies. It is also possible to acquire non-stop movies of cell adhesion, from which still images can be extracted at specified time points.

The lateral microscope described herein is a powerful imaging tool that provides entirely new capabilities for the examination of biological interfaces. By acquiring brightfield images of cell-surface interfaces and measuring changes in the contact angles and heights of cells, it has been demonstrated that lateral microscopy can facilitate the label-free, dynamic, and quantitative study of cell adhesion. The efficacy of this approach is best supported by measurements of rates of adhesion, which simplify the comparison of materials and coatings for biomaterial fabrication. Moreover, the lateral microscope has enabled the discovery of a new morphology adopted by MDA-MB-231 cells during adhesion. Unexpectedly, these cells experienced an increase in height by way of a pedestal formation early on, which contradicts the accepted approach for characterizing the extent of adhesion according to spreading. Using these results, a better understanding of the initial events of adhesion at the biochemical level using fluorescence lateral microscopy can be achieved. Ultimately, with the aid of the lateral microscope, one can establish a strong foundation for future investigations on basic biological problems related to cell adhesion, the pathogenesis of diseases, and the development of biomaterials.

### REFERENCES FOR EXAMPLE 3

(1) Parsons, T. J.; Horwitz, A. R.; Schwartz, M. A. Cell adhesion: integrating cytoskeletal dynamics and cellular tension. Nat. Rev. Mol. Cell Biol. 2010, 11, 633-643, DOI: 10.1038/nrm2957.
(2) Sampson, N. S.; Mrksich, M.; Bertozzi, C. R. Surface molecular recognition. Proc. Natl. Acad. Sci. U.S.A. 2001, 98, 12870-12871, DOI: 10.1073/pnas.231391398.
(3) Brodland, G. W. The Differential Interfacial Tension Hypothesis (DITH): a comprehensive theory for the self-rearrangement of embryonic cells and tissues. J. Biomech. Eng. 2002, 124, 188-197, DOI: 10.1115/1.1449491.
(4) Kanchanawong, P.; Shtengel, G.; Pasapera, A. M.; Ramko, E. B.; Davidson, M. W.; Hess, H. F.; Waterman, C. M. Nanoscale architecture of integrin-based cell adhesions. Nature 2010, 468, 580-584, DOI: 10.1038/nature09621.
(5) Barone, V.; Heisenberg, C.-P. Cell adhesion in embryo morphogenesis. Curr. Opin. Cell Biol. 2012, 24, 148-153, DOI: 10.1016/j.ceb.2011.11.006.
(6) Middleton, J.; Patterson, A. M.; Gardner, L.; Schmutz, C.; Ashton, B. A. Leukocyte extravasation: chemokine transport and presentation by the endothelium. Blood 2002, 100, 3853-3860, DOI: 10.1182/blood.V100.12.3853.
(7) Valastyan, S; Weinberg, R. A. Tumor metastasis: Molecular insights and evolving paradigms. Cell 2011, 147, 275-292, DOI: 10.1016/j.cell.2011.09.024.
(8) Statz, A.; Barron, A.; Messersmith, P. Protein, cell and bacterial fouling resistance of polypeptoid-modified surfaces: effect of side chain chemistry. Soft Matter 2008, 4, 131-139, DOI: 10.1039/B711944E.
(9) Tang, L.; Jennings, T.; Eaton, J. W. Mast cells mediate acute inflammatory responses to implanted biomaterials. Proc. Natl. Acad. Sci. U.S.A. 1998, 95, 8841-8846, DOI: 10.1203/00006450-199704001-00699.
(10) Hallab, N. J.; Bundy, K. J.; Connor, K. O.; Moses, R. L.; Jacobs, J. J. Evaluation of Metallic and Polymeric Biomaterial Surface Energy and Surface Roughness Characteristics for Directed Cell Adhesion. Tissue Eng. 2001, 7, 55-71, DOI: 10.1089/107632700300003297.
(11) Yeung, A.; Evans, E. Cortical shell-liquid core model for passive flow of liquid-like spherical cells into micropipettes. Biophys. J. 1989, 56, 139-149, DOI: 10.1016/S0006-3495(89)82659-1.
(12) Hochmuth, R. M. Micropipette aspiration of living cells. J. Biomech. 2000, 33, 15-22.
(13) Evans, E.; Yeung, A. Apparent viscosity and cortical tension of blood granulocytes determined by micropipette aspiration. Biophys. J. 1989, 56, 151-160, DOI: 10.1016/S0006-3495(89)82660-8.
(14) Cuvelier, D.; Thery, M.; Chu, Y.-S.; Dufour, S.; Thiery, J.-P.; Bornens, M.; Nassoy, P.; Mahadevan, L. The universal dynamics of cell spreading. Curr. Biol. 2007, 17, 694-699, DOI: 10.1016/j.cub.2007.02.058.
(15) Manning, M. L.; Foty, R. A.; Steinberg, M. S.; Schoetz, E.-M. Coaction of intercellular adhesion and cortical tension specifies tissue surface tension. Proc. Natl. Acad. Sci. U.S.A. 2010, 107, 12517-12522, DOI: 10.1073/pnas.1003743107.
(16) Müller, A.; Meyer, J.; Paumer, T.; Pompe, T. Cytoskeletal transition in patterned cells correlates with interfacial energy model. Soft Matter 2014, 10, 2444-2452, DOI: 10.1039/C3 SM52424H.
(17) Maitre, J.-L.; Berthoumieux, H.; Krens, S. F.; Salbreux, G.; Jülicher, F.; Paluch, E.; Heisenberg, C. P. Adhesion functions in cell sorting by mechanically coupling the cortices of adhering cells. Science 2012, 338, 253-256, DOI: 10.1126/science.1225399.
(18) Fouchard, J.; Bimbard, C.; Bufi, N.; Durand-Smet, P.; Proag, A.; Richert, A.; Cardoso, O.; Asnacios, A. Three-dimensional cell body shape dictates the onset of traction force generation and growth of focal adhesions. Proc. Natl. Acad. Sci. U.S.A. 2014, 111, 13075-13080, DOI: 10.1073/pnas.1411785111.
(19) Simson, R.; Wallraff, E.; Faix, J.; Niewohner, J.; Gerisch, G.; Sackmann, E. Membrane bending modulus and adhesion energy of wild-type and mutant cells of Dictyostelium lacking talin or cortexillins. Biophys. J. 1998, 74, 514-522, DOI: 10.1016/S0006-3495(98)77808-7.
(20) Bruinsma, R.; Sackmann, E. Bioadhesion and the dewetting transition. C. r. hebd. séances Acad. sci. 2001, 2, 803-815, DOI: 10.1016/S1296-2147(01)01225-2.
(21) Sackmann E.; Bruinsma, R. F. Cell adhesion as wetting transition? ChemPhysChem 2002, 12, 262-269, DOI: 10.1002/1439-7641(20020315)3:3<262::AID-CPHC262>3 0.0. CO;2-U.
(22) Cerchiari, A. E.; Garbe, J. C.; Jee, N. Y.; Todhunter, M. E.; Broaders, K. E.; Peehl, D. M.; Desai, T. A.; LaBarge, M. A.; Thomson, M.; Gartner, Z. J. A strategy for tissue self-organization that is robust to cellular heterogeneity and plasticity. Proc. Natl. Acad. Sci. U.S.A. 2015, 112, 2287-2292, DOI: 10.1073/pnas.1410776112.
(23) Stephens, D. J.; Allan, V. J. Light microscopy techniques for live cell imaging. Science 2003, 300, 82-86, DOI: 10.1126/science.1082160.
(24) Guttenberg, Z.; Bausch, A. R.; Hu, B.; Bruinsma, R.; Moroder, L.; Sackmann, E. Measuring ligand-receptor unbinding forces with magnetic beads: molecular leverage. Langmuir 2000, 16, 8984-8993, DOI: 10.1021/la000279x.
(25) Curtis, A. S. G. The mechanism of adhesion of cells to glass. J. Cell Biol. 1964, 20, 199-215, DOI: 10.1083/jcb.20.2.199.
(26) Bereiter-Hahn, J.; Fox, C. H.; Thorell, B. Quantitative reflection contrast microscopy of living cells. J. Cell Biol. 1979, 82, 767-779, DOI: 10.1083/jcb.82.3.767.
(27) Knight, M. M.; Roberts, S. R.; Lee, D. A.; Bader, D. L. Live cell imaging using confocal microscopy induces intracellular calcium transients and cell death. Am. J. Physiol.-Cell Ph. 2003, 284, 1083-1089, DOI: 10.1152/ajpce11.00276.2002.
(28) Fink, J.; Carpi, N.; Betz, T.; Bétard, A.; Chebah, M.; Azioune, A.; Bornens, M.; Sykes, C.; Fetler, L.; Cuvelier, D.; Piel, M. External forces control mitotic spindle positioning. Nat. Cell Biol. 2011, 13, 771-778, DOI: 10.1038/ncb2269.
(29) Chen, B. C.; Legant, W. R.; Wang, K.; Shao, L.; Milkie, D. E.; Davidson, M. W.; Janetopoulos, C.; Wu, X. S.; Hammer III, J. A.; Liu, Z.; English, B. P.; Mimori-Kiyosue, Y.; Romero, D. P.; Ritter, A. T.; Lippincott-Schwartz, J. Fritz-Laylin, L.; Mullins, R. D.; Mitchell, D. M.; Bembenek, J. N.; Reymann, A. C.; Bohme, R.; Grill, S. W.; Wang, J. T.; Seydoux, G.; Tulu, U. S.; Kiehart, D. P.; Betzig, E. Lattice light-sheet microscopy: imaging molecules to embryos at high spatiotemporal resolution. Science 2014, 346, 1257998, DOI: 10.1126/science.1257998.
(30) Artym, V. V.; Matsumoto, K. Imaging Cells in Three-Dimensional Collagen Matrix. Curr. Protoc. Cell Biol. 2010, 1-23, DOI: 10.1002/0471143030.cb1018s48.
(31) Bell, L. G. E.; Jeon, K. W. Locomotion of Amoeba Proteus. Nature 1963, 198, 675-676, DOI: 10.1038/198675a0.
(32) Cao, J.; Usami, S.; Dong, C. Development of a side-view chamber for studying cell-surface adhesion under flow conditions. Ann. Biomed. Eng. 1997, 25, 573-580, DOI: 10.1007/BF02684196.
(33) Dong, C.; Lei, X. X. Biomechanics of cell rolling: shear flow, cell-surface adhesion, and cell deformability. J. Biomech. 2000, 33, 35-43, DOI: 10.1016/S0021-9290(99)00174-8.
(34) Cao, J.; Donell, B.; Deaver, D. R.; Lawrence, M. B.; Dong, C. In Vitro Side-View Imaging Technique and Analysis of Human T-Leukemic Cell Adhesion. Microvasc. Res. 1998, 55, 124-137, DOI: 10.1006/mvre.1997.2064.
(35) Chaudhuri, O.; Parekh, S. H.; Lam, W. A.; Fletcher, D. A. Combined atomic force microscopy and side-view optical imaging for mechanical studies of cells. Nat. Methods 2009, 6, 383-387, DOI: 10.1038/nmeth.1320.
(36) Hanker, J. S.; Giammara, B. L. Biomaterials and Biomedical Devices. Science 1988, 242, 885-892, DOI: 10.1126/science.3055300.
(37) Williams, D. L.; Kuhn, A. T.; Amann, M. A.; Hausinger, M. B.; Konarik, M. M.; Nesselrode, E. I. Computerized Measurement of Contact Angles. Galvanotech. 2010, 10, 1-11.
(38) Fairman, K.; Jacobson, B. S. Unique morphology of HeLa cell attachment, spreading, and detachment from microcarrier beads covalently coated with a specific and non-specific substratum. Tissue Cell 1983, 15, 167-180, DOI: 10.1016/0040-8166(83)90014-9.
(39) Tjhung, E.; Tiribocchi, A.; Marenduzzo, D.; Cates, M. E. A minimal physical model captures the shapes of crawling cells. Nat. Commun. 2015, 6, 5420, DOI: 10.1038/ncomms6420.
(40) Gabella, C.; Bertseva, E.; Bottier, C.; Piacentini, N.; Bornert, A.; Jeney, S.; Forró, L.; Sbalzarini, I. F.; Meister, J. J.; Verkhovsky, A. B. Contact Angle at the Leading Edge Controls Cell Protrusion Rate. Curr. Biol. 2014, 24, 1126-1132, DOI: 10.1016/j.cub.2014.03.050.
(41) Lu, M. L.; Beacham, D. A.; Jacobson, B. S. The Identification and Characterization of Collagen Receptors Involved in HeLa Cell-Substratum Adhesion. J. Biol. Chem. 1989, 264, 13546-13558.
(42) Weiss, L.; Blumenson, L. E. Dynamic Adhesion and Separation of Cells in Vitro. J. Cell. Physiol. 1967, 70, 23-32, DOI: 10.1002/jcp.1040700104.
(43) Todaro, G. J.; Green, H. Quantitative studies of the growth of mouse embryo cells in culture and their development into established lines. J. Cell Biol. 1963, 17, 299-313, DOI: 10.1083/jcb.17.2.299.
(44) Bell, P. B. Locomotory behavior, contact inhibition, and pattern formation of 3T3 and polyoma virus-transformed 3T3 cells in culture. J. Cell Biol. 1977, 74, 963-982, DOI: 10.1083/jcb.74.3.963.
(45) Plant, A. L.; Bhadriraju, K.; Spurlin, T. A.; Elliot, J. T. Cell response to matrix mechanics: Focus on collagen. Biochim. Biophys. Acta 2009, 1793, 893-902, DOI: 10.1016/j.bbamcr.2008.10.012.

### Example 4: Aspiration System for Manipulation of Single Cells

Cells maintain a spherical shape due to their cortical tension in the absence of external mechanical contacts (e.g., in suspension). During adhesion, cells undergo significant changes in morphology as they spread to increase their contact area with a surface in order to minimize interfacial free energy. A number of models have been developed to describe the biophysics and biomechanics underlying cell adhesion, which have since been applied to systems that range in complexity from single cells to tissues. Common to all of these approaches is the importance of an accurate description of cell morphology and the significance of the contact angle between cellular interfaces as an emergent geometric parameter resulting from adhesion processes. Additionally, the use of the contact angle has been proposed as a means to translate theories related to surface wetting phenomena into quantitative descriptions of cell adhesion.

The morphologies of adherent cells are conventionally studied using optical microscopy techniques. The most common approaches to determine contact angles are reflectance interference contrast microscopy (RICM) and confocal microscopy. The interference fringes resulting from RICM images can be translated into distance information, while the ability of confocal microscopy to generate three-dimensional reconstructions inherently provides interfacial fields of view. These techniques, however, are not without their drawbacks: (i) RICM is restricted to imaging cells adhered only to transparent glass substrates and requires mathematical models to extrapolate contact angles and cell morphologies. (ii) Confocal microscopy requires cells to be labeled with a fluorophore by addition of an exogenous dye or expression of an endogenous fluorescent protein. There are significant lags in time required to establish the desired focal plane and acquire the series of image slices, which must later be reconstructed computationally into a three-dimensional image. In order to overcome the challenges of imaging cells on opaque substrates (i.e., without a brightfield image to guide the experiment), cells are typically fixed with paraformaldehyde. This procedure provides important experimental flexibility, but precludes any time-resolved, live-cell investigations.

Further, there is an established need to not just image cell adhesion processes but also to independently quantify the forces associated with them. While a number of techniques have been developed to characterize cell adhesion quantitatively, atomic force microscopy (AFM) or variations of single-cell force spectroscopy (SCFS) are the predominant approaches used to measure cell adhesion forces. These techniques are slow, low-throughput, and often destructive to the cell under study. Moreover, SCFS approaches must be paired to an optical microscope to facilitate locating a cell and positioning the sensor in a manner that does not obstruct the instrument or the field of view of the experiment, which limits these techniques to transparent substrates.

Considering the significance of cell adhesion, there is an outstanding need for a method that broadly permits (i) the direct imaging of biological interfaces and (ii) quantitative measurements of forces associated with cell adhesion.

Described herein is the novel application of a lateral microscope that provides an entirely new means to study cell adhesion. This approach is innovative because it enables (i) the direct imaging of dynamic changes to cell morphology, (ii) the investigation of any material surface regardless of its composition or physical properties, and (iii) the simple integration with complementary tools that permit quantitative measurements of cell adhesion forces. This technique can improve (i) the fundamental understanding of the mechanisms controlling adhesion processes and (ii) the methods by which biomaterials are designed, studied, and characterized.

Cells will spread when interacting with a surface that promotes adhesion, but will retain a spherical shape—thus minimizing contact area—on a surface that resists adhesion. These morphologies are readily described with contact angle measurements in a manner that is analogous to the wettability of hydrophilic and hydrophobic surfaces: favorable interactions lead to small contact angles (<90°), while unfavorable interactions result in large contact angles (>90°). The rate of change in the contact angle also provides valuable insight into the mechanisms that regulate cell adhesion.

SAMS:

Self-assembled monolayers (SAMs) of thiols on gold substrates have found widespread use as models for biological surfaces because they are chemically and structurally well-defined. As a result, SAMs have been applied to study a number of problems related to cell biology and cell adhesion. To demonstrate this innovative approach to the study of cell adhesion, lateral microscopy was used to examine interactions between breast cancer cells and SAMs of integrin-binding ligands. These systems were selected because they represent a biologically important and diverse functional space: (i) Integrin expression has been shown to be a prognostic indicator for breast cancer. (ii) Integrin-binding peptides and proteins are well-understood. (iii) A number of integrin-binding peptides are known and span a range of binding abilities. (iv) Breast cancer is highly metastatic. Metastatic processes require changes to the adhesive properties of a cell and integrins play a significant role in controlling these processes. Furthermore, there is a great need to develop tools to study triple negative breast cancer (TNBC) cells and those cells with invasive and metastatic phenotypes.

Three TNBC lines that vary in invasive phenotype: MDA-MB-231 (highly invasive), MDA-MB-157 (slightly invasive), and MDA-MB-453 (non-invasive) were selected for the study. All three epithelial cell lines natively express integrins. siRNA is used to knockdown the specific alpha- and beta-isoforms of integrin expressed by each cell type; these transient knockdowns serve as effective negative control cell lines for the specific integrin-targeting adhesion interactions. Flow cytometry is used to quantify the expression level of integrins in the normal (integrin +) and knockdown (integrin −) TNBC lines. Table 4 lists the SAMs that were used for this research.

TABLE 4
List of self-assembled monolayers

```
  1. Ac-GRGDSC-NH₂
  2. Ac-GRDGSC-NH₂
  3. cyclic-RGSfK
  4. Ac-PHSCNGGK-NH₂
  5. Ac-HSPNCGGK-NH₂
  6. HS(CH₂)₁₁(OCH₂CH₂)₄OH
  7. HS(CH₂)₁₇CH₃
  8. HS(CH₂)₁₁O(CH₂)₂(CF₂)₅CF₃
  9. fibronectin
10. collagen
```

Two classes of peptides that are known to bind to integrin—RGD and PHSCN—can be used to study the adhesive properties of these cells. In particular, linear, cyclic and scrambled RGD, and linear and scrambled PHSCN (SAMs 1-5) were studied. To immobilize the peptides, a mixed SAM is prepared comprising 1 mol % of an alkanethiol bearing an activated N-hydroxysuccinimide ester, which will facilitate covalent coupling of amine-terminated or lysine-containing peptides. The remainder of the SAM comprises a tetra(ethyleneglycol)-terminated alkanethiol (SAM 6) in order to limit non-specific adsorption to the SAM. In addition, SAMs prepared from an alkanethiol (SAM 7), a fluorinated alkanethiol (SAM 8), and the extracellular matrix proteins fibronectin (SAM 9) and collagen (SAM 10) are each contemplated for use in similar studies.

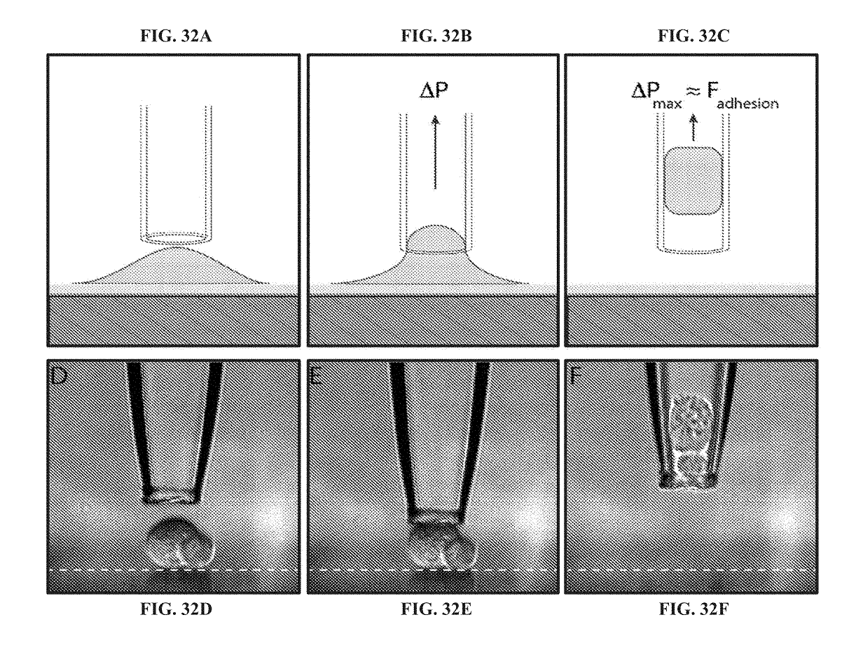

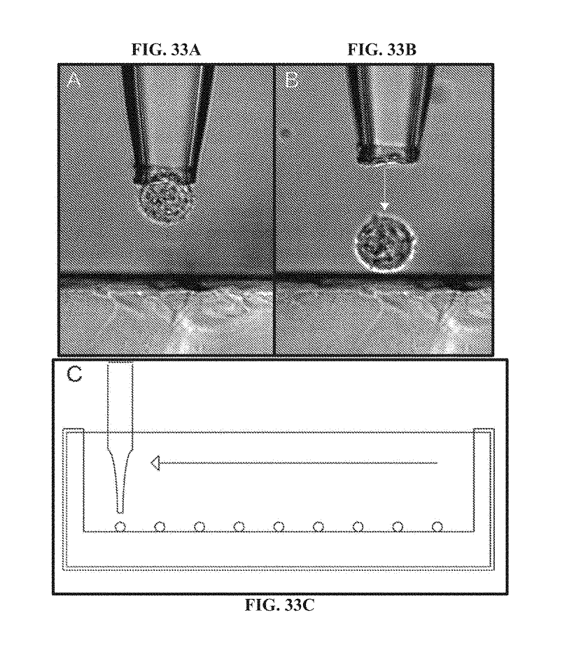

Furthermore, in the interest of developing a method that improves the information density of a cell adhesion experiment imaged by lateral microscopy. Therefore, in addition to preparing surfaces that are uniformly coated with a SAM, microcontact printing is used to pattern SAMs onto a surface (FIGS. 33A-33C).

The feature size of the stamp is varied in order to produce stripes (ca. 20-50 μm wide) of functionalized SAMs that restrict the position of an adherent cell without producing aberrant phenotypes associated with confinement. The goal of this preliminary study is to study multiple adhesive ligands in a single field of view. A micropipette dispensing system is used to control the delivery of cells to patterned SAMs.

These studies will permit the study of a variety of phenomena including, but not limited to, the following:
1. Surfaces functionalized to promote (e.g., cyclic RGD) or resist (e.g., fluorinated) adhesion can be differentiated based on observing the changes to the contact angle of surface-adherent breast cancer cells.
2. Surfaces functionalized with SAMs of different affinity to integrin (e.g., RGD vs. PHSCN) can be differentiated based on the rate of change of the contact angle of interacting breast cancer cells.
3. Triple negative breast cancer cells can be characterized by their dynamic interactions with SAMs.
4. SAMs patterned by microcontact printing can enable the multiplexed study of cell adhesion.

Measure the Adhesion Forces of Single Cells on Biologically Relevant Self-Assembled Monolayers (SAMs) Using Micropipette Aspiration.

The force required to remove an adhered cell from its surface is dependent on adhesion time and the interactions between cell adhesion molecules and surface patterned ligands. Techniques based on micropipette aspiration have previously been used to measure the cortical tension of single cells, the adhesion forces between cells, and the adhesion forces between cells and beads. Micropipette aspiration experiments require micropipettes with internal diameters on the order of 1-10 μm, where the selection of tip geometry is based on the physical properties of the cells of interest (e.g., dimensions and stiffness). A micromanipulator is used to move the pipette with micron-scale precision, and a differential height pressure transduction device, often referred to as a manometer, is used to generate the pressures needed to aspirate the cells. The manometer must precisely transduce pressure on the order of single Pascals to provide the forces necessary for controlled manipulation of soft cells.

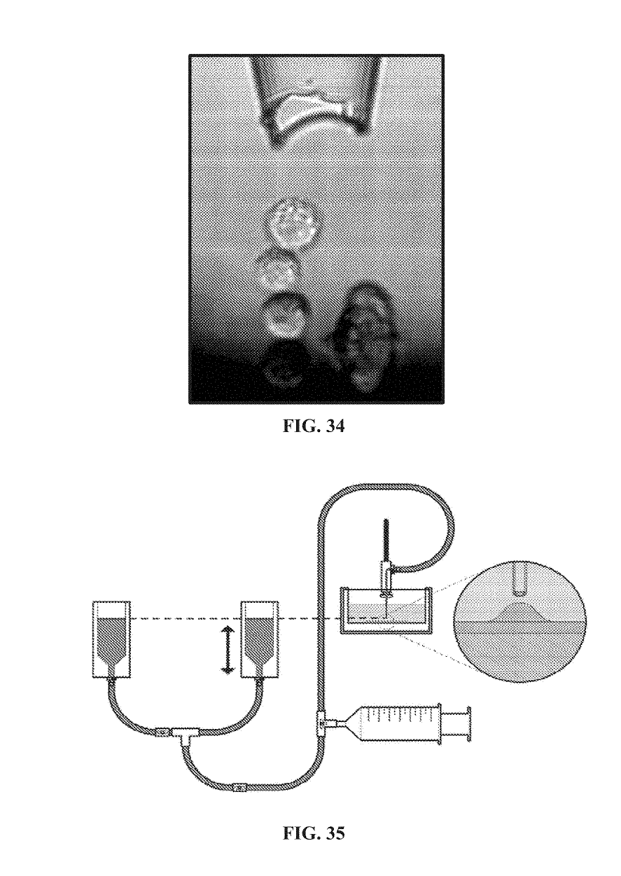

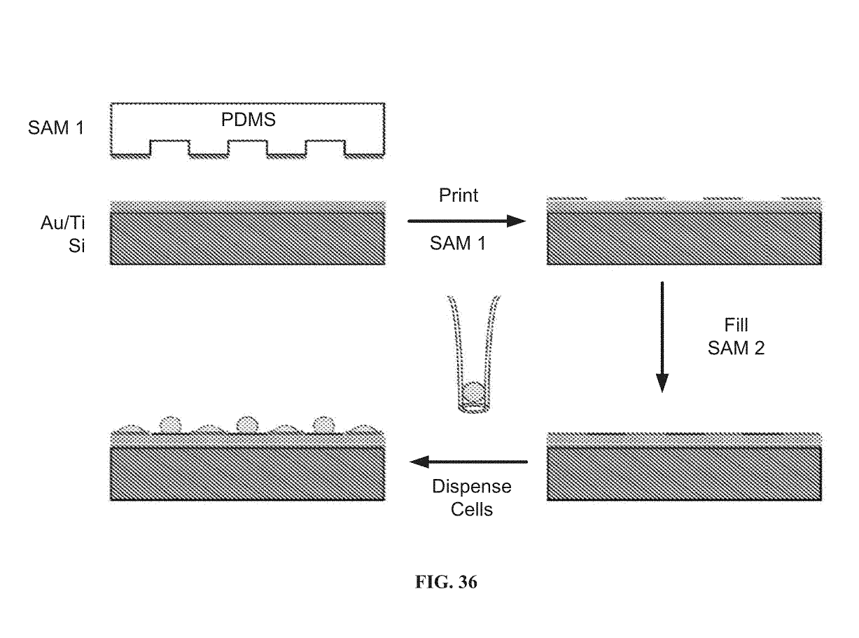

The methods and systems provided herein permit one to quantify adhesion forces as a function of time for all cell lines and SAMs. The inventors have fabricated a custom manometer that can be used with a standard micromanipulator to perform micropipette aspiration experiments using the lateral microscope (FIG. 35). The manometer comprises two liquid reservoirs that are driven vertically by stepper motors attached to threaded drive screws. These two reservoirs are connected to each other and to the micropipette. The stepper motors are controlled using custom software on a Raspberry Pi computer. After the reservoirs and micropipette tip have been leveled (zero net flow), one reservoir is closed off and the other is manipulated to transduce pressure in the system. The resulting height difference (h, m) between the two reservoirs can be obtained from the digital display of a magnetic position sensor; this difference is then used to determine the applied pressure (P, Pa) using Equation 1:

P=μgh (Eq. 1)

where ρ is the density of the medium in the reservoirs (kg/m3) and g is the acceleration due to gravity (m/s²). The motorized z-stage of the lateral microscope is used to bring the cell into and out of contact with the micropipette tip. The force F (N) on a cell held by a micropipette is expressed by Equation 2 as the suction pressure P times the cross-sectional area of the pipette tip, where Rp is the radius of the pipette tip (m).

F=πR²pP (Eq. 2)

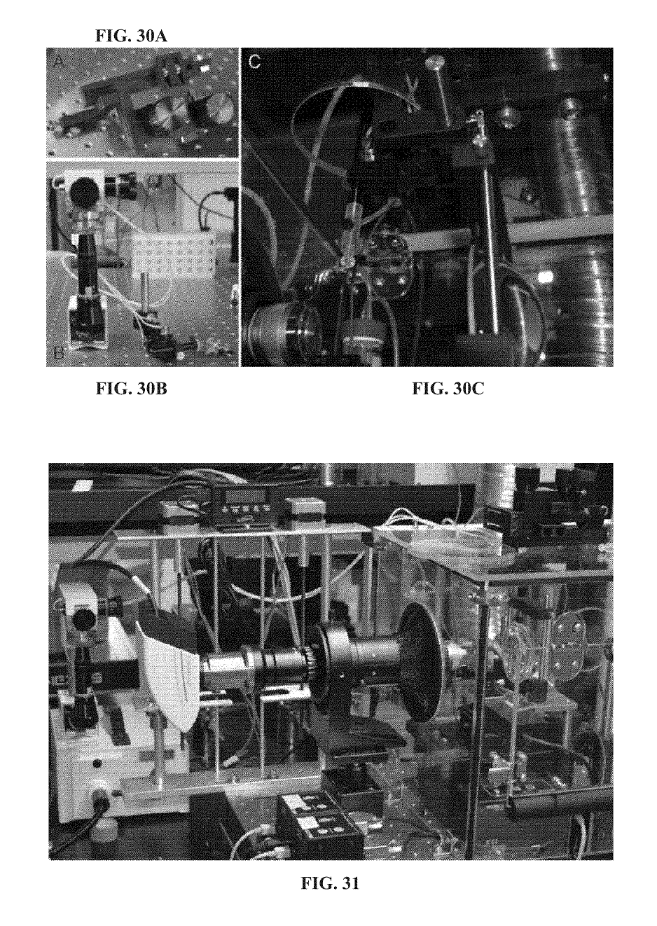

The manometer has been used in preliminary experiments to demonstrate the detachment of HeLa cells adhered to gold surfaces functionalized with octadecanethiol SAMs (FIGS. 32A-32F). In the experiments described herein, the force required to remove a cell from a surface can be quantified in the following manner:
1. The pipette tip is brought into contact with a non-adhered cell (e.g., recently settled or on a nonadherent, PTFE surface) until a seal is formed between the tip and cell membrane. Small, increasing steps of pressure will be applied using the manometer until the cell has been aspirated into the pipette. The force required to aspirate the cell into the pipette will be calculated from the minimum aspiration pressure.
2. The removed cell is placed on the SAM using the micromanipulator and allowed to adhere for a specified period of time. The cell can then be detached from the surface and aspirated into the pipette. Again, small increasing steps in pressure can be applied using the manometer. The total force for detachment and aspiration will be calculated from the minimum pressure
3. The forces of aspiration and detachment (adhesion) can be decoupled by subtracting the force required for aspiration only from the total force required for detachment and aspiration.
4. To account for size differences among single cell populations, one can normalize measured adhesion forces to the adhesion area of the cell.
5. This aspiration approach can be used to perform replicate force measurements with a single cell on a unique SAM and across multiple SAMs.

The methods and systems used herein can aid in analysis of the following phenomena:
1. Cells will adhere dissimilarly to surfaces patterned with different adhesion-promoting ligands. The identity of the ligands and their surface densities will dictate adhesion forces for single cells.
2. Detachment forces will depend on the amount of time for which the cell has been allowed to adhere to the surface. Longer adhesion times will correspond to greater detachment forces until a maximum force is obtained that is characteristic of a specific cell/substrate interface.
3. The data obtained from single cells will demonstrate the heterogeneity of large cell populations.

1. An imaging system comprising:
a sample container comprising an interface, in which a biological sample comprising at least one cell is introduced;
illuminating optics outputting a light beam aligned with a sample plane; and
imaging optics aligned with the interface in the sample container.

2. The imaging system of claim 1, wherein the system comprises a total magnification of at least 100×.

3. The imaging system of claim 1, wherein upon introduction of the biological sample comprising at least one cell, the imaging optics magnify, in response to a control input, at least one cell in the biological sample.

4. The imaging system of claim 1, further comprising a camera, a CMOS sensor, a charge-coupled device (CCD), or a diode array.

5. The imaging system of claim 4, wherein the camera is a high-speed CCD camera or a high-speed CMOS sensor.

6. The imaging system of claim 1, further comprising a vibration-isolated breadboard on which one or more of the sample container, the imaging optics, or the camera are mounted.

7. The imaging system of claim 1, wherein the interface includes a planar surface, an immiscible liquid interface, a three-dimensional surface, an inert material surface, a porous material surface, a patterned material surface, a treated/coated material surface, a surface of another cell(s), or a biological material.

8. The imaging system of claim 1, wherein the imaging optics are configured as an imaging configuration selected from the group consisting of a bright-field imaging configuration, a phase-contrast imaging configuration, an epi-fluorescence imaging configuration, and a confocal imaging configuration.

9. The imaging system of claim 4, further comprising one or more controllers communicatively coupled with the camera.

10. The imaging system of claim 9, wherein the one or more controllers communicatively coupled with the camera are configured to:
(i) receive data representative of a plurality of images of the at least one cell at a plurality of time points;
(ii) measure, for each of the plurality of images, the contact angle between the at least one cell and the interface surface; and
(iii) determine the change in the contact angle over time for the at least one cell.

11. A method for analyzing dynamics of at least one cell or particle in a sample, the method comprising:
(a) magnifying at least one cell or particle in a sample using an imaging system comprising:
(i) a sample container in which the sample is introduced,
(ii) illuminating optics outputting a light beam aligned with a sample plane;
(iii) imaging optics aligned with the interface in the sample container; and
(b) measuring an output parameter to analyze the dynamics of the at least one cell or particle.

12. The method of claim 11, wherein the at least one cell or particle is in contact with an interface in the sample container.

13. The method of claim 11, wherein the at least one cell comprises a human cell, a mammalian cell, a bacterial cell, a yeast cell, a fungal cell, an algal cell or a cell fragment.

14. The method of claim 11, wherein the particle includes a liposome, a micelle, an exosome, a microbubble, or a unilamellar vesicle.

15. The method of claim 12, wherein the interface includes a planar surface, an immiscible liquid interface, a three-dimensional surface, an inert material surface, a porous material surface, a patterned material surface, a treated material surface, a coated material surface, a metal material surface, a surface of another cell(s) or a biological material.

16. The method of claim 15, wherein the treated material surface or the coated material surface includes a coating with a biological material, a polymer material, a nylon material, a Teflon™ material, a polytetrafluoroethylene (PTFE) material, or a gold material.

17. The method of claim 16, wherein the biological material has at least one extracellular matrix component.

18. The method of claim 17, wherein the extracellular matrix component includes fibronectin, collagen, laminin, vitronectin, fibrinogen, tenascin, elastin, entactin, heparin sulfate, chondroitin sulfate, keratin sulfate, gelatin, silk fibroin, or agar.

19. The method of claim 11, wherein the output parameter includes contact angle, rate of change of contact angle, height of pedestal, invasion, contact area, sedimentation, adhesion, rolling, extravasation, intravasation, tethering, migration, displacement, morphology, detachment, locomotion, protrusion, contraction, matrix remodeling, gradient sensing, or contact inhibition.

20. The method of claim 19, wherein the output parameter is contact angle.

21. The method of claim 11, further comprising a step of contacting the biological sample with a bioactive agent.

22. The method of claim 11, further comprising a step of applying directional flow and/or shear stress to the interface.

23. The method of claim 11, wherein the imaging system is further configured for detecting fluorescence.

24. The method of claim 11, wherein the output parameter is measured at a plurality of time points.

25. The method of claim 11, wherein the particle includes at least one droplet.

26. The method of claim 25, wherein the droplet includes a colloidal droplet, a phase-separated droplet, or a coacervate.

27. A method for directly measuring contact angle of at least one cell in a biological sample, the method comprising:
(a) magnifying and obtaining an image of the at least one cell using light microscopy, and
(b) measuring contact angle of the at least one cell at an interface using the image obtained in step (a), thereby directly measuring the contact angle of the at least one cell.

28. The method of claim 27, wherein the image is obtained laterally.

29. The method of claim 28, wherein the at least one cell comprises a human cell, a mammalian cell, a bacterial cell, a yeast cell, a fungal cell, an algal cell or a cell fragment.

30. The method of claim 27, wherein the interface includes a planar surface, an immiscible liquid interface, a three-dimensional surface, an inert material surface, a porous material surface, a patterned material surface, a treated material surface, a coated material surface, a metal material surface, a surface of another cell(s), or a biological material.

31. The method of claim 30, wherein the treated material surface or the coated material surface includes a coating with a biological material, a polymer material, a nylon material, a Teflon™ material, a polytetrafluoroethylene (PTFE) material, or a gold material.

32. The method of claim 27, further comprising a step of contacting the biological sample with a bioactive agent.

33. The method of claim 27, wherein the light microscopy is performed using an imaging system comprising:
(a) a sample container comprising an interface, in which a biological sample comprising the cell is introduced,
(b) illuminating optics outputting a light beam aligned with a sample plane, and
(c) imaging optics aligned with the interface.

34. A method for directly measuring adhesion of at least one cell in a biological sample, the method comprising:
(a) magnifying and obtaining an image of the at least one cell using light microscopy, and
(b) measuring adhesion of the at least one cell at an interface using the image obtained in step (a), thereby directly measuring the adhesion of the at least one cell.

35. The method of claim 34, wherein the image is obtained laterally.

36. A method for determining morphology or shape of at least one cell in a biological sample, the method comprising:
(a) magnifying and obtaining an image of the at least one cell laterally using light microscopy, and
(b) determining the morphology or shape of the at least one cell using the image obtained in step (a).

37. An assay for determining invasiveness of a cancer or tumor cell, the assay comprising:
(a) magnifying and obtaining an image of the at least one cancer or tumor cell laterally using light microscopy,
(b) measuring the height of the cell or cell pedestal as a percentage of the diameter of the cell, wherein an increased height as compared to a reference, non-invasive cell indicates that the cell is invasive, thereby determining the invasiveness of the cell.
